(19) United States
(12) Patent Application Publication
(10) Pub. No.: US 2013/0028269 A1
(43) Pub. Date: Jan. 31, 2013

(54) DTV systems employing parallel concatenated coding in COFDM transmissions for iterative diversity reception

(71) Applicant: Allen LeRoy Limberg, Port Charlotte, FL (US)

(72) Inventor: Allen LeRoy Limberg, Port Charlotte, FL (US)

(21) Appl. No.: 13/524,614

(22) Filed: Jun. 15, 2012

Related U.S. Application Data
(60) Provisional application No. 61/574,640, filed on Aug. 6, 2011.
(60) Provisional application No. 61/575,179, filed on Aug. 16, 2011.
(60) Provisional application No. 61/627,495, filed on Oct. 13, 2011.
(60) Provisional application No. 61/685,020, filed on Mar. 10, 2012.
(60) Provisional application No. 61/628,832, filed on Nov. 7, 2011.
(60) Provisional application No. 61/574,138, filed on Jul. 28, 2011.
(60) Provisional application No. 61/626,437, filed on Sep. 27, 2011.

(51) Int. Cl. H04L 27/06; H04L 29/00; H04L 27/36

(52) U.S. Cl. 370/474; 375/298; 375/340

(57) ABSTRACT

A digital television (DTV) system uses parallel concatenated coding (PCC), together with QAM constellations for modulating OFDM carriers. A first encoder responds to bits of randomized data to generate a first component of parallel concatenated coding. A second encoder responds to delayed bits of the randomized data to generate a second component of parallel concatenated coding. A constellation mapper generates QAM symbols responsive to successive time-slices of the first component of the PCC interleaved with successive time-slices of the second component of the PCC. An OFDM modulator generates a COFDM modulating signal responsive to the QAM symbols. In a receiver for the DTV system, the second component of the PCC and delayed first component of the PCC are iteratively decoded. Corresponding soft bits from the second component and delayed first component of the PCC are combined to supply soft randomized data used in that iterative decoding.

This application claims the benefit of the filing dates of provisional U.S. Pat. App. Ser. No. 61/574,640 filed 6 Aug. 2011, of provisional U.S. Pat. App. Ser. No. 61/575,179 filed 16 Aug. 2011, of provisional U.S. Pat. App. Ser. No. 61/627,495 filed 13 Oct. 2011, of provisional U.S. Pat. App. Ser. No. 61/628,832 filed 7 Nov. 2011 and of provisional U.S. Pat. App. Ser. No. 61/685,020 filed 10 Mar. 2012, which patent applications are incorporated herein by reference.

### FIELD OF THE INVENTION

In general the invention relates to systems of over-the-air broadcasting of digital television (DTV) signals suited for reception by mobile and handset receivers commonly referred to collectively as “M/H” receivers and by “stationary” receivers that customarily remain at one reception site. Each system employs forward-error-correction (FEC) coding of the DTV signals, which are subsequently transmitted using coded orthogonal frequency-division multiplexing (COFDM) of a plurality of carrier waves. Some aspects of the invention more specifically concern transmitters for such systems. Other aspects of the invention more specifically concern both stationary and M/H receivers for such systems.

### BACKGROUND OF THE INVENTION

DTV broadcasting in the United States of America has been done in accordance with broadcasting standards formulated by an industry consortium called the Advanced Television Systems Committee (ATSC). ATSC published a Digital Television Standard in 1995 that employed 8-level vestigial-sideband amplitude modulation of a single radio-frequency (RF) carrier wave. This DTV transmission system is referred to as 8-VSB. In the beginning years of the twenty-first century efforts were made to provide for more robust transmission of data over broadcast DTV channels without unduly disrupting the operation of DTV receivers already in the field. These efforts culminated in an ATSC standard directed to broadcasting digital television and digital data to mobile receivers being adopted on 15 Oct. 2009. This subsequent standard also used 8-level vestigial-sideband amplitude modulation of a single RF carrier wave, so the more robust transmission of data could be time-division multiplexed with the transmission of DTV signal to DTV receivers.

DTV broadcasting in Europe has employed coded orthogonal frequency-division multiplexing (COFDM) that employs a multiplicity of RF carrier waves closely spaced across each 6-, 7- or 8-MHz-wide television channel, rather than a single RF carrier wave per television channel. Adjacent carrier waves are orthogonal to each other. Successive multi-bit symbols are selected from a serial data stream and used to modulate respective ones of the multiplicity of RF carrier waves in turn, in accordance with a conventional modulation scheme—such as quaternary phase shift keying (QPSK) or quadrature amplitude modulation (QAM). QPSK is preferably DQPSK, using differential modulation that is inherently insensitive to slowly changing amplitude and phase distortion. DPSK simplifies carrier recovery in the receiver. Customarily, the QAM is either 16-QAM or 64QAM using square 2-dimensional modulation constellations. In actual practice, the RF carrier waves are not modulated individually. Rather, a single carrier wave is modulated at high symbol rate using QPSK or QAM. The resulting modulated carrier wave is then transformed in a fast inverse discrete Fourier transform (I-DFT) procedure to generate the multiplicity of RF carrier waves each modulated at low symbol rate.

In Europe, broadcasting to hand-held receivers is done using a system referred to as DVB-H. DVB-H (Digital Video Broadcasting-Handheld) is a digital broadcast standard for the transmission of broadcast content to handheld receivers, published in 2004 by the European Telecommunications Standards Institute (ETSI) and identified as EN 302304. DVB-H, as a transmission standard, specifies the physical layer as well as the elements of the lower protocol layers. It uses a power-saving technique based on the time-multiplexed transmission of different services. The technique, called “time slicing”, allows substantial saving of battery power. Time slicing allows soft hand-over as the receiver moves from network cell to network cell. The relatively long power-save periods may be used to search for channels in neighboring radio cells offering the selected service. Accordingly, at the border between two cells, a channel hand-over can be performed that is imperceptible by the user. Both the monitoring of the services in adjacent cells and the reception of the selected service data can utilize the same front-end tuner.

In contrast to other DVB transmission systems, which are based on the DVB Transport Stream adopted from the MPEG-2 standard, the DVB-H system is based on Internet Protocol (IP). The DVB-H baseband interface is an IP interface allowing the DVB-H system to be combined with other IP-based networks. Even so, the MPEG-2 transport stream is still used by the base layer. The IP data are embedded into the transport stream using Multi-Protocol Encapsulation (MPE), an adaptation protocol defined in the DVB Data Broadcast Specification. At the MPE level, DVB-H employs an additional stage of forward error correction called MPE-FEC, which is essentially (255, 191) transverse Reed-Solomon (TRS) coding. The transverse direction is orthogonal to the direction of the (204, 188) Reed-Solomon (RS) coding employed both in DVB-H and in DVB-T terrestrial broadcasting to stationary DTV receivers. This TRS coding reduces the S/N requirements for reception by a handheld device by a 7 dB margin compared to DVB-T. The block interleaver used for the TRS coding creates a specific frame structure, called the “FEC frame”, for incorporating the incoming data of the DVB-H codec.

The physical radio transmission of DVB-H is performed according to the DVB-T standard and employs OFDM multi-carrier modulation. DVB-T employed coded orthogonal frequency division multiplexing (COFDM) in which an 8-MHz-wide radio-frequency (RF) channel comprises somewhat fewer than 2000 or somewhat fewer than 8000 evenly-spaced carriers for transmitting to stationary DTV receivers. DVB-T2, an upgrade of DVB-T proposed in 2011, further permits somewhat fewer than 4000 evenly-spaced carrier waves better to accommodate transmitting to mobile receivers. These choices as to number of carrier waves are commonly referred to as 2K, 8K and 4K options. DVB-H uses only a fraction (e.g., one quarter) of the digital payload capacity of the RF channel.

COFDM may again be considered for DTV broadcasting in the United States of America, where 6-MHz-wide, rather than 8-MHz-wide, RF channels are employed for such broadcasting. The 2K, 8K and 4K options are retained in proposals for such DTV broadcasting, with bit rates being scaled back to suit 6-MHz-wide RF channels. COFDM can also be scaled to fit wider RF channels, such as the 20-MHz-wide RF channels that proponents of a Long Term Evolution (LTE) system of broadcasting envision eventually being used in the United States of America.

COFDM is able to overcome frequency-selective fading quite well, but reception will fail if there is protracted severe flat-spectrum fading. Such flat-spectrum fading is sometimes referred to as a “drop-out” in received signal strength. Such drop-out occurs when the receiving site changes such that a sole effective signal transmission path is blocked by an intervening hill or structure, for example. Because the signaling rate in the individual OFDM carriers is very low, COFDM receivers are capable of maintaining reception despite drop-outs that are only a fraction of a second in duration. However, drop-outs that last as long as a few seconds disrupt television reception perceptibly. Such protracted drop-outs are encountered in a vehicular receiver when the vehicle passes through a tunnel, for example. By way of further example of a protracted drop-out in reception, a stationary receiver may briefly discontinue COFDM reception when receiver synchronization is momentarily lost during dynamic multipath reception conditions, as caused by aircraft flying over the reception site.

Techniques for dealing with protracted drop-outs in received signal strength were developed for 8-VSB DTV broadcasting, and A. L. R. Limberg investigated whether some of them could be adapted for use with COFDM broadcasting similar to DVB-H. The ATSC standard directed to broadcasting digital television and digital data to mobile receivers used TRS coding that extended over 80 or a few more dispersed-in-time short time-slot intervals, rather than being confined to a single longer time-slot interval. A principal purpose of the TRS coding that extended over eighty or so time-slot intervals was overcoming occasional protracted drop-outs in received signal strength. Confining TRS coding to a single longer time-slot interval similar to what is done with MPE-FEC in DVB-H sacrifices such capability, but is advantageous in that error-correction is completed within a shorter time. This helps speed up changes in RF channel tuning, for example.

Iterative-diversity transmissions were proposed to facilitate alternative or additional techniques for dealing with flat-spectrum fading of 8-VSB signals. Some of these proposals were directed to separate procedures being used for decoding earlier and later transmissions of the same coded data to generate respective sets of data packets, each identified after such decoding either as being probably correct or probably incorrect. Corresponding data packets from the two sets were compared, and a further set of data packets was chosen from the ones of the compared data packets more likely to be correct. A. L. R. Limberg proposed delaying earlier transmissions of coded data so as to be concurrent with later transmissions of coded similar data, then decoding the concurrent codings of data in an interdependent way that secures coding gain. Such procedures are described in the list below of A. L. R. Limberg's published patent applications.
1) US-2009-0016432-A1 published 15 Jan. 2009 with the title “Systems for reducing adverse effects of deep fade in DTV signals designed for mobile reception”
2) US-2009-0052544-A1 published 26 Feb. 2009 with the title “Staggercasting of DTV signals that employ serially concatenated convolutional coding”
3) US-2010-0100793-A1 published 22 Apr. 2010 with the title “Digital television systems employing concatenated convolutional coded data”
4) US-2010-0293433-A1 published 18 Nov. 2010 with the title “Burst-error correction methods and apparatuses for wireless digital communications systems”
5) US-2011-0113301-A1 published 12 May 2011 with the title “Diversity broadcasting of Gray-labeled CCC data using 8-VSB AM”.
   After substantial consideration A. L. R. Limberg determined that the techniques these published patent applications describe for implementing iterative-diversity reception can be adapted for use in COFDM broadcasting similar to DVB-H. These techniques employ concatenated convolutional coding (CCC), which is not used in either DVB-T or DVB-H broadcasting. These techniques are hampered in 8-VSB DTV broadcasting by the fact that the inner convolutional coding of the CCC is not independent of the convolutional coding used for ⅔ trellis coding of main-service transmissions, but rather continues that convolutional coding. This constraint can be avoided in a new transmission system employing COFDM. The techniques that employ CCC without puncturing, although very robust, reduce code rate by a factor of three, as compared to non-repeated transmissions with simple one-half-rate convolutional coding (CC) without puncturing.

Iterative-diversity reception implemented at the transfer-stream (TS) data-packet level does not require as much delay memory for the earlier transmitted data as delaying complete earlier transmissions to be concurrent with later transmissions of the same data. This is because the redundant parity bits associated with FEC coding contained in those complete earlier transmissions is removed during its decoding and so do not need to be delayed. However, implementation of diversity reception at the TS data-packet level sacrifices the substantial coding gain that can be achieved by decoding delayed earlier transmissions concurrently with later transmissions of similar data. Implementation of diversity reception at the TS data-packet level is also incompatible with code-combining of delayed earlier transmissions and later transmissions of similar data being used to improve signal-to-noise ratio (SNR).

Code-combining of delayed earlier transmissions and later transmissions of data broadcast for mobile reception is not feasible for 8-VSB DTV transmissions as currently broadcast, since error-correction coding of these transmissions is affected by data broadcast for fixed-site reception for legacy as well as new DTV receivers. Error-correction coding of data for each of different services can be independent of error-correction coding of data for the other services in a new system of COFDM DTV broadcasting intended to replace 8-VSB DTV broadcasting.

With recent developments in so-called “flash” memory, it is becoming feasible to delay complete earlier transmissions of DTV time-slices for a few seconds in physically small memory that consumes little power and is practical for inclusion in a handheld receiver. Developments that will be commercialized in just a few years will make it feasible to delay complete earlier transmissions of DTV time-slices for several seconds within a handheld receiver. It would be well if the development of new DTV broadcast systems took this into consideration, since the adoption of new standards for such broadcasting is likely to take a few years.

U.S. Pat. No. 5,978,365 granted 2 Nov. 1999 to Byung Kwan Yi with title “Communications system handoff operation combining turbo coding and soft handoff techniques” describes turbo decoding procedures in which different elements of parallel concatenated convolutional coding (PCCC) are transmitted by different transmitters in a communications system. The PCCC is utilized to provide for soft hand-offs in reception from one transmitter to reception from another transmitter. The Yi technique can be modified such that the same transmitter transmits different elements of PCCC at different times separated by intervals of a second or more. This alternative provides for iterative-diversity reception not as robust as re-transmitting complete CCC signals. However, this alternative reduces code rate by only a factor of two, as compared to non-repeated transmissions with simple one-half-rate convolutional coding (CC) without puncturing.

DVB-T2 employs low-density parity check (LDPC) coding as forward-error-correction (FEC) coding to help overcome ISI and other AWGN, rather than using concatenated convolutional coding (CCC) or product coding. An LDPC code is based on an H matrix containing a low count of ones. Encoding uses equations derived from the H matrix to generate the parity check bits. Decoding is accomplished using these equations with “soft-decisions” as to transmitted symbols to generate new estimates of the transmitted symbols. This process is repeated in an iterative manner resulting in a powerful decoder. Like parallel concatenated convolutional coding (PCCC), LDPC codes are subject to error floors. Outer coding, such as Bose-Chaudhuri-Hocquenghem (BCH) coding, can be added to LDPC technology to lower the error floor. The BCH coding can be Reed-Solomon (RS) coding, for example. Reportedly, LDPC coding provides AWGN performance that can approach the Shannon Limit even more closely than PCCC. However, LDPC coding may lend itself less well than CCC or product coding to diversity reception, which type of reception helps in addressing impulse and burst noise problems.

Patent application US-2004/0123229-A1 filed for Jung-Im Kim and Young-Jo Ko was published 24 Jun. 2004 with the title “Encoding/decoding apparatus using low density parity check code”. It discloses an encoding/decoding apparatus for a hybrid automatic repeat request system. A first LDPC code encoding apparatus encodes input information data and transmits the encoded data to the decoding apparatus. An interleaver interleaves the input information data. A second LDPC code encoder in parallel with the first LDPC code encoder performs LDPC code encoding on the interleaver response and transmits the encoded data to the decoding apparatus. The first LDPC code encoder transmits an output signal to the decoding apparatus at odd numbered retransmissions in response to a retransmission request from the decoding apparatus. The second LDPC code encoder transmits an output signal to the decoding apparatus at even numbered retransmissions in response to the retransmission request from the decoding apparatus.

Patent application US-2005/0149841-A1 filed for Gyu-Bum Kyung, Hong-Sil Jeong and Jae-Yoel Kim was published 7 Jul. 2005 with the title “Channel encoding/decoding apparatus and method using a parallel concatenated low density parity check code”. US-2005/0149842-A1 describes channel encoding apparatus using a parallel concatenated low density parity check (PCLDPC) coding. A first LDPC encoder generates first parity bits of a first component LDPC coding of information bits. An interleaver interleaves the information bits according to a predetermined interleaving rule, and a second LDPC encoder generates second parity bits of a second component LDPC coding of the interleaved information bits. A controller performs a control operation such that the information bits, the first parity bits from the first component LDPC codes, and the second parity bits from the second component LDPC code are combined to provide a predetermined code rate.

### SUMMARY OF THE INVENTION

COFDM digital television broadcast systems embodying some aspects of the invention transmit different components of the parallel concatenated coding of the same data at separate times more than a second apart. Each component of the parallel concatenated coding includes the same information bits as the other component and parity bits, which are derived differently than the parity bits in the other component. In further aspects of the invention, iterative decoding procedures are preceded by an initial procedure in which a maximal-ratio code combiner combines the soft data bits in the earlier transmitted component of the parallel concatenated coding with the soft data bits in the corresponding later transmitted component of the parallel concatenated coding. This initial procedure generates the soft data bits used in the subsequent iterative decoding procedures, which soft data bits are less susceptible to interruption caused by losses in received signal strength.

In some embodiments of the invention, the parallel concatenated coding is parallel concatenated convolutional coding (PCCC) composed of two convolutional coding (CC) components. The CC of the data earlier transmitted is one portion of PCCC suitable for iterative decoding procedures, and the CC of the data later transmitted is the remaining portion of the same PCCC. In a receiver the earlier CC and the later transmitted CC are combined with each other to reproduce PCCC for being turbo decoded.

In other embodiments of the invention, COFDM digital television broadcast systems transmit different LDPC coding of the same data at separate times more than a second apart. The different LDPC coding of the same data is suitable for iterative decoding procedures in a receiver, which procedures have some similarities to turbo decoding procedures for PCCC. In a receiver the earlier transmitted LDPC coding is delayed so as to be concurrent with the corresponding later transmitted LDPC coding. The delayed earlier transmitted LDPC coding and the corresponding later transmitted LDPC coding are then combined with each other to reproduce parallel concatenated LDPC coding for being iteratively decoded.

### BRIEF DESCRIPTION OF THE DRAWING FIGURES

FIGS. 1 and 2 combine to provide a schematic diagram of a portion of a COFDM transmitter for a DTV system, which transmitter is capable of transmitting pairs of one-half-code-rate CC signals designed for iterative-diversity reception by stationary DTV receivers.

FIGS. 3 and 4 combine to provide a schematic diagram of a portion of a COFDM transmitter for a DTV system, which transmitter is capable of transmitting pairs of one-half-code-rate CC signals designed for iterative-diversity reception by mobile DTV receivers.

FIG. 5 is a diagram of a 64QAM modulation constellation using minimum-energy Gray mapping, as described in a paper in March 2003 IEEE Transactions on Communications, Vol. 51, No. 3 titled “Constellation Mappings for Two-Dimensional Signaling of Nonuniform Sources” and authored by Glen Takahara, Fady Alajaji, Norman C. Beaulieu and Hongyan Kuai.

FIG. 6 is a diagram of a 64QAM modulation constellation described in the same paper by Takahara, Alajaji, Beaulieu and Kuai, which constellation employs optimized mapping that the paper indicates achieves better turbo decoding performance than obtained with Gray mapping per FIG. 5.

FIG. 7 is a diagram of the 64QAM modulation constellation used in DVB-T broadcasting.

FIG. 8 is a diagram of a novel 64QAM modulation constellation using mapping that is bit-complementary to the optimized mapping described by Takahara, Alajaji, Beaulieu and Kuai.

FIG. 9 is a diagram of a 64QAM modulation constellation using minimum-energy Gray mapping, the Gray labeling of which was designed by A. L. R. Limberg to be used with one-half-rate FEC coding.

FIGS. 10A, 10B, 10C, 10D, 10E and 10F are diagrams showing patterns of the first, second, third, fourth, fifth and sixth bits within the 64QAM symbol constellation map of FIG. 9.

FIG. 11 is a diagram showing the nature of the information in the six bits of turbo coding associated with each of the 64 lattice points in the 64QAM symbol constellation shown in FIG. 9.

FIGS. 12, 13 and 14 combine to provide a generic schematic diagram of a stationary DTV receiver adapted for iterative-diversity reception of COFDM signals as transmitted by the portions of the DTV transmitter as depicted in FIGS. 1 and 2, which DTV receiver is novel and embodies aspects of the invention.

FIGS. 15, 16, 17 and 18 combine to provide a generic schematic diagram of a mobile DTV receiver adapted for iterative-diversity reception of COFDM signals as transmitted by the portions of the DTV transmitter depicted in FIGS. 3 and 4, which DTV receiver is novel and embodies aspects of the invention.

FIG. 19 is a more detailed schematic diagram of the maximal-ratio code combiner as shown in FIGS. 13 and 16, which code combiner is connected for receiving pilot-carrier-energy information from one of the pilot and TPS carriers processors as shown in FIGS. 12 and 15.

FIG. 20 is a schematic diagram of a modification of the FIG. 2 portion of a COFDM transmitter for a DTV system, which modified transmitter embodies a further aspect of the invention.

FIG. 21 is a schematic diagram of a modification of the FIG. 4 portion of a COFDM transmitter for a DTV system, which modified transmitter embodies a further aspect of the invention.

FIGS. 22, 23 and 14 combine to provide a generic schematic diagram of a stationary DTV receiver adapted for iterative-diversity reception of COFDM signals as transmitted by the portions of the DTV transmitter as depicted in FIGS. 1 and 20, which DTV receiver is novel and embodies aspects of the invention.

FIGS. 24, 25, 17 and 18 combine to provide a generic schematic diagram of a mobile DTV receiver of mobile/handheld type adapted for iterative-diversity reception of COFDM signals as transmitted by the portions of the DTV transmitter depicted in FIGS. 3 and 21, which DTV receiver is novel and embodies aspects of the invention.

FIG. 26 is a detailed schematic diagram of a modification of any of the turbo decoders shown in FIGS. 13, 16, 23, 25, 33, 34, 37, 39 and 41, in which modification a (204, 188) Reed-Solomon decoder is used to increase the confidence levels of data bits of correct (204, 188) Reed-Solomon codewords as an aid to turbo decoding procedures.

FIG. 27 is a schematic diagram of apparatus for addressing memories of any of the turbo decoders shown in FIGS. 13, 16, 23, 25, 33, 34, 37, 39 and 41.

FIG. 28 is an informal flow chart illustrating the method by which turbo decoding procedures are aided by the (204, 188) Reed-Solomon decoder in any of the turbo decoders shown in FIGS. 13, 16, 23, 25, 33, 34, 37, 39 and 41 as modified per FIG. 26.

FIG. 29 is a schematic diagram of turbo decoding apparatus alternative to any of those shown in FIGS. 13, 16, 23 and 25, which alternative turbo decoding apparatus employs a single SISO decoder instead of two SISO decoders.

FIG. 30 is a schematic diagram of a configuration of the decoders for (204, 188) Reed-Solomon coding and for (255, 191) transverse Reed-Solomon coding, which configuration facilitates interactive two-dimensional Reed-Solomon decoding.

FIG. 31 is an informal flow chart illustrating the method of two-dimensional Reed-Solomon decoding performed by the decoders for (204, 188) Reed-Solomon coding and for (255, 191) transverse Reed-Solomon coding, as connected per FIG. 30.

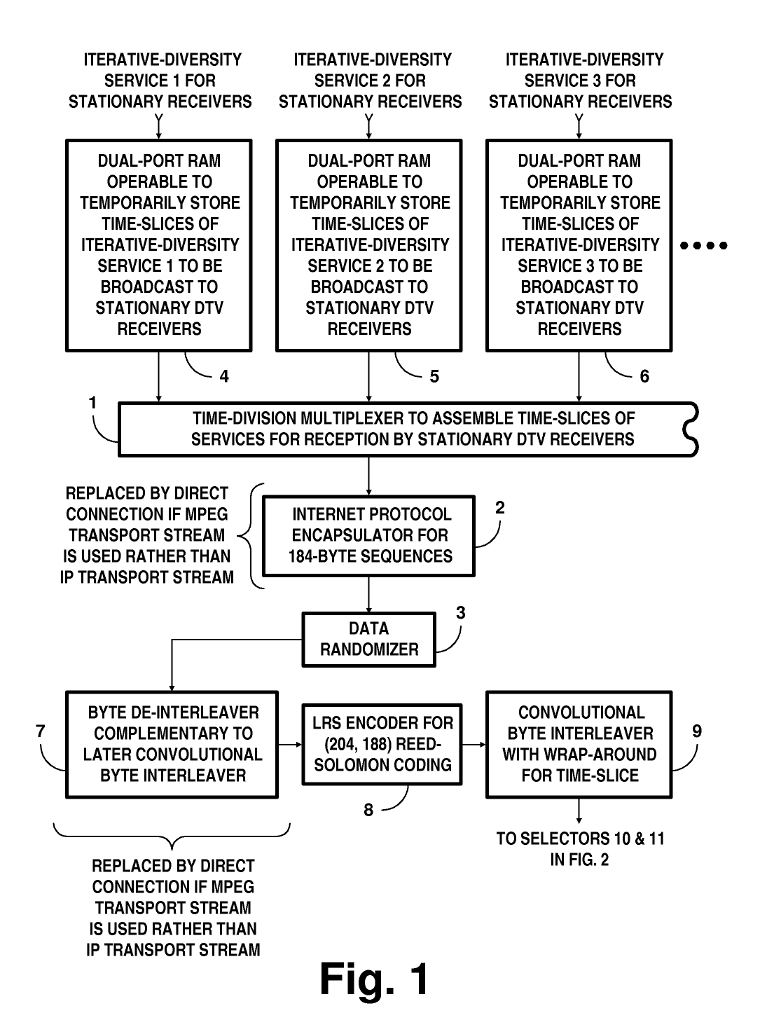

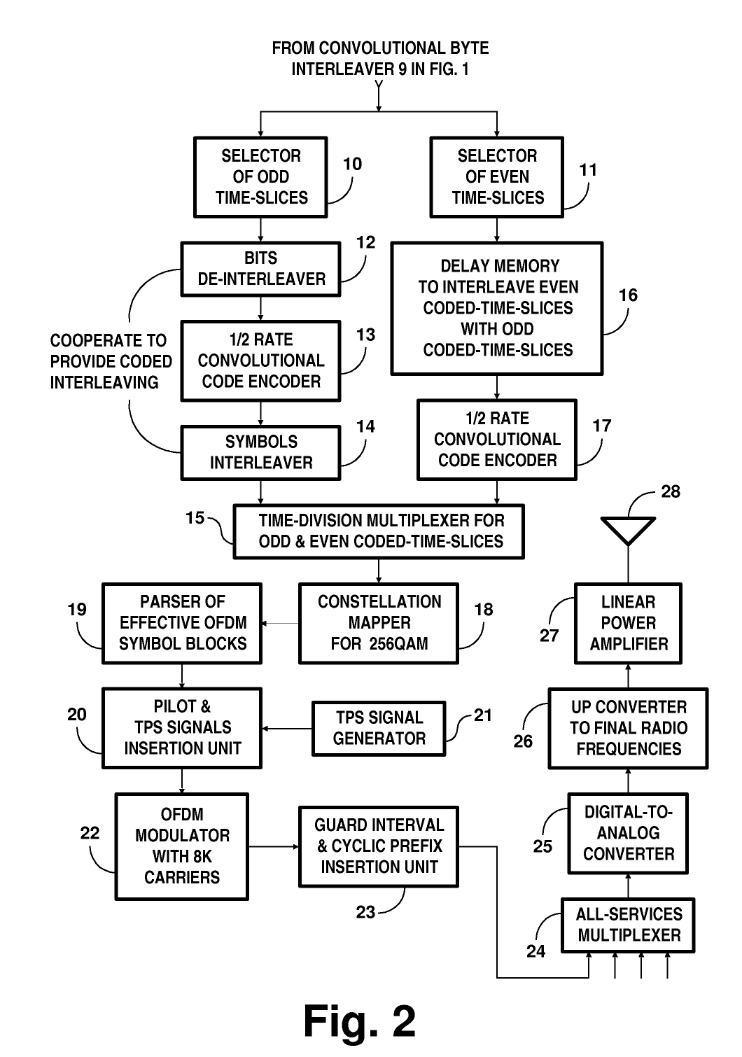

FIGS. 1 and 32 combine to provide a schematic diagram of a portion of a COFDM transmitter for a DTV system, which transmitter is capable of transmitting pairs of one-half-code-rate LDPC-coded signals designed for iterative-diversity reception by stationary DTV receivers.

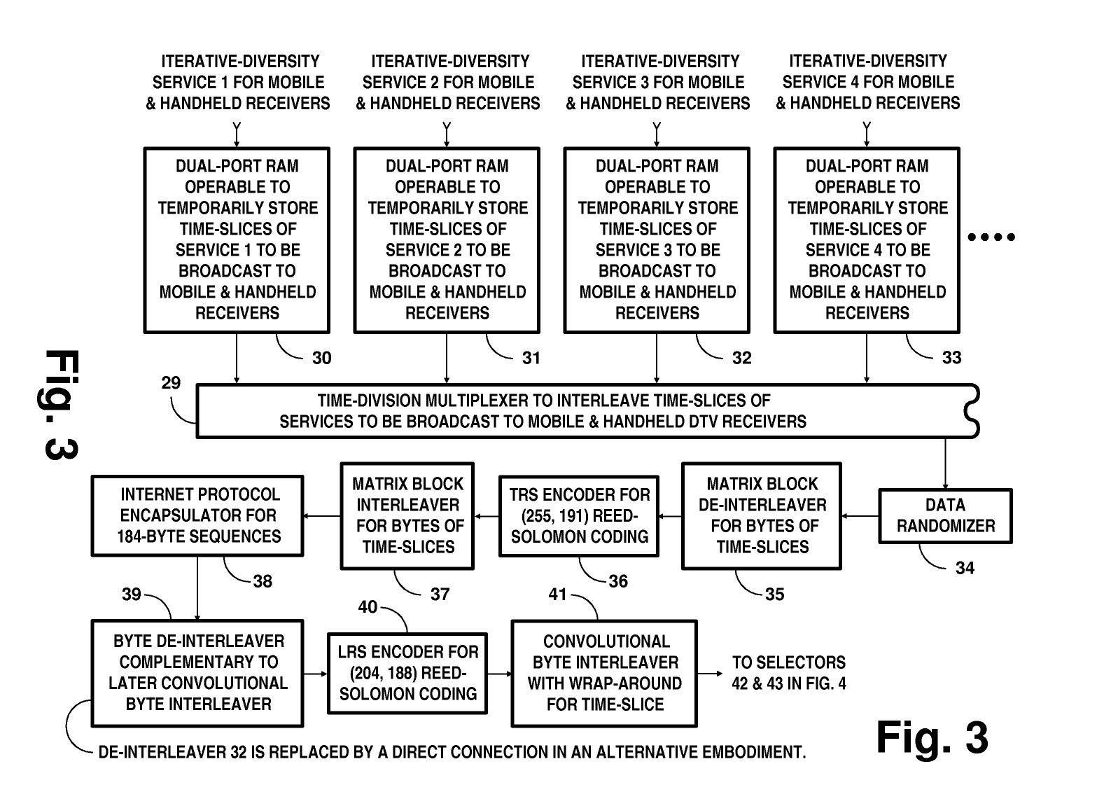

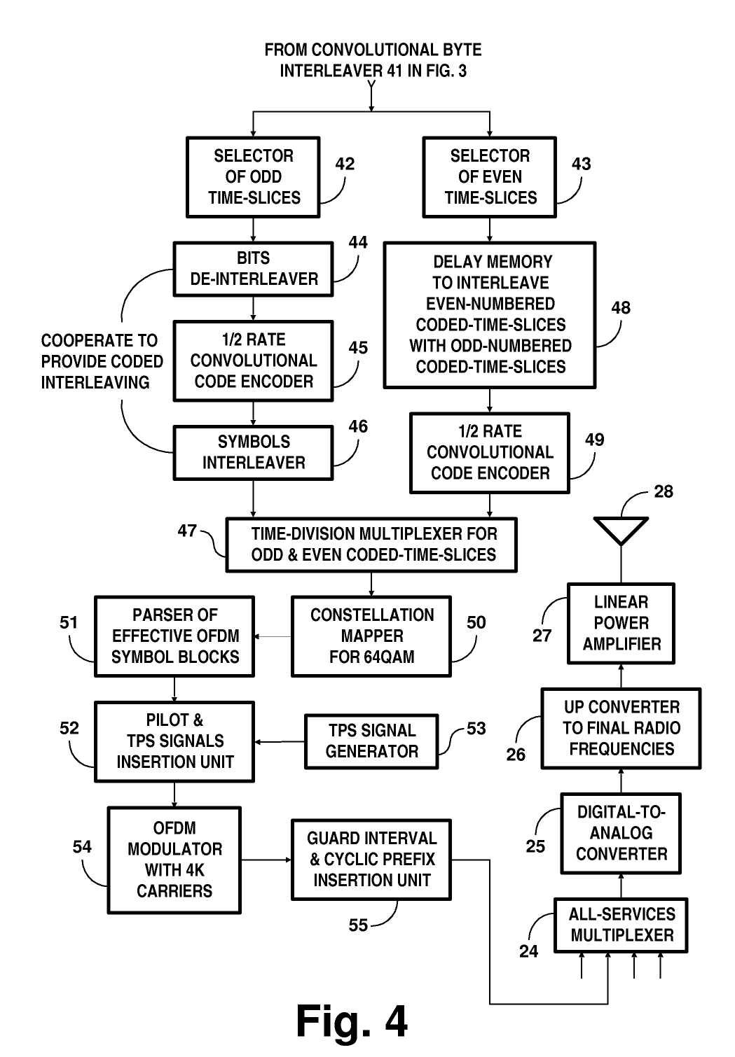

FIGS. 3 and 33 combine to provide a schematic diagram of a portion of a COFDM transmitter for a DTV system, which transmitter is capable of transmitting pairs of one-half-code-rate LDPC-coded signals designed for iterative-diversity reception by mobile DTV receivers.

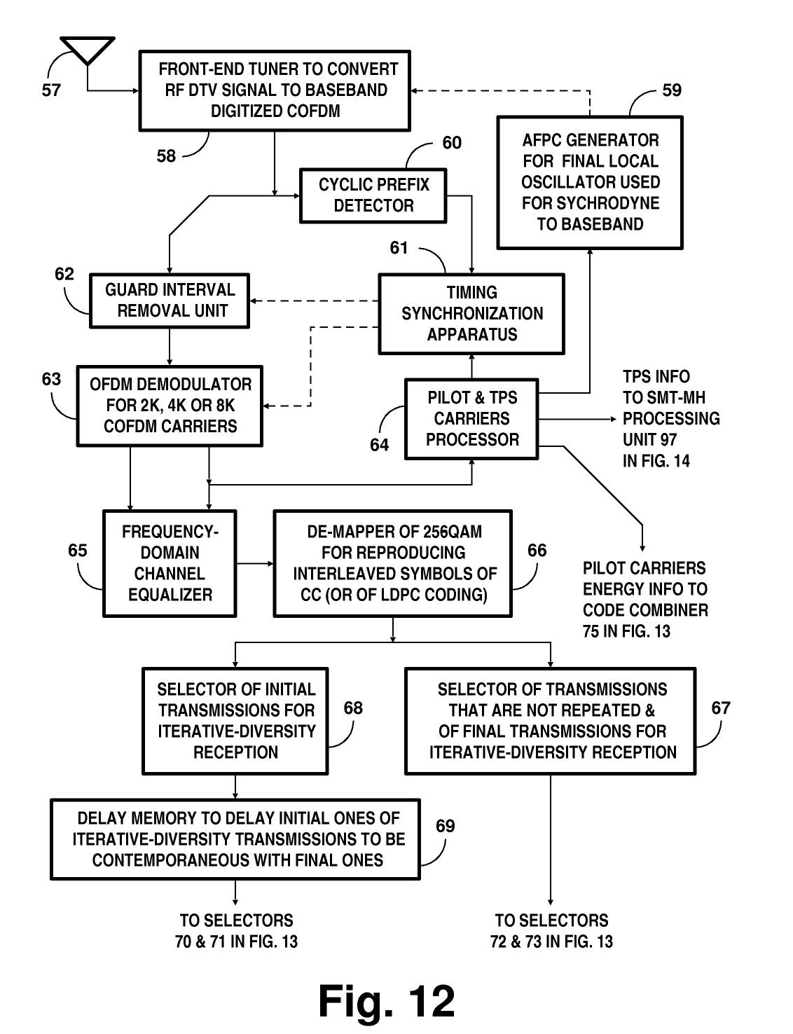

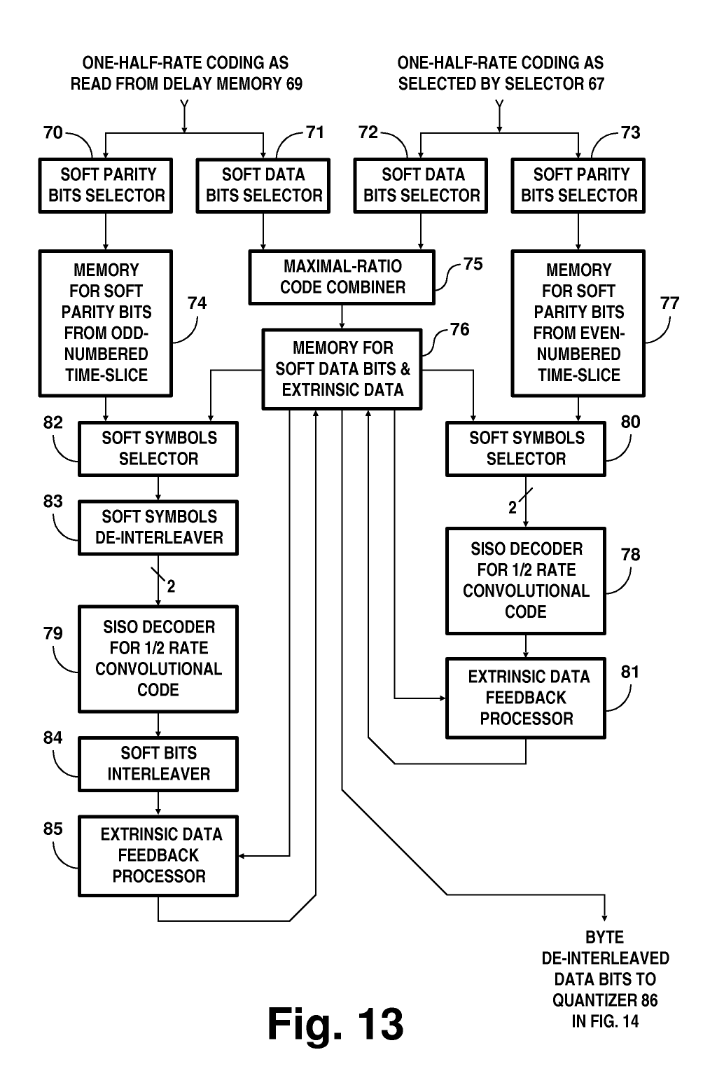

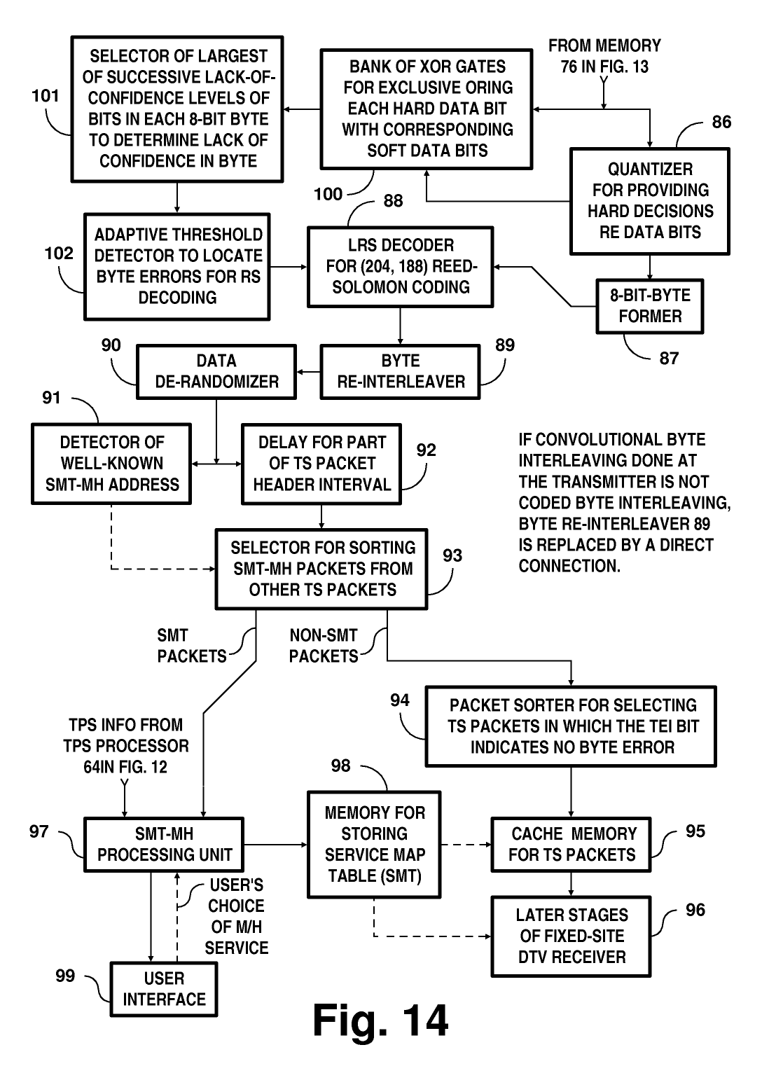

FIGS. 12, 34 and 14 combine to provide a generic schematic diagram of a stationary DTV receiver adapted for iterative-diversity reception of COFDM signals as transmitted by the portions of the DTV transmitter depicted in FIGS. 1 and 32, which DTV receiver is novel and embodies aspects of the invention.

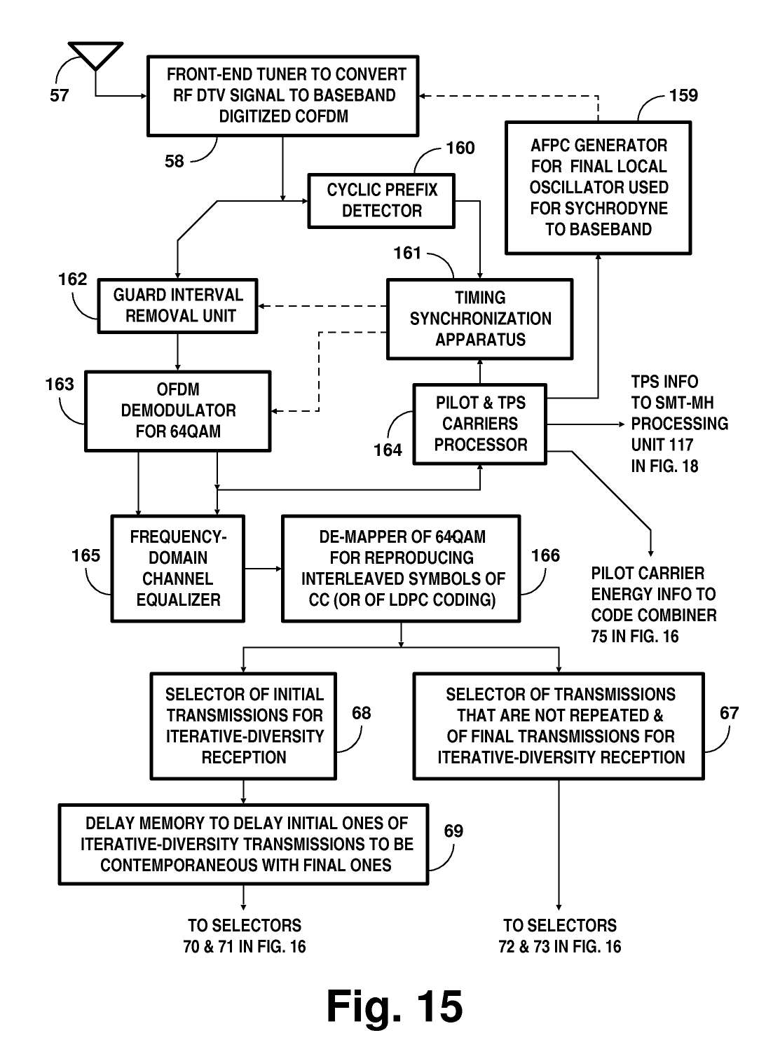

FIGS. 15, 35, 17 and 18 combine to provide a generic schematic diagram of a mobile DTV receiver adapted for iterative-diversity reception of COFDM signals as transmitted by the portions of the DTV transmitter depicted in FIGS. 3 and 33, which DTV receiver is novel and embodies aspects of the invention.

FIG. 36 is a schematic diagram of another modification of the FIG. 2 portion of the COFDM transmitter for a DTV system, which modified transmitter embodies a further aspect of the invention.

FIG. 37 is a schematic diagram of another modification of the FIG. 4 portion of the COFDM transmitter for a DTV system, which modified transmitter embodies a further aspect of the invention.

FIG. 38 combines with FIGS. 12 and 14 to provide a generic schematic diagram of another stationary DTV receiver adapted for iterative-diversity reception of COFDM signals as transmitted by the portions of the DTV transmitter as depicted in FIG. 1 and in FIG. 2 with modifications per FIG. 36, which DTV receiver is novel and embodies aspects of the invention. FIG. 38 combines with FIGS. 15, 17 and 18 to provide a generic schematic diagram of another mobile DTV receiver adapted for iterative-diversity reception of COFDM signals as transmitted by the portions of the DTV transmitter as depicted in FIG. 3 and in FIG. 4 with modifications per FIG. 37, which DTV receiver is novel and embodies aspects of the invention.

FIG. 39 is a schematic diagram of another modification of the FIG. 2 portion of the COFDM transmitter for a DTV system, which modified transmitter embodies a further aspect of the invention.

FIG. 40 combines with FIGS. 12 and 14 to provide a generic schematic diagram of another stationary DTV receiver adapted for iterative-diversity reception of COFDM signals as transmitted by the portions of the DTV transmitter as depicted in FIG. 1 and in FIG. 2 with modifications per FIG. 39, which DTV receiver is novel and embodies aspects of the invention

FIG. 41 is a schematic diagram of another modification of the FIG. 4 portion of the COFDM transmitter for a DTV system, which modified transmitter embodies a further aspect of the invention.

FIG. 42 combines with FIGS. 15, 17 and 18 to provide a generic schematic diagram of a mobile DTV receiver adapted for iterative-diversity reception of COFDM signals as transmitted by the portions of the DTV transmitter depicted in FIG. 3 and in FIG. 4 with modifications per FIG. 41, which DTV receiver is novel and embodies aspects of the invention.

### DETAILED DESCRIPTION

FIGS. 1 and 2 together show a portion of a DTV transmitter generating COFDM signals for reception by stationary DTV receivers. Apparatus for generating bit-wise forward-error-correction (FEC) coding and subsequent COFDM signals is shown in FIG. 2. FIG. 1 depicts apparatus for processing time-slices of services to be broadcast to stationary DTV receivers for iterative-diversity reception.

A time-division multiplexer 1 for interleaving time slices of services to be broadcast to stationary DTV receivers is depicted at the middle of FIG. 1. The time-division multiplexer 1 successively selects time-slices of these various services to be reproduced in its response, which is supplied from its output port. FIG. 1 shows the output port of the multiplexer 1 connected to the input port of an internet protocol encapsulator 2, the output port of which IPE 2 connects to the input port of a data randomizer 3.

The internet protocol encapsulator 2 is used only if the services for reception by stationary DTV receivers use internet-protocol (IP) transport-stream (TS) packets, which packets have varying lengths. An internet-protocol encapsulator (IPE) encapsulates incoming IP-datagrams into MPE (MultiProtocol Encapsulation) sections, which MPE sections are subsequently segmented to fit within the final 184 bytes of 188-byte MPEG-2 TS packets, as defined by the Motion Picture Experts Group (MPEG). The IPE further encapsulates the required PSI/SI (Program Specific Information/Service Information) signaling data that accompany each frame. The original format for services broadcast for reception by stationary DTV receivers may be composed of successive MPEG-2 TS packets, rather than successive IP TS packets. In such case, the IPE 2 is either selectively by-passed or is replaced by a direct connection from the output port of multiplexer 1 to the input port of the data randomizer 3.

Super-frames are customarily composed of four consecutive frames apiece, three frames for respective ones of the services for reception by stationary receivers and a fourth frame comprising a plurality of respective time-slices for respective ones of the services for reception by M/H receivers. Customarily, the duration of each frame is eight time-slice intervals of equal duration, which contain consecutive time-slices considered to be consecutively numbered from first through eighth. There are various ways that the multiplexer 1 could time-division multiplex earlier and later transmissions of data scheduled for iterative-diversity reception by stationary DTV receivers. Time-division multiplexing could be done on a frame-by-frame basis, for example, or half-frame by half-frame. FIG. 1 shows the multiplexer 1 connected for performing the time-division multiplexing time-slice by time-slice—i.e., one-eighth frame by one-eighth frame. Such time-division multiplexing is preferred, partly because it can afford greater flexibility to the broadcasting system insofar as scheduling different services is concerned, provided that the nature of that multiplexing is signaled. The three frames scheduled for reception by stationary DTV receivers altogether contain twenty-four time-slices. By way of example, these twenty-four time-slices can be reapportioned among four services, each provided with only six time-slices per super-frame, rather than eight. Alternatively, adjustments of the time-division multiplexing can be made to take into account whether high-definition or standard-definition DTV signals are transmitted. Remnant pairs of time-slices left over from the services scheduled for reception by stationary DTV receivers can be scheduled for reception by M/H receivers.

Data concerning a first of the services to be transmitted twice to enable iterative-diversity reception by stationary DTV receivers are written to a dual-port random-access memory 4 via a random-access port thereof. The RAM 4 is capable of temporarily storing a number of time-slices of the first service. Successive time-slices of the first service for reception by stationary DTV receivers are read from the serial output port of the RAM 4, ordinarily four odd-numbered time-slices in a single frame per super-frame, to a first input port of the multiplexer 1. As will be described further on in this specification, each of these time-slices will be transmitted twice, one time-slice more than N super-frames apart, to enable iterative-diversity reception by stationary DTV receivers. Typically, there are several super-frames between the two transmissions, N being eight or more.

Data concerning a second of the services to be transmitted twice to enable iterative-diversity reception by stationary DTV receivers are written to a dual-port random-access memory 5 via a random-access port thereof. The RAM 5 is capable of temporarily storing a number of time-slices of the second service. Successive time-slices of the second service for reception by stationary DTV receivers are read from the serial output port of the RAM 5, ordinarily four odd-numbered time-slices in a single frame per super-frame, to a second input port of the multiplexer 1. As will be described further on in this specification, each of these time-slices will be transmitted twice, one time-slice more than N super-frames apart, to enable iterative-diversity reception by stationary DTV receivers.

Data concerning a third of the services to be transmitted twice to enable iterative-diversity reception by stationary DTV receivers are written to a dual-port random-access memory 6 via a random-access port thereof. The RAM 6 is capable of temporarily storing a number of time-slices of the third service. Successive time-slices of the second service for reception by stationary DTV receivers are read from the serial output port of the RAM 6, ordinarily four odd-numbered time-slices in a single frame per super-frame, to a third input port of the multiplexer 1. As will be described further on in this specification, each of these time-slices will be transmitted twice, one time-slice more than N super-frames apart, to enable iterative-diversity reception by stationary DTV receivers.

The bits of the concluding 187-byte portion of each of the data packets supplied to the input port of the data randomizer 3 are exclusive-ORed with a prescribed repeating pseudo-random binary sequence (PRBS) in the data randomizer 3. However, initial synchronizing bytes accompanying the data packets are excluded from such data randomization procedure. By way of example, the PRBS can be the maximal-length 16-bit sequence prescribed in §§4.3.1 of the 1996 European Telecommunication Standard 300 744 titled “Digital Video Broadcasting (DVB); Framing Structure, Channel Coding and Modulation for Digital Terrestrial television (DVB-T)”. Alternatively, the PRBS can be the maximal-length 16-bit one prescribed in §4.2.2 of the 1995 ATSC Digital Television Standard, Annex D. The 16-bit register used to generate the PRBS for data randomization is reset to initial condition at the beginning of each time-slice supplied from the multiplexer 1.

If the services broadcast for reception by stationary DTV receivers employ IP TS packets, the output port of the data randomizer 3 is connected for supplying data-randomized IPE packets to the input port of a byte de-interleaver 7. The output port of the byte de-interleaver 7 is then connected for supplying its byte-interleaved response to the input port of an encoder 8 for (204, 188) Reed-Solomon (RS) forward-error-correction (FEC) coding. In this specification and its claims, the (204, 188) RS FEC coding is referred to as “lateral Reed-Solomon” FEC coding or “LRS” FEC coding to distinguish it from transverse RS FEC coding or “TRS” coding. The words “lateral” and “transverse” also refer to respective directions in which RS coding is done with respect to IPE packets. The output port of the LRS encoder 8 is connected for supplying serially generated (204, 188) RS FEC codewords to the input port of a convolutional byte interleaver 9. The pattern of byte de-interleaving that the byte de-interleaver 7 employs is complementary to the pattern of byte interleaving employed by the subsequent convolutional byte interleaver 9. The byte de-interleaver 7 arranges for the convolutional byte interleaver 9 to provide “coded” or “implied” byte interleaving of (204, 188) RS FEC codewords from the LRS encoder 8.

In a DTV receiver, the decoding of the (204, 188) RS FEC codewords implements error correction, but is not used to validate the correctness of IP packets. The correctness of the IP packets is validated by cyclic-redundancy-check (CRC) coding within them. Some burst errors may exceed the error-correction capability of decoding the (204, 188) RS FEC codewords. If the byte interleaving of (204, 188) RS FEC codewords at the transmitter is not “coded”, byte de-interleaving in the receiver disperses these burst errors that cannot be corrected among a greater number of IP packets than those affected by such burst error when initially received. With “coded” byte interleaving of the (204, 188) RS FEC codewords, the DTV receiver can confine those burst errors that cannot be corrected to fewer data-randomized IP packets. The dispersal of burst errors that cannot be corrected that occurs in byte de-interleaving prior to decoding the (204, 188) RS FEC codewords is counteracted in byte re-interleaving performed after such decoding and before decoding of bitwise FEC-coded IP packets.

If the original format for services broadcast for reception by stationary DTV receivers is composed of successive MPEG-2 TS packets, rather than successive IP TS packets, the byte de-interleaver 7 is either selectively by-passed or is replaced by a direct connection from the output port of the data randomizer 3 to the input port of the LRS encoder 8. In the DTV receiver, the decoding of the (204, 188) RS FEC codewords not only implements error correction, but is used directly to validate the correctness of the MPEG-2 TS packets. Accordingly, “coded” convolutional byte interleaving is not used when the original format for services broadcast for reception by stationary DTV receivers is composed of successive MPEG-2 TS packets.

Preferably, the pattern of byte interleaving for the convolutional byte interleaver 9 is one that wraps around from the conclusion of each time-slice to its beginning. Otherwise, the pattern of byte interleaving can be similar to that used in DVB-T and DVB-H. The convolutional byte interleaver 9 is preferably similar in construction and operation to the convolutional byte interleaver 35 described in more detail further on in this specification. The output port of the convolutional byte interleaver 9 is connected for supplying its response to apparatus for further FEC coding of individual bits of that response, which apparatus is shown in FIG. 2.

FIG. 2 shows apparatus for generating PCCC components and subsequent COFDM signals subsequently transmitted over the air for iterative-diversity reception by stationary DTV receivers. The output port of the convolutional byte interleaver 4 shown in FIG. 1 is connected for supplying the response therefrom to the respective input ports of selectors 10 and 11 shown in FIG. 2. The selector 10 selectively responds to the convolutionally byte-interleaved (204, 188) Reed-Solomon codewords of odd-numbered time-slices supplied to its input port, reproducing them in bit-serial form at its output port. The selector 11 selectively responds to the convolutionally byte-interleaved (204, 188) Reed-Solomon codewords of even-numbered time-slices supplied to its input port, reproducing them in bit-serial form at its output port.

The bit-serial, convolutionally byte-interleaved (204, 188) Reed-Solomon codewords of odd-numbered time-slices are supplied from the output port of the selector 10 to the input port of a bits de-interleaver 12. The output port of the bits de-interleaver 12 is connected for supplying bit de-interleaved response to the input port of a CC encoder 13 for one-half-rate convolutional coding (CC). The output port of the CC encoder 13 is connected for supplying one-half-rate convolutional coding to the input port of a symbols interleaver 14. The bits de-interleaver 12 and the symbols interleaver 14 cooperate to provide coded (or “implied”) interleaving of the data bits and parity bits of the convolutional coding from the output port of the symbols interleaver 14. The symbols interleaver 14 interleaves half-nibble symbols in a way complementary to the way that the bits de-interleaver 12 de-interleaves data bits supplied to the CC encoder 13 for one-half-rate CC. Accordingly, data bits appear in their original order in the symbol-interleaved one-half-rate CC supplied from the output port of the symbol interleaver 14 to a first of two input ports of a time-division multiplexer 15 for odd-numbered and even-numbered coded-time-slices.

The bit-serial, convolutionally byte-interleaved (204, 188) Reed-Solomon codewords of even-numbered time-slices are supplied from the output port of the selector 11 to the input port of a delay memory 16. The output port of the delay memory 16 is connected to the input port of a CC encoder 17 for one-half-rate convolutional coding (CC). The CC encoder 17 is similar in construction and operation to the CC encoder 13. The output port of the CC encoder 17 is connected for supplying one-half-rate CC to the second input port of the time-division multiplexer 15 for odd and even coded-time-slices. The delay memory 17 provides delay that compensates for the latent delays in the bit-de-interleaver 12 and the symbol interleaver 14. So, coded even-numbered time-slices that the CC encoder 17 supplies to the second input port of the time-division multiplexer 15 interleave in time with the odd coded-time-slices that the symbol interleaver 14 supplies to the first input port of the time-division multiplexer 15.

The output port of the multiplexer 15 is connected for supplying the time-division-multiplexed odd and even coded-time-slices to the input port of a constellation mapper 18 for 256-QAM. The output port of the constellation mapper 18 is connected to the input port of a parser 19 for effective OFDM symbol blocks. The block parser 19 parses a stream of complex samples supplied from the constellation mapper 18 into uniform-length sequences of complex samples, each of which sequences is associated with a respective effective OFDM symbol. The output port of the block parser 19 is connected to a first input port of a pilot and TPS signal insertion unit 20, a second input port of which unit 20 is connected to receive Transmission Parameters Signaling (TPS) bits from a TPS signal generator 21. The pilot and TPS signal insertion unit 20 inserts these TPS bits, which are to be transported by modulated dedicated carriers (TPS Pilots), into each effective OFDM symbol block. The pilot and TPS signal insertion unit 20 inserts other bits descriptive of unmodulated carriers of predetermined amplitude and predetermined phase into each effective OFDM symbol block. An output port of the pilot and TPS signal insertion unit 20 is connected for supplying the effective OFDM symbol blocks, with pilot carriers inserted therein, to the input port of an OFDM modulator 22. The OFDM modulator 22 has 8K carriers capability, suitable for transmissions to stationary DTV receivers.

A transmission signal in an OFDM system is transmitted by a unit of a symbol called an OFDM symbol. This OFDM symbol includes an effective symbol that is a signal period in which I-DFT is performed during transmission and a guard interval in which the waveform of a part of the latter half of this effective symbol is directly copied. This guard interval is provided in the former half of the OFDM symbol. In the OFDM system, such a guard interval is provided to improve performance during multi-path reception. Plural OFDM symbols are collected to form one OFDM transmission frame. For example, in the ISDB-T standard, ten OFDM transmission frames are formed by two hundred four OFDM symbols. Insertion positions of pilot signals are set with this unit of OFDM transmission frames as a reference.

The OFDM modulator 22 includes a serial-to-parallel converter for converting the serially generated complex digital samples of the effective OFDM symbols to parallel complex digital samples for inverse discrete Fourier transformation (I-DFT). The OFDM modulator 22 further includes a parallel-to-serial converter for converting the parallel complex digital samples of the I-DFT results to serial complex digital samples of the I-DFT results supplied from the output port of the OFDM modulator 22 to the input port of a guard-interval-and-cyclic-prefix insertion unit 23. The output port of the guard-interval-and-cyclic-prefix insertion unit 23 is connected for supplying successive complex digital samples of a COFDM signal to a first input port of an all-services multiplexer 24.

The output port of the all-services multiplexer 24 is connected to the input port of a digital-to-analog converter 25. FIG. 2 shows the output port of the DAC 25 is connected for supplying its analog COFDM signal response to the input port of an up-converter 26 for converting baseband-frequency analog COFDM signal to very-high-frequency (VHF) or ultra-high-frequency (UHF) analog COFDM signal. The output port of the up-converter 26 is connected for supplying analog COFDM signal at radio frequencies to the input port of a linear power amplifier 27. FIG. 2 shows the output port of the linear power amplifier 27 connected for driving RF analog COFDM signal power to a transmission antenna 28. FIG. 2 omits showing details, such as band-shaping filters for the RF signals.

FIGS. 3 and 4 together show a further portion of the DTV transmitter generating COFDM signals for reception by M/H DTV receivers. Apparatus for generating PCCC and subsequent COFDM signals is shown in FIG. 4. FIG. 3 shows apparatus for processing time-slices for iterative-diversity reception. A time-division multiplexer 29 to assemble time-sliced services for reception by mobile and handheld receivers is shown somewhat above the middle of FIG. 3.

Data concerning a first of the services to be transmitted twice to enable iterative-diversity reception by M/H DTV receivers are written into storage locations within a dual-port random-access memory 30 via a random-access port thereof. The RAM 30 is capable of temporarily storing a number at least N+1 of time-slices of the first service to be transmitted twice to enable iterative-diversity reception by M/H DTV receivers. The dual-port RAM 30 has a serial output port connected to a first input port of the multiplexer 29 of time-sliced services for reception by M/H receivers. Successive time-slices of the first service for iterative-diversity reception by M/H receivers are read from the serial output port of the RAM 30, one odd-numbered time-slice per super-frame, to support the initial transmissions of those time-slices. The successive time-slices of the first service for iterative-diversity reception by mobile receivers are read again from the serial output port RAM 30, one even-numbered time-slice per super-frame, to support the final transmissions of those time-slices.

Data concerning a second of the services to be transmitted twice to enable iterative-diversity reception by M/H DTV receivers are written into storage locations within a dual-port random-access memory 31 via a random-access port thereof. The RAM 31 is capable of temporarily storing a number at least N+1 of time-slices of the second service to be transmitted twice to enable iterative-diversity reception by M/H DTV receivers. The dual-port RAM 31 has a serial output port connected to a second input port of the multiplexer 29 of time-sliced services for reception by M/H receivers. Successive time-slices of the second service for iterative-diversity reception by M/H receivers are read from the serial output port of the RAM 31, one odd-numbered time-slice per super-frame, to support the initial transmissions of those time-slices. The successive time-slices of the second service for iterative-diversity reception by mobile receivers are read again from the serial output port RAM 31, one even-numbered time-slice per super-frame, to support the final transmissions of those time-slices.

Data concerning a third of the services to be transmitted twice to enable iterative-diversity reception by M/H DTV receivers are written into storage locations within a dual-port random-access memory 32 via a random-access port thereof. The RAM 32 is capable of temporarily storing a number at least N+1 of time-slices of the third service to be transmitted twice to enable iterative-diversity reception by M/H DTV receivers. The dual-port RAM 32 has a serial output port connected to a third input port of the multiplexer 29 of time-sliced services for reception by M/H receivers. Successive time-slices of the third service for iterative-diversity reception by M/H receivers are read from the serial output port of the RAM 32, one odd-numbered time-slice per super-frame, to support the initial transmissions of those time-slices. The successive time-slices of the third service for iterative-diversity reception by mobile receivers are read again from the serial output port RAM 32, one even-numbered time-slice per super-frame, to support the final transmissions of those time-slices.

Data concerning a fourth of the services to be transmitted twice to enable iterative-diversity reception by M/H DTV receivers are written into storage locations within a dual-port random-access memory 33 via a random-access port thereof. The RAM 33 is capable of temporarily storing a number at least N+1 of time-slices of the fourth service to be transmitted twice to enable iterative-diversity reception by M/H DTV receivers. The dual-port RAM 33 has a serial output port connected to a fourth input port of the multiplexer 29 of time-sliced services for reception by M/H receivers. Successive time-slices of the fourth service for iterative-diversity reception by M/H receivers are read from the serial output port of the RAM 33, one odd-numbered time-slice per super-frame, to support the initial transmissions of those time-slices. The successive time-slices of the fourth service for iterative-diversity reception by mobile receivers are read again from the serial output port RAM 30, one even-numbered time-slice per super-frame, to support the final transmissions of those time-slices.

The respective time-slices from each of services for reception by M/H receivers that the time-division multiplexer 29 assembles are supplied from the output port of the multiplexer 29 to the input port of a data randomizer 34. The construction of the data randomizer 34 is similar to that of the data randomizer 2. FIG. 3 shows the output port of the data randomizer 34 connected to the input port of a block de-interleaver 35 for bytes of time-slices. The block de-interleaver 35 is of matrix type and preferably is constructed from two banks of byte-organized dual-ported random-access memory, each of which banks has 35,144 m addressable byte-storage locations arranged in 184m columns and 191 rows, m being an integer multiplier ranging between one and seven, inclusive. Byte-storage locations in a first bank of the RAM are written to during odd-numbered time-slice intervals, while byte-storage locations in the second bank of the RAM are read from. Byte-storage locations in the second bank of the RAM are written to during even-numbered time-slice intervals, while byte-storage locations in the first bank of the RAM are read from. The response of the from the output port of the data randomizer 34 is supplied to the random-access write-input port of the RAM to be written into byte-storage locations row by row. After the 191 rows of byte-storage locations have been written or re-written by the data randomizer 34 response, the contents of the byte-storage locations are read column by column from the serial read-output port of the RAM to the input port of a TRS encoder 36, used for (255, 191) transverse Reed-Solomon (TRS) forward-error-correction (FEC) coding of the block de-interleaver 35 response.

The output port of the TRS encoder 36 is connected for supplying (255, 191) TRS codewords to the input port of a block interleaver 37 for bytes from those (255, 191) TRS codewords. The output port of the block interleaver 37 connects to the input port of an internet protocol encapsulator (IPE) 38. The block interleaver 37 is of matrix type and preferably is constructed from two banks of byte-organized dual-ported random-access memory, each of which banks has 46,920 m addressable byte-storage locations arranged in 184m columns and 255 rows. Byte-storage locations in a first bank of the RAM are written to during odd-numbered time-slice intervals, while byte-storage locations in the second bank of the RAM are read from. Byte-storage locations in the second bank of the RAM are written to during even-numbered time-slice intervals, while byte-storage locations in the first bank of the RAM are read from. The (255, 191) TRS codewords from the output port of the TRS encoder 36 are supplied to the random-access write-input port of the RAM to be written into byte-storage locations column by column. After the 184 columns of byte-storage locations have been written or re-written by respective (255, 191) TRS codewords, the contents of the byte-storage locations are read row by row from the serial read-output port of the RAM to the input port of the IPE 38.

The IPE 38 performs functions concerning transmissions for iterative reception by M/H receivers similar to those described supra as being performed by the IPE 2 concerning transmissions for iterative reception by fixed-site DTV receivers. The IPE 38 also introduces signaling regarding the time-slicing transmissions of data in bursts, each burst including a respective FEC frame together with MPE timing information that let receivers know when to expect the next burst of data. The relative amount of time from the beginning of this MPE frame to the beginning of the next burst is indicated within a burst in the header of each MPE frame. This enables an M/H receiver to shut down between bursts, thereby minimizing power consumption and preserving battery life.

In transmissions made per the DVB-H standard, further signaling information in regard to time-slicing, such as burst duration, is included in the time_slice_fec_identifier_descriptor in the INT (IP/MAC Notification Table). Some of this information is also sent within Transmission Parameters Signaling (TPS) bits that are transported by dedicated carriers (TPS Pilots) in the COFDM (Coded Orthogonal Frequency Division Multiplexing) signal so as to be more quickly and easily available to receivers. This relieves a receiver of the need to decode MPEG2 and PSI/SI information. Such further time-slicing signaling information can be transmitted in tabular format prescribed in a standard developed for broadcasting in the United States of America, as well as some of this information being sent as TPS bits.

FIG. 3 shows the output port of the IPE 38 connected for supplying data-randomized IPE packets to the input port of a byte de-interleaver 39, the output port of which is connected for supplying byte-deinterleaved data-randomized IPE packets to the input port of an LRS encoder 40 for (204, 188) Reed-Solomon (RS) forward-error-correction (FEC) coding. The output signal from the LRS encoder 40 reproduces the 188-byte segments of the byte de-interleaver 39 response, but appends to each of those 188-byte segments a respective set of sixteen parity bytes for the (204, 188) RS FEC coding, as calculated by the LRS encoder 40. The output port of the LRS encoder 40 is connected for supplying the resulting (204, 188) RS codewords as input signal to the input port of a convolutional byte interleaver 41, which is preferably similar in construction and operation to the convolutional byte interleaver 9. The output port of the convolutional byte interleaver 41 is connected for supplying its response to apparatus for further FEC coding of individual bits of that response, which apparatus can be as shown in FIG. 4 for example.

The pattern of byte de-interleaving the byte de-interleaver 39 employs is complementary to the pattern of byte interleaving employed by the subsequent convolutional byte interleaver 41. The byte de-interleaver 39 arranges for the convolutional byte interleaver 41 to provide “coded” or “implied” byte interleaving of (204, 188) RS FEC codewords from the LRS encoder 40. Referring back to the TRS encoding operations, the pattern of byte de-interleaving the block interleaver 37 employs is complementary to the pattern of byte interleaving employed by the preceding block de-interleaver 35. The block de-interleaver 35 arranges for the block interleaver 37 to provide “coded” or “implied” byte interleaving of (255, 191) TRS FEC codewords from the TRS encoder 36. Some burst errors may exceed the error-correction capability of decoding the (204, 188) RS FEC codewords and may then also exceed the error-correction capability of decoding the (255, 191) RS FEC codewords. If the byte interleaving of (204, 188) RS FEC codewords and of (255, 191) TRS FEC codewords at the transmitter is not “coded”, byte de-interleaving in the receiver disperses burst errors that cannot be corrected among a greater number of IP packets than those affected by such burst error when initially received. With “coded” byte interleaving of the (204, 188) RS FEC codewords and of the (255, 191) RS FEC codewords, the DTV receiver can confine to fewer data-randomized IP packets those burst errors that cannot be corrected.

Super-frames are customarily composed of four consecutive frames apiece, a fourth frame of each super-frame comprising eight respective time-slices for reception by M/H receivers. Preferably, these eight time-slices are apportioned in the following way among the services scheduled for iterative-diversity reception by M/H receivers. Initial and final transmissions of a first of the services scheduled for iterative-diversity reception by M/H receivers are transmitted in respective ones of the first and second of the time-slices in each fourth frame. Initial and final transmissions of a second of the services scheduled for iterative-diversity reception by M/H receivers are transmitted in respective ones of the third and fourth of the time-slices in each fourth frame. Initial and final transmissions of a third of the services scheduled for iterative-diversity reception by M/H receivers are transmitted in respective ones of the fifth and sixth of the time-slices in each fourth frame. Initial and final transmissions of a fourth of the services scheduled for iterative-diversity reception by M/H receivers are transmitted in respective ones of the seventh and eighth of the time-slices in each fourth frame. This protocol for apportioning time slices among the services scheduled for iterative-diversity reception is well suited for selectively energizing an M/H receiver only for receiving one of those services. This protocol permits the front-end tuner of the M/H receiver to be powered up just once in each fourth frame, rather than having to be powered up twice in each fourth frame. This reduces the time taken for settling of the front-end tuner before actively receiving the service selected for reception. If a service scheduled for iterative-diversity reception by M/H receivers requires more than two data slices within each fourth frame, arranging the data slices so as to be consecutive in time permits the front-end tuner of the M/H receiver still to be powered up just once in each fourth frame, rather than having to be powered up more times in each fourth frame.

The convolutional byte interleaver 41 is preferably similar in construction and operation to the convolutional byte interleaver 9. The convolutional byte interleaver 41 is preferably designed to exhibit wrap-around of the pattern of byte interleaving for each successive time-slice that the LRS encoder 35 supplies within each frame. The convolutional byte interleaver 9 is preferably designed to exhibit wrap-around of the pattern of byte interleaving for each successive time-slice that the LRS encoder 8 supplies within each frame. Providing wrap-around of the pattern of byte interleaving for each successive time-slice in each frame avoids byte interleaving continuing from one time-slice or frame to a succeeding time-slice or frame. This facilitates a DTV receiver being selectively powered up just for receiving bursts of data, so as to conserve drain from a battery power supply.

Such wrap-around of the byte-interleaving pattern also facilitates iterative-diversity reception of selected data bursts by DTV receivers when single-time transmissions are intermixed with the transmissions for iterative-diversity reception. The initial and final transmissions of the same time-slice will not be subject to being affected differently by respective foregoing transmissions of other coding. This facilitates maximal-ratio combining of those initial and final transmissions of same time-slices by a DTV receiver. Except for wrapping around each consecutive time-slice, the pattern of byte interleaving can otherwise be similar to that used by the Europeans in DVB-T and DVB-H. DVB-T and DVB-H use a 12-branch shift register configuration for Forney type convolutional byte interleaving that spaces bytes of a (204, 188) RS codeword at 17-byte-epoch intervals.

If wrap-around of the pattern of byte interleaving from the conclusion of each successive time-slice to its beginning is not employed, the convolutional byte interleaving depth of seventeen 204-byte segments causes the combined latent delay in the transmitter byte interleaver and receiver byte de-interleaver to be slightly more than 2 milliseconds. If wrap-around of the pattern of byte interleaving from the conclusion of each successive time-slice to its beginning is employed, the transmitter introduces additional delay of slightly more than 2 milliseconds waiting for the results of initial byte interleaving without wrap-around followed by byte de-interleaving before final byte interleaving with wrap-around can proceed. I.e., final byte interleaving requires knowledge of the concluding bytes of the pattern of convolutional byte interleaving so as to be able to insert those bytes as the wrap-around bytes near the beginning of the final byte interleaving.

The nature of the convolutional byte interleaving performed by the byte interleaver 9 and by the byte interleaver 41 is such that sustained burst noise extending for as many as seventeen rows of the 204-byte-wide data field will cause no more than sixteen byte errors in any (204, 188) RS codeword. If byte errors in a (204, 188) RS codeword are located externally to the codeword, as many as sixteen byte errors in the codeword can be corrected during its decoding in the M/H receiver. The results of previous decoding of bit-wise FEC coding can be processed to locate byte-errors for decoding (204, 188) RS codewords. If byte errors in a (204, 188) RS codeword have to be located internally, within the codeword itself, only up to eight byte errors in the codeword can be corrected during its decoding in the M/H receiver. Sustained burst noise extending for as many as nine rows of the 204-byte-wide data field can still be corrected by the decoder for (204, 188) RS codewords.

The nature of the convolutional byte interleaving by the byte interleaver 41 is such that sustained burst noise extending for as many as eighty rows of the 204-byte-wide data field will cause no more than sixty-four byte errors in any (255, 191) RS codeword. If byte errors in a (255, 191) RS codeword are located externally to the codeword, as many as sixty-four byte errors in the codeword can be corrected during its decoding in the M/H receiver. The results of previous decoding of bit-wise FEC coding can be processed to locate byte-errors for decoding (255, 191) RS codewords. Alternatively, the results of decoding (204, 188) RS codewords can be used to locate byte-errors for decoding (255, 191) RS codewords. The results of decoding (204, 188) RS codewords can also be used to refine the location of byte-errors for decoding (255, 191) RS codewords, as determined by processing the results of previous decoding of bit-wise FEC coding. If byte errors in a (255, 191) RS codeword have to be located internally, within the codeword itself, only up to thirty-two byte errors in the codeword can be corrected.

FIG. 4 shows apparatus for generating PCCC components and subsequent COFDM signals subsequently transmitted over the air for reception by M/H receivers. The output port of the convolutional byte interleaver 41 shown in FIG. 3 is connected for supplying the response therefrom to the respective input ports of selectors 42 and 43 shown in FIG. 4. The selector 42 selectively responds to the convolutionally byte-interleaved (204, 188) Reed-Solomon codewords of odd-numbered time-slices supplied to its input port, reproducing them in bit-serial form at its output port. The selector 43 selectively responds to the convolutionally byte-interleaved (204, 188) Reed-Solomon codewords of even-numbered time-slices supplied to its input port, reproducing them in bit-serial form at its output port.

The bit-serial, convolutionally byte-interleaved (204, 188) RS codewords of odd-numbered time-slices supplied from the output port of the selector 42 are supplied to the input port of a bits de-interleaver 44. The output port of the bits de-interleaver 44 is connected for supplying bit de-interleaved response to the input port of a CC encoder 45 for one-half-rate convolutional coding (CC). The output port of the CC encoder 45 is connected for supplying one-half-rate CC to the input port of a symbols interleaver 46. The bits de-interleaver 44 and the symbols interleaver 46 cooperate to provide coded (or “implied”) interleaving of the data bits and parity bits of the CC from the output port of the symbols interleaver 46. The symbols interleaver 46 interleaves half-nibble symbols in a way complementary to the way that the bits de-interleaver 44 de-interleaved data bits supplied to the CC encoder 45 for one-half-rate convolutional coding. Accordingly, data bits appear in their original order in the symbol-interleaved one-half-rate CC supplied from the output port of the symbol interleaver 46 to a first of two input ports of a time-division multiplexer 47 for odd-numbered and even-numbered coded time-slices.

The bit-serial, convolutionally byte-interleaved (204, 188) RS codewords of even-numbered time-slices supplied from the output port of the selector 43 are delayed by delay memory 48 for application to the input port of a CC encoder 49 for one-half-rate convolutional coding (CC). The CC encoder 49 is similar in construction and operation to the CC encoder 45. The output port of the CC encoder 49 is connected for supplying one-half-rate CC to the second input port of the time-division multiplexer 47 for odd and even coded-time-slices. The delay introduced by the delay memory 48 compensates for the latent delays in the bits de-interleaver 44 and the symbols interleaver 46. Accordingly, the even-numbered coded-time-slices supplied from the output port of the CC encoder 49 to the second input port of the time-division multiplexer 47 interleave in time with the odd-numbered coded-time-slices that the symbols interleaver 46 supplies to the second input port of the time-division multiplexer 47.

The output port of the time-division multiplexer 47 is connected for supplying the multiplexed odd-numbered and even-numbered coded-time-slices to the input port of a constellation mapper 50 for 64QAM. The output port of the constellation mapper 50 is connected to the input port of a parser 51 for effective OFDM symbol blocks. The block parser 51 parses a stream of complex samples supplied from the constellation mapper 50 into uniform-length sequences of complex samples, each of which sequences is associated with a respective effective OFDM symbol. The output port of the block parser 51 is connected to a first input port of a pilot and TPS signal insertion unit 52, a second input port of which unit 52 is connected to receive Transmission Parameters Signaling (TPS) bits from a TPS signal generator 53. The pilot and TPS signal insertion unit 52 inserts these TPS bits, which are to be transported by dedicated carriers (TPS Pilots), into each effective OFDM symbol block. The pilot and TPS signal insertion unit 52 inserts other bits descriptive of unmodulated carriers of predetermined amplitude and predetermined phase into each effective OFDM symbol block. An output port of the pilot and TPS signal insertion unit 52 is connected for supplying the effective OFDM symbol blocks with pilot carriers inserted therein to the input port of an OFDM modulator 54. The OFDM modulator 54 has 4K carriers capability, suitable for transmissions to M/H DTV receivers.

The OFDM modulator 54 includes a serial-to-parallel converter for converting the serially generated complex digital samples of the effective OFDM symbols to parallel complex digital samples for inverse discrete Fourier transformation (I-DFT). The OFDM modulator 54 further includes a parallel-to-serial converter for converting the parallel complex digital samples of the I-DFT results to serial complex digital samples of the I-DFT results supplied from the output port of the OFDM modulator 54 to the input port of a guard-interval-and-cyclic-prefix insertion unit 55. The output port of the guard-interval-and-cyclic-prefix insertion unit 55 is connected for supplying successive complex digital samples of a COFDM signal to a second input port of the all-services multiplexer 24.

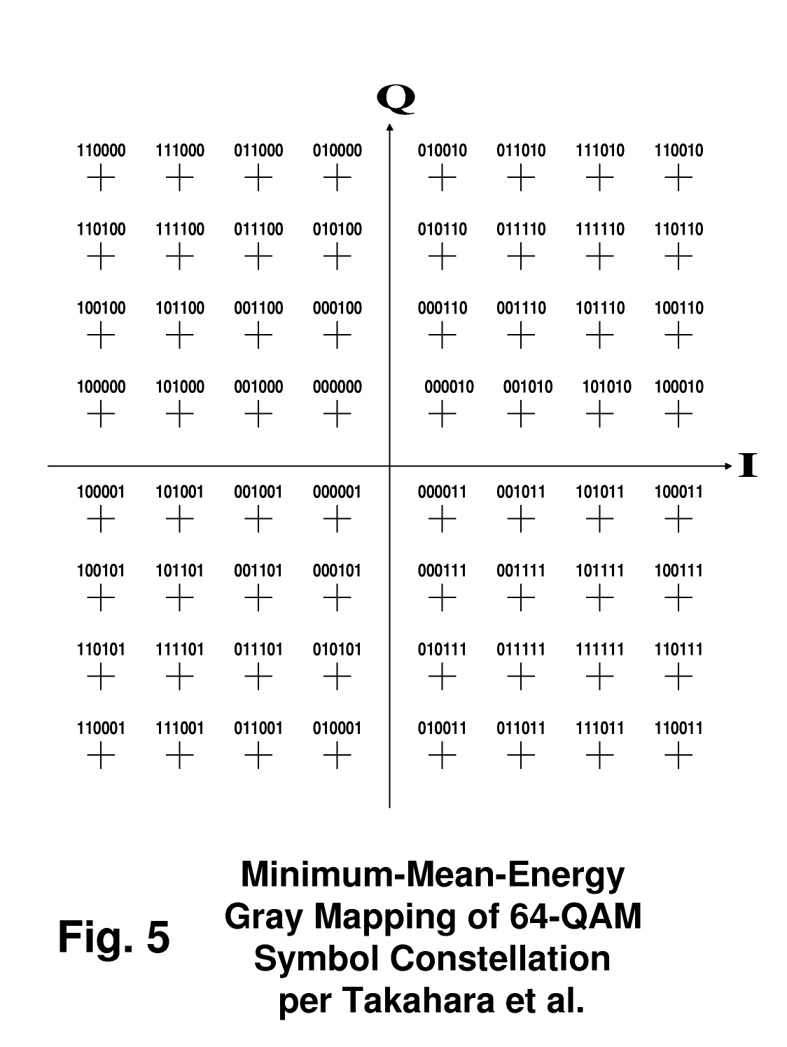

FIG. 5 is a diagram of a 64QAM modulation constellation using minimum-energy Gray mapping that is described by Glen Takahara, Fady Alajaji, Norman C. Beaulieu and Hongyan Kuai in their paper “Constellation Mappings for Two-Dimensional Signaling of Nonuniform Sources” published in IEEE TRANSACTIONS ON COMMUNICATIONS, Vol. 51, No. 3, March 2003, pp. 400-408. The minimum-energy Gray mapping provides a zero-mean constellation when used with random data all possible values of which have uniform likelihood of occurrence. The FIG. 5 constellation can be reversed one way left for right, or reversed one way top for bottom, or reversed both ways to form other constellations having respective minimum-energy Gray mappings. Any of these constellations can be rotated 90 degrees to form still further constellations having respective minimum-energy Gray mappings.

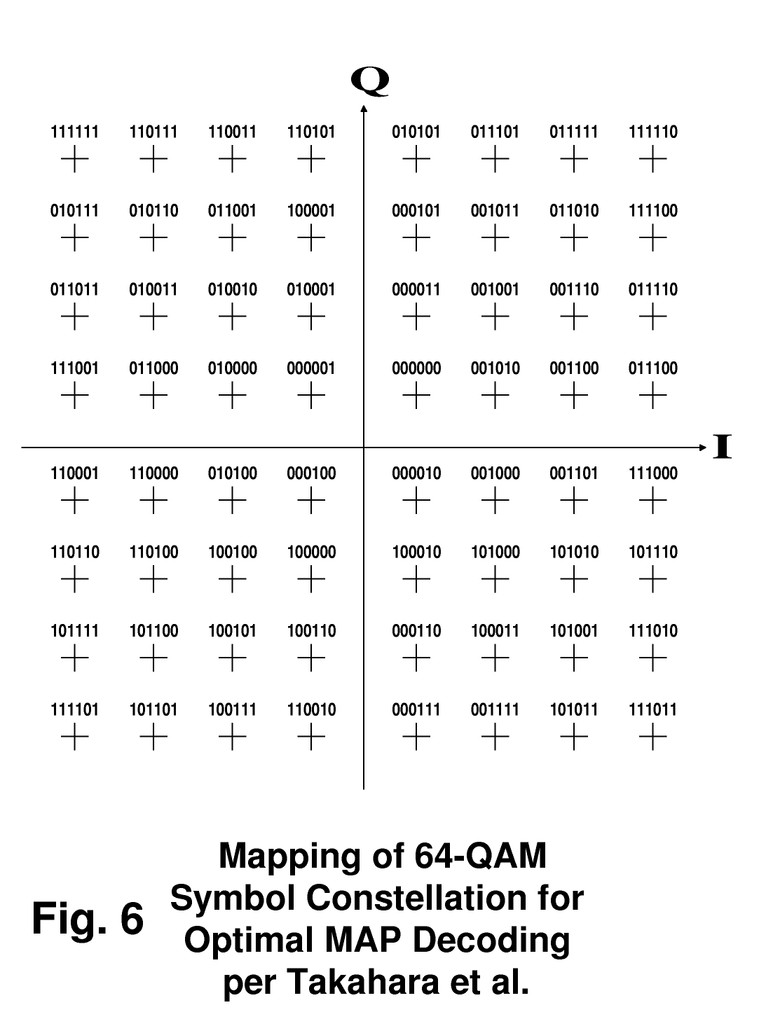

FIG. 6 is a diagram of a 64QAM modulation constellation using a mapping that the paper by Takahara, Alajaji, Beaulieu and Kuai indicates to be better than Gray mapping when the convolutionally coded information in the baseband signal is to be decoded using a maximum a posteriori (MAP) detector, rather than a maximum-likelihood (ML) detector. A variant of the MAP detector called a log-MAP detector is customarily used, in which the extensive multiplication procedures involved in MAP detection are performed by additions of logarithms. A turbo decoder comprising two log-MAP detectors in the turbo loop is preferred for decoding the CCC used in the modified DVB-H signals described supra. Presuming the CCC to be PCCC, the turbo decoder can take a form similar to that described by Matthew C. Valenti and Jian Sun in their paper “The UMTS Turbo Code and an Efficient Decoder Implementation Suitable for Software-Defined Radios”. The paper was published in International Journal of Wireless Information Networks, Vol. 8, No. 4, October 2001, pp. 203-215. The FIG. 5 constellation can be reversed one way left for right, or reversed one way top for bottom, or reversed both ways to form other constellations the mappings of which are optimal for MAP or log-MAP detection. Any of these constellations can be rotated 90 degrees to form still further constellations the mappings of which are optimal for MAP or log-MAP detection.

Takahara, Alajaji, Beaulieu and Kuai designed their FIG. 5 64QAM symbol constellation based on the presumption that an all-ZERO 6-bit sequence would be the most likely to occur. However, randomization of data to be FEC-coded makes 6-bit sequences containing ONEs more likely to occur than all-ZERO ones. Better practice is to label the points of the 64QAM symbol constellation so the labels with fewer ZEROes are in positions of maximum modulation. Since the labels with few ZEROes are less likely to occur, modulation peaks will occur less frequently, tending to reduce the average power of each modulated carrier. The Euclidean distances between adjacent points of the 64QAM symbol constellations can be kept the same, even though the transmitter radiates less power on average.

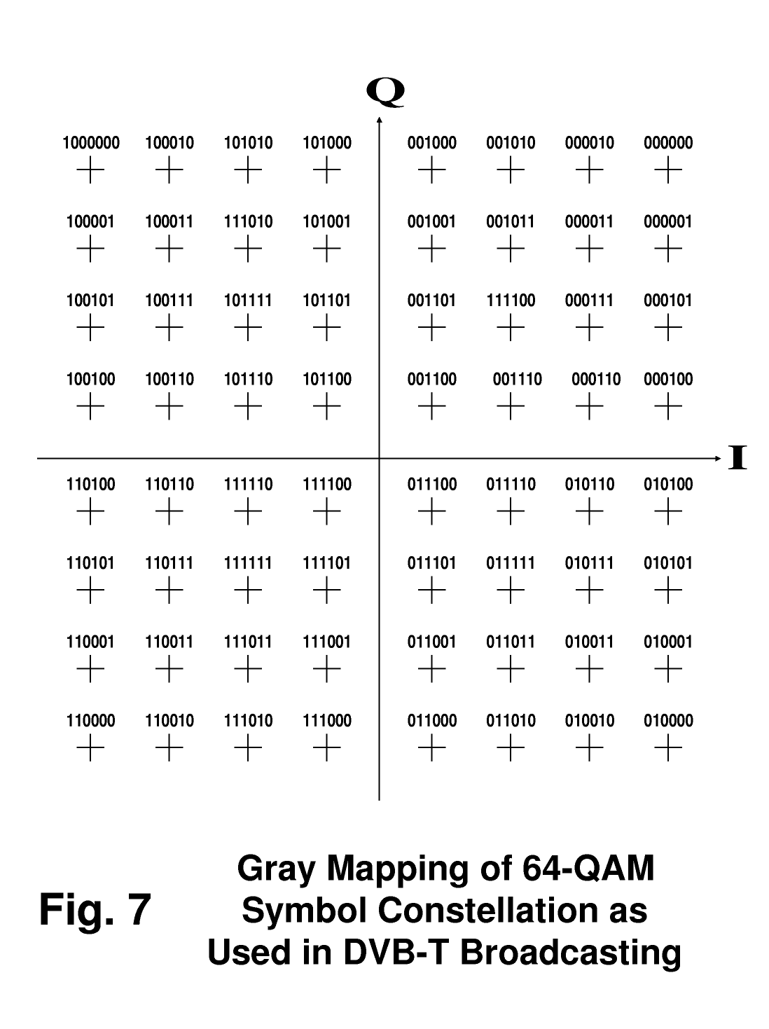

FIG. 7 is a diagram of the 64QAM modulation constellation used in DVB-T broadcasting. Its labels with few ZEROes are in positions of maximum modulation.

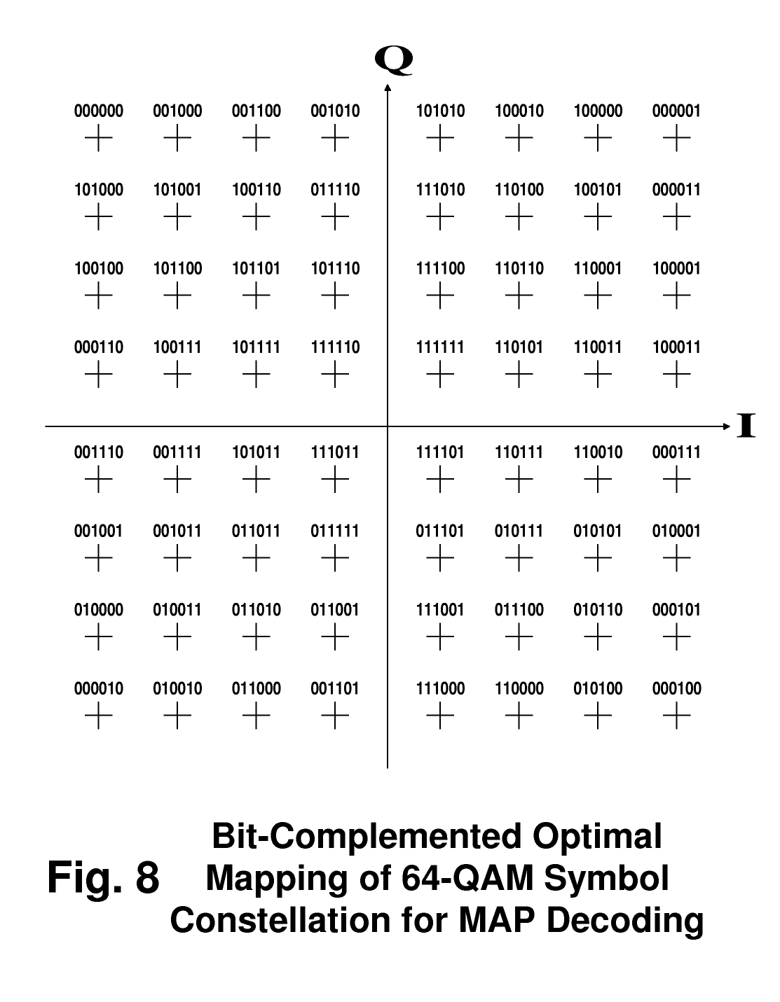

FIG. 8 is a diagram of a novel 64QAM modulation constellation using mapping that is bit-complementary to the FIG. 5 optimized mapping of Takahara, Alajaji, Beaulieu and Kuai. The FIG. 8 symbol constellation was designed presuming that the labels with fewer ZEROes are presumed to be less likely to occur, rather than more likely to occur, than the labels with more ZEROes. Optimization of the MAP or log-MAP decoding procedure is presumably unaffected by the bit-complementing of the labels used for mapping to the 64QAM modulation constellations. The Euclidean distances between adjacent points of the 64QAM symbol constellations remain the same, but the transmitter radiates less power on average, which is desirable for reducing interference with other signals nearby in the frequency spectrum.

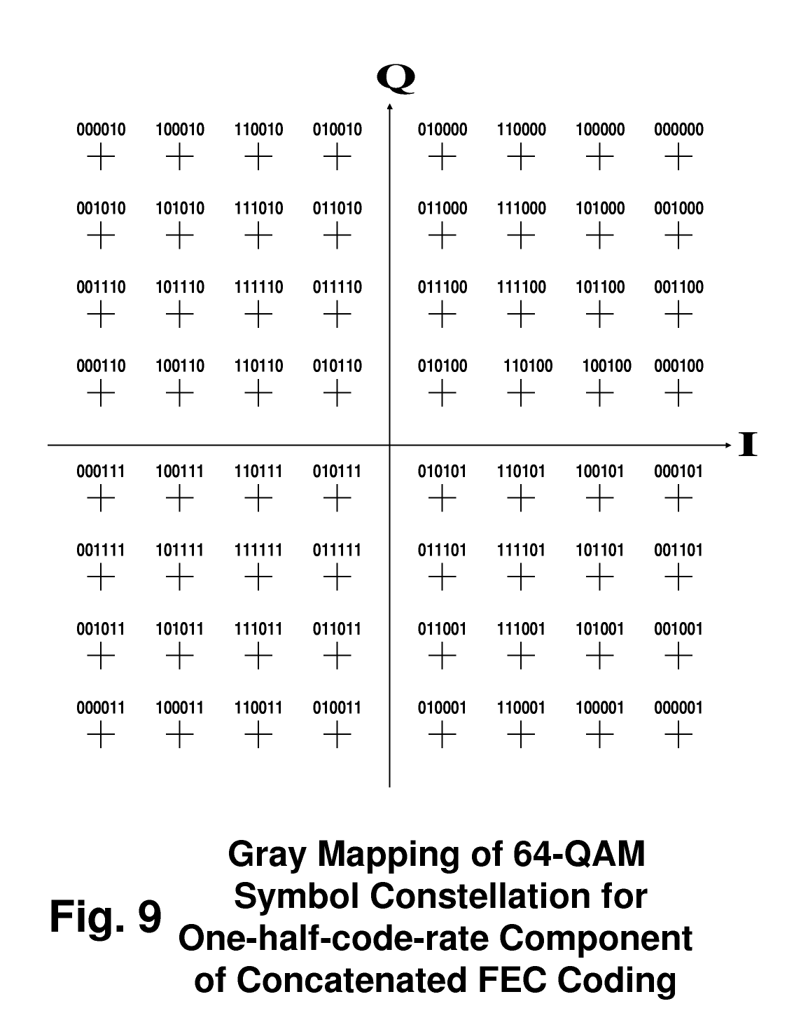

FIG. 9 is a diagram of a 64QAM symbol constellation using minimum-mean-energy Gray mapping, as disclosed in U.S. provisional patent application Ser. No. 61/626,437 titled “COFDM broadcast systems employing turbo coding” filed 27 Sep. 2011 by A. L. R. Limberg. The Gray labeling of the 64QAM symbol constellation shown in FIG. 9 was designed to facilitate decoding of one-half-rate FEC coding. A receiver for COFDM plural-carrier signals is apt to recover values of complex amplitude modulation that depart in some degree from lattice points in the two-dimensional range of complex amplitude modulation, owing to imperfect reception. Ongoing departures are caused by Johnson noise arising in the atmosphere and in the receiver elements. Occasional departures are caused by burst noise, often generated by electrical equipment near the receiver. Some departure may arise from imperfect channel equalization filtering. Generally, the further bits of the soft-decision bits associated with the complex amplitude modulation actually received are determined by how far the position defined by that complex amplitude modulation departs from the boundaries of change in the hard-bit values associated with closest lattice point in the two-dimensional range of complex amplitude modulation.

The hard-decision bits in each successive set of decision bits with each lattice point in the two-dimensional range of complex amplitude modulation can be independent of the more significant bits of the in-phase coordinates and quadrature-phase coordinates of the two-dimensional QAM symbol constellation. This allows Gray mapping of QAM constellations, in which mapping procedure the set of decision bits associated with any lattice point differs by only a single bit from the set of decision bits associated with any one of the closest by lattice points in the symbol constellation. Perfect Gray mapping is possible for a square QAM constellation having an even power of two lattice points therein. I.e., perfect Gray mapping is possible for 4PSK, 16QAM, 64QAM, 256QAM or 1024QAM constellations that are square. Consider the number of lattice points between change in each hard-decision bit within successive sets of decision bits sharing the same in-phase coordinates or the same quadrature-phase coordinates in a square two-dimensional QAM symbol constellation. Such numbers vary among the hard-decision bits within each set of decision bits. Limberg observed that the variation in this number for each hard-decision bit exhibits a well-defined pattern, if perfect or almost perfect Gray mapping is used.

Limberg's U.S. provisional patent application Ser. No. 61/626,437 proposes matching this pattern to the particular form of turbo coding of data bits that is used before mapping the FEC coding results to QAM symbol constellations. Iterative decoding in a receiver of QAM symbol constellations transmitted via COFDM plural carrier waves adjusts data bits from the QAM constellations best to conform to parity bits from the QAM constellations. These adjustments are made with the goal of maximizing overall the confidence levels of the bits in estimates that the receiver generates as to the FEC coding actually transmitted. These procedures are facilitated by proper placement of the parity bits of the FEC coding within the sets of information bits associated with respective lattice points in each QAM symbol constellation. The parity bits, which are not adjusted during iterative decoding procedures using MAP or log-MAP detectors, are placed within each set of information bits in the bit places more likely to have high confidence levels associated with them. The data bits, which are adjusted during iterative decoding procedures using MAP or log-MAP detectors, are placed within each set of information bits in the bit places less likely to have high confidence levels associated with them.

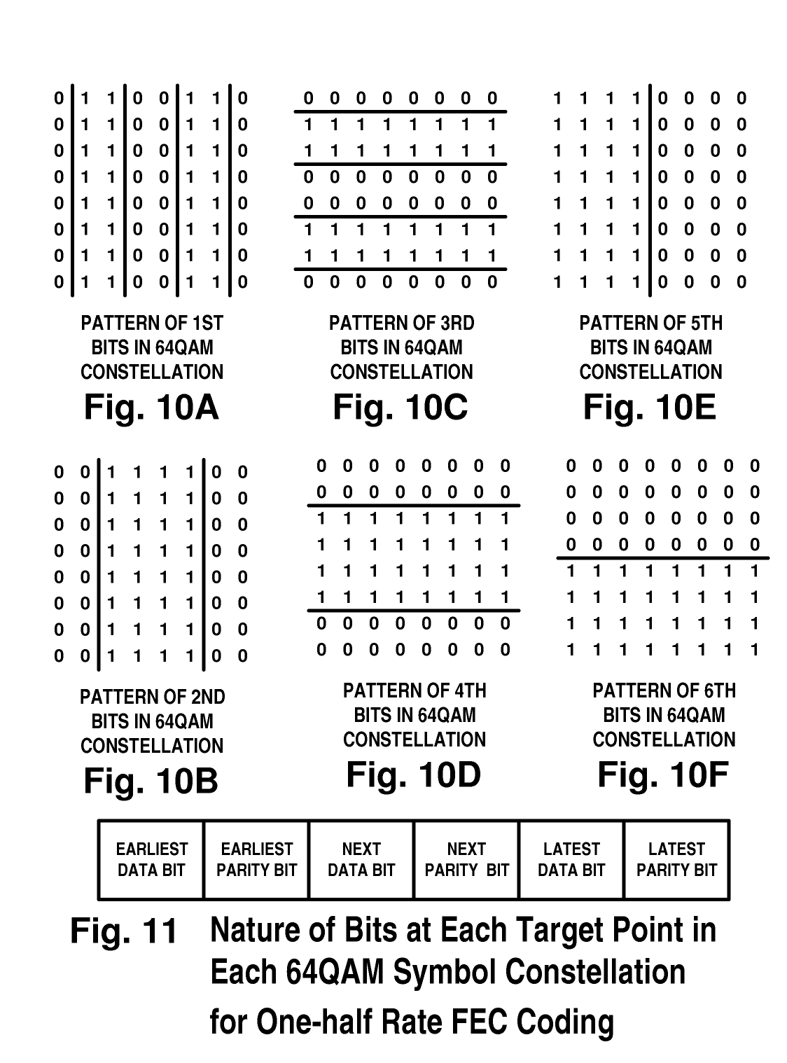

FIG. 10A shows the pattern exhibited by bits in the first bit-places of the 6-bit sequences respectively associated with the square array of sixty-four lattice points in the 64QAM symbol constellation map of FIG. 9. The vertical bands of ONEs are each two lattice points wide, and the vertical bands of ZEROes are each two lattice points wide except at left and right edges of the 64QAM symbol constellation map. FIG. 10B shows the pattern exhibited by bits in the second bit-places of the 6-bit sequences respectively associated with the square array of sixty-four lattice points in the 64QAM symbol constellation map of FIG. 9. The vertical band of ONEs is four lattice points wide, and the flanking vertical bands of ZEROes are each two lattice points wide. Decision bits in the first bit-places are more likely to be from lattice points adjoining boundaries between ONEs and ZEROes, where confidence levels are reduced, than decision bits in the second bit-places are. So, as shown in FIG. 11, the first and second bit-places are used to convey data bits and parity bits, respectively, of the one-half-rate FEC coding of individual bits.

FIG. 10C shows the pattern exhibited by bits in the third bit-places of the 6-bit sequences respectively associated with the square array of sixty-four lattice points in the 64QAM symbol constellation map of FIG. 9. The horizontal bands of ONEs are each two lattice points deep, and the horizontal bands of ZEROes are each two lattice points deep except at top and bottom edges of the 64QAM symbol constellation map. FIG. 10D shows the pattern exhibited by bits in the fourth bit-places of the 6-bit sequences respectively associated with the square array of sixty-four lattice points in the 64QAM symbol constellation map of FIG. 9. The horizontal band of ONEs is four lattice points deep, and the flanking horizontal bands of ZEROes are each two lattice points deep. Decision bits in the third bit-places are more likely to be from lattice points adjoining boundaries between ONEs and ZEROes, where confidence levels are reduced, than decision bits in the fourth bit-places are. So, as shown in FIG. 11, the third and fourth bit-places are used to convey data bits and parity bits, respectively, of the one-half-rate FEC coding of individual bits.

FIG. 10E shows the pattern exhibited by bits in the fifth bit-places of the 6-bit sequences respectively associated with the square array of sixty-four lattice points in the 64QAM symbol constellation map of FIG. 9. In this pattern a vertical band of ONEs is four lattice points wide, and a vertical band of ZEROes is also four lattice points wide. FIG. 10F shows the pattern exhibited by bits in the sixth bit-places of the 6-bit sequences respectively associated with the square array of sixty-four lattice points in the 64QAM symbol constellation map of FIG. 9. In this pattern a horizontal band of ONEs is four lattice points deep, and a horizontal band of ZEROes is also four lattice points deep. FIG. 11 shows that the fifth and sixth bit-places are used to convey data bits and parity bits, respectively, of the one-half-rate FEC coding of individual bits. The selection is arbitrary, and a 64QAM symbol constellation map in which the bits associated with the fifth and sixth bit places are interchanged is an alternative as good as that shown in FIG. 9.

FIG. 12 shows the initial portion of a receiver designed for iterative-diversity stationary reception of COFDM signals as transmitted at VHF or UHF by a DTV transmitter such as the one depicted in FIGS. 1 through 4. A reception antenna 57 captures the radio-frequency COFDM signal for application as input signal to a front-end tuner 58 of the receiver. The front-end tuner 58 can be of a double-conversion type composed of initial single-conversion super-heterodyne receiver circuitry for converting radio-frequency (RF) COFDM signal to intermediate-frequency (IF) COFDM signal followed by circuitry for performing a final conversion of the IF COFDM signal to baseband COFDM signal. The initial single-conversion receiver circuitry typically comprises a tunable RF amplifier for RF COFDM signal incoming from the reception antenna, a tunable first local oscillator, a first mixer for heterodyning amplified RF COFDM signal with local oscillations from the first local oscillator to obtain the IF COFDM signal, and an intermediate-frequency (IF) amplifier for the IF COFDM signal. Typically, the front-end tuner 58 further includes a synchronous demodulator for performing the final conversion from IF COFDM signal to baseband COFDM signal and an analog-to-digital converter for digitizing the baseband COFDM signal. Synchronous demodulation circuitry typically comprises a final local oscillator with automatic frequency and phase control (AFPC) of its oscillations, a second mixer for synchrodyning amplified IF COFDM signal with local oscillations from the final local oscillator to obtain the baseband COFDM signal, and a low-pass filter for suppressing image signal accompanying the baseband COFDM signal. FIG. 12 shows an AFPC generator 59 for generating the automatic frequency and phase control (AFPC) signal for controlling the final local oscillator within the front-end tuner 58. In some designs of the front-end tuner 58, synchronous demodulation is performed in the analog regime before subsequent analog-to-digital conversion of the resulting complex baseband COFDM signal. In other designs of the front-end tuner 58 analog-to-digital conversion is performed before synchronous demodulation is performed in the digital regime.

Simply stated, the front-end tuner 58 converts radio-frequency COFDM signal received at its input port to digitized samples of baseband COFDM signal supplied from its output port. Typically, the digitized samples of the real component of the baseband COFDM signal are alternated with digitized samples of the imaginary component of the baseband COFDM signal for arranging the complex baseband COFDM signal in a single stream of digital samples.

The output port of the front-end tuner 58 is connected for supplying digitized samples of baseband COFDM signal to the input port of a cyclic prefix detector 60. The cyclic prefix detector 60 differentially combines the digitized samples of baseband COFDM signal with those samples as delayed by the duration of an effective COFDM symbol. Nulls in the difference signal so generated should occur, marking the guard intervals of the baseband COFDM signal. The nulls are processed to reduce any corruption caused by noise and to generate sharply defined indications of the phasing of COFDM symbols. The output port of the cyclic prefix detector 60 is connected to supply these indications to a first of two input ports of timing synchronization apparatus 61.

A first of two output ports of the timing synchronization apparatus 61 is connected for supplying gating control signal to the control input port of a guard-interval-removal unit 62, the signal input port of which is connected for receiving digitized samples of baseband COFDM signal from the output port of the front-end tuner 58. The output port of the guard-interval-removal unit 62 is connected for supplying the input port of an OFDM demodulator 63 with windowed portions of the baseband COFDM signal that contain effective COFDM samples. A second of the output ports of the timing synchronization apparatus 61 is connected for supplying the OFDM demodulator 63 with synchronizing information concerning the effective COFDM samples.

The output port of the front-end tuner 58 is connected for supplying digitized samples of baseband COFDM signal to the signal input port of the guard-interval-removal unit 62. The indications concerning the phasing of COFDM symbols that the cyclic prefix detector 60 supplies to the timing synchronization apparatus 61 is sufficiently accurate for initial windowing of the baseband COFDM signal that the guard-interval-removal unit 62 supplies to the OFDM demodulator 63.

A first output port of the OFDM demodulator 63 is connected for supplying demodulated pilot carrier information to the input port of a pilot and TPS carriers processor 64. The information concerning unmodulated pilot carriers is processed in the processor 64 to support more accurate windowing of the baseband COFDM signal that the guard-interval-removal unit 62 supplies to the OFDM demodulator 63. Such processing can be done similarly to the way described by Nicole Alcouffe in U.S. Pat. No. 2,003,0138060-A1 published 24 Jul. 2003 with the title “COFDM demodulator with an optimal FFT analysis window positioning”, for example. A first of four output ports of the pilot and TPS carriers processor 64 is connected for supplying more accurate window positioning information to the second input port of the timing synchronization apparatus 61.

The pilot and TPS carriers processor 64 demodulates the TPS information conveyed by modulated pilot signals. The second output port of the pilot and TPS carriers processor 64 is connected for supplying the TPS information to an SMT-MH processing unit 117 shown in FIG. 14.

The third output port of the pilot and TPS carriers processor 64 is connected to forward unmodulated pilot carriers to the input port of the AFPC generator 59. The real components of the unmodulated pilot carriers are multiplied by their respective imaginary components in the AFPC generator 59. The resulting products are summed and low-pass filtered to develop the AFPC signal that the AFPC generator 59 supplies to the front-end tuner 58 for controlling the final local oscillator therein. Other ways of developing AFPC signals for the final local oscillator in the front-end tuner 58 are also known, which can replace or supplement the method described above. One such other way is described in U.S. Pat. No. 5,687,165 titled “Transmission system and receiver for orthogonal frequency-division multiplexing signals, having a frequency-synchronization circuit”, which was granted to Flavio Daffara and Ottavio Adami on 11 Nov. 1997. That patent describes complex digital samples from the tail of each OFDM symbol being multiplied by the conjugates of corresponding digital samples from the cyclic prefix of the OFDM symbol. The resulting products are summed and low-pass filtered to develop the AFPC signal that the AFPC generator 59 supplies to the front-end tuner 58 for controlling the final local oscillator therein.

The fourth output port of the pilot and TPS carriers processor 64 is connected for supplying information concerning the respective energies of unmodulated pilot carriers. This information is used for maximal-ratio code combining to be performed in the FIG. 13 portion of the receiver.

A second output port of the OFDM demodulator 63 is connected to supply demodulated complex digital samples of 256QAM to a first input port of a frequency-domain channel equalizer 65. FIG. 12 shows the frequency-domain channel equalizer 65 having a second input port connected for receiving pilot carriers supplied from the first input port of the OFDM demodulator 63. A simple form of frequency-domain channel equalizer 65 measures the amplitude of the unmodulated pilot carriers to determine basic weighting coefficients for various portions of the frequency spectrum. The carriers conveying convolutional coding in QAM format are then multiplied by respective weighting coefficients determined by interpolation among the basic weighting coefficients determined by measuring the amplitudes of the unmodulated pilot carriers. Various alternative types of frequency-domain channel equalizer are also known. The output port of the channel equalizer 65 is connected for supplying equalized carriers conveying convolutional coding in QAM format to the input port of a de-mapper 66 for 256QAM symbols. The de-mapper 66 is operable for reproducing at an output port thereof the one-half-rate convolutional coding supplied as response from the time-division multiplexer 15 in the FIG. 2 portion of the DTV transmitter.

As thusfar described, except for the de-mapper 66 possibly being adapted for de-mapping 256QAM differently, the FIG. 12 initial portion of a COFDM receiver is similar to the initial portions of COFDM receivers used for DVB in Europe. The output port of the de-mapper 66 is connected for supplying one-half-rate CC to the input port of a selector 67 for reproducing at its output port just those transmissions that are not repeated and the final ones of those transmissions that are repeated for iterative-diversity reception. The output port of the de-mapper 66 is further connected for supplying one-half-rate CC to the input port of a selector 68 for reproducing at its output port just the initial ones of those transmissions subsequently repeated to support iterative-diversity reception. The output port of the selector 68 is connected for writing to the input port of a delay memory 69 which memory is employed to delay the one-half-rate CC of the initial transmissions subsequently once-repeated for iterative-diversity reception. The delay can be prescribed fixed delay or, alternatively, can be programmable responsive to delay specified by bits of TPS coding. In either case, the delay is such that the transmissions subsequently repeated for iterative-diversity reception are supplied from the output port of the delay memory 69 concurrently with the corresponding final transmissions as repeated for iterative-diversity reception that are supplied from the output port of the selector 67. The read output port of the delay memory 69 connects to the input ports of selectors 70 and 71 shown in FIG. 13. The output port of the selector 67 connects to the input ports of selectors 72 and 73 shown in FIG. 13.

FIG. 13 shows the selector 70 connected for selectively reproducing at its output port just the soft parity bits from the one-half-rate CC read to its input port from the delay memory 69. The output port of the soft-parity-bits selector 70 is connected to supply these selectively reproduced soft parity bits as write input signal to a memory 74 for temporarily storing the soft parity bits of the one-half-rate CC for each successive even-numbered time-slice.

FIG. 13 shows the selector 71 connected for selectively reproducing at its output port just the soft data bits from the one-half-rate CC read to its input port from the delay memory 69. FIG. 13 shows the selector 72 connected for selectively reproducing at its output port just the soft data bits from the one-half-rate CC selected to its input port by the selector 67. A maximal-ratio code combiner 75 is connected for receiving at a first of its two input ports the soft data bits selectively reproduced at the output port of the soft-data-bits selector 71. The second input port of the maximal-ratio code combiner 75 is connected for receiving the soft data bits selectively reproduced at the output port of the soft-data-bits selector 72. The output port of the maximal-ratio code combiner 75 is connected for supplying best soft estimates of the data bits of the one-half-rate CC as write input signal to a memory 76, which temporarily stores those soft data bits.

The memory 76 also temporarily stores soft extrinsic data bits determined during the subsequent turbo decoding procedures. Soft data bits are read from the memory 76 without being combined with corresponding soft extrinsic data bits during the initial half cycle of an iterative turbo decoding procedure. Thereafter, when soft data bits are read from the memory 76 during subsequent half cycles of the iterative turbo decoding procedure, the soft data bits have respectively corresponding soft extrinsic data bits additively combined therewith. The soft extrinsic data bits temporarily stored in the memory 76 are updated responsive to the results of decoding CC each half cycle of the iterative turbo decoding procedure.

FIG. 13 shows the selector 73 connected for selectively reproducing at its output port just the soft parity bits from the one-half-rate CC selected to its input port by the selector 67. The output port of the soft-parity-bits selector 73 is connected to supply these selectively reproduced soft parity bits as write input signal to a memory 77 for temporarily storing the soft parity bits of the one-half-rate CC for each successive odd-numbered time-slice.

The memories 74, 76 and 77 together temporarily store all the components of the PCCC for a given service to be received by the stationary DTV receiver depicted in FIGS. 12, 13 and 14. The PCCC is turbo decoded by soft-input/soft-output decoders 78 and 79 in FIG. 13, which preferably employ the sliding-window log-MAP algorithm. The term “log-MAP” is short for “logarithmic maximum a posteriori”. During the initial half of each cycle of turbo decoding, the SISO decoder 78 decodes one-half-rate CC that includes soft parity bits from an even-numbered time-slice of the service being received. During the final half of each cycle of turbo decoding, the SISO decoder 79 decodes one-half-rate CC that includes soft parity bits from an odd-numbered time-slice of the service being received. The soft data bits that the SISO decoders 78 and 79 supply from their respective output ports as respective decoding results are compared to combined soft data bits and soft extrinsic data bits read from the memory 76. This is done to generate updated soft extrinsic data bits to be written back to the memory 76. At the conclusion of turbo decoding, combined soft data bits and soft extrinsic data bits are read from the memory 76 to supply an ultimate turbo decoding result to the input port of a quantizer 86 shown in FIG. 14. The read addressing for the memory 76 during reading an ultimate turbo decoding result therefrom is such as to counteract the convolutional byte interleaving introduced at the DTV transmitter by the FIG. 1 convolutional byte interleaver 4.

FIG. 13 shows a soft-symbols selector 80 that selects soft data bits and soft parity bits to be supplied from first and second output ports thereof, respectively, to first and second input ports of the SISO decoder 78 during the initial half of each cycle of turbo decoding. The soft-symbols selector 80 relays soft data bits additively combined with soft extrinsic data bits, if any, as read to a first input port thereof from the memory 76, thus to generate the soft data bits supplied to the first input port of the SISO decoder 78. The soft-symbols selector 80 reproduces the soft parity bits read to a second input port thereof from the memory 77, thus generating the soft parity bits supplied to the second input port of the SISO decoder 78. In actual practice, the soft-symbols selector 80 will usually be incorporated into the structures of the memories 76 and 77.

The soft data bits supplied from the output port of the SISO decoder 78 as decoding results during the initial half of each cycle of turbo decoding are supplied to a first of two input ports of an extrinsic-data-feedback processor 81. The processor 81 differentially combines soft data bits read from the memory 76 with corresponding soft data bits of the SISO decoder 78 decoding results to generate extrinsic data feedback written into the memory 76 to update the soft extrinsic data bits temporarily stored therein.

FIG. 13 shows a soft-symbols selector 82 that selects soft data bits and soft parity bits to be supplied as input soft symbols to a soft-symbols de-interleaver 83. The soft-symbols de-interleaver 83 responds to supply de-interleaved soft data bits and de-interleaved soft parity bits from first and second output ports thereof, respectively, to first and second input ports of the SISO decoder 79 during the final half of each cycle of turbo decoding. The soft symbols selector 82 relays soft data bits additively combined with soft extrinsic data bits, if any, as read to a first input port thereof from the memory 76, thus to generate the soft data bits supplied to the soft-symbols de-interleaver 83. The soft-symbols selector 82 reproduces the soft parity bits read to a second input port thereof from the memory 74, thus to generate the soft parity bits supplied to the soft symbols de-interleaver 83. The de-interleaving provided by soft-symbols de-interleaver 83 complements the symbol interleaving provided by the symbol interleaver 14 in the FIG. 2 portion of the DTV transmitter.

The soft data bits supplied from the output port of the SISO decoder 79 as decoding results during the final half of each cycle of turbo decoding are supplied to the input port of a soft-bits interleaver 84 in FIG. 13. FIG. 13 shows the output port of the soft-bits interleaver 84 connected to a first of two input ports of an extrinsic data feedback processor 85. The interleaving provided by soft-bits interleaver 84 complements the bit de-interleaving provided by the bits de-interleaver 12 in the FIG. 2 portion of the DTV transmitter. The processor 85 differentially combines soft data bits read from the memory 76 with corresponding soft data bits of the soft-bits interleaver 84 response to generate extrinsic data feedback written into the memory 76 to update the soft extrinsic data bits temporarily stored therein.

In actual practice, the soft-symbols selector 82 will usually be incorporated into the structures of the memories 74 and 76. The soft-symbols de-interleaver 83 will usually not appear as a separate physical element either. Instead, its function is subsumed into the memories 74 and 76 by suitable addressing of them when reading soft data bits and soft parity bits directly to the first and second input ports of the SISO decoder 79. The soft-bits interleaver 84 need not appear as a separate physical element either, its function being subsumed into the memory 76 by suitable addressing during operation of the extrinsic feedback data processor 85. Since the operations of the SISO decoders 78 and 79 alternate in time, a single decoder structure can be used for implementing both the SISO decoders 78 and 79. The foregoing description of turbo decoding describes each cycle as beginning with decoding of an even-numbered time-slice and concluding with the decoding of an odd-numbered time-slice. The order of decoding is arbitrarily chosen, however. Alternatively, turbo decoding can be done with each cycle thereof beginning with decoding of an odd-numbered time-slice and concluding with the decoding of an even-numbered time-slice.

After a last half cycle of the iterative turbo decoding procedure, soft data bits as additively combined with respectively corresponding soft extrinsic data bits are read from the memory 76 to the input port of the quantizer 86 depicted in FIG. 14. Preferably, the read addressing of the memory 76 is such as to counteract the convolutional byte interleaving of time-slices introduced by the convolutional byte interleaver 4 in the portion of the DTV transmitter depicted in FIG. 1. This avoids the need for a separate byte de-interleaver to restore RS codewords to their original byte order. The output port of the quantizer 86 is connected for supplying hard decisions concerning de-interleaved soft data bits to the input port of an 8-bit-byte former 87. The 8-bit-byte former 87 responds, to supply successive 204-byte codewords from its output port to the input port of a Reed-Solomon decoder 88 for (204, 188) Reed-Solomon coding.

FIG. 14 shows the output port of the RS decoder 88 connected to the input port of a byte re-interleaver 89. The byte re-interleaver 89 performs convolutional byte interleaving similar to that performed by the byte interleaver 9 in FIG. 1. FIG. 14 further shows the output port of the byte re-interleaver 89 connected for supplying 188-byte packets to the input port of a data de-randomizer 90, which de-randomizes the final 187 bytes of each of those packets to recover a succession of MPEG-2 transport-stream packets. If the byte de-interleaver 7 in FIG. 1 is replaced by direct connection, so convolutional byte interleaving by the subsequent byte interleaver 9 is not coded interleaving, the byte re-interleaver 89 is replaced by a direct connection from the output port of the LRS decoder 88 to the input port of the data de-randomizer 90.

The data de-randomizer 90 is connected to supply these MPEG-2 packets to a detector 91 of a “well-known” SMT-MH address and to a delay unit 92. The delay unit 92 delays the MPEG-2 transport-stream (TS) packets supplied to a packet selector 93 for selecting SMT-MH packets from other TS packets. The delay unit 92 provides delay of a part of a TS-packet header interval, which delay is long enough for the detector 91 to ascertain whether or not the “well-known” SMT-MH address is detected.

If the detector 91 does not detect the “well-known” SMT-MH address in the TS packet, the detector 91 output response conditions the packet selector 93 to reproduce the TS packet for application to a packet sorter 94 as input signal thereto. The packet sorter 94 sorts out each TS packet in which the transport-error-indication (TEI) bit is ZERO-valued for writing to a cache memory 95 for TS packets. A ZERO-valued TEI bit in the header of each TS packet header will have been toggled to a ONE if it was not successfully decoded by the RS decoder 84. The cache memory 95 temporarily stores those TS packets in which the TEI bit is ZERO-valued, for possible future reading to the later stages 96 of the receiver.

If the detector 91 does detect the “well-known” SMT-MH address in the TS packet, establishing it as an SMT-MH packet, the detector 91 output response conditions the packet selector 93 to reproduce the SMT-MH packet for application to an SMT-MH processing unit 97, which includes circuitry for generating control signals for the later stages 96 of the M/H receiver. FIG. 14 shows the SMT-MH processing unit 97 connected for receiving Fast Information Channel (FIC) information from the TPS carriers processor 64 in FIG. 12. The SMT-MH processing unit 97 integrates this FIC information with information from SMT-MH packets during the generation of Service Map Data. The Service Map Data generated by the SMT-MH processing unit 97 is written into memory 98 for temporary storage therein and subsequent application to the later stages 96 of the M/H receiver. The SMT-MH processing unit 97 relays those SMT-MH packets that have ZERO-valued TEI bits to a user interface 99, which typically includes an Electronic Service Guide (ESG) and apparatus for selectively displaying the ESG on the viewing screen of the M/H receiver. A patent application filed for A. L. R. Limberg, published 11 Mar. 2010 as US-2010-0061465-A1, and titled “Sub-channel Acquisition in a Digital Television Receiver Designed to Receive Mobile/Handheld Signals” provides more detailed descriptions of the operations of the portion of an M/H receiver as shown in FIG. 14. The description with reference to the drawing FIGS. 12, 13 and 14 of that application describes operations relying on the SMT-MH tables available in A/153.

In the prior art DTV receivers of COFDM signals the RS decoders for (204, 188) Reed-Solomon coding used decoding algorithms that located byte errors as well as subsequently correcting them. These decoding algorithms are capable of correcting no more than eight byte errors. If the RS decoder 88 for (204, 188) Reed-Solomon coding is supplied the locations of byte errors by external means, it can employ a decoding algorithm that is capable of correcting up to sixteen byte errors. The soft data bits read to the quantizer 86 from the memory 76 contain confidence-level information that can be analyzed to locate byte errors for the RS decoder 88. A bank 100 of exclusive-OR gates exclusively-ORs the hard data bit of each soft data bit read from the memory 76 with the remaining bits of that soft bit expressive of the level of confidence that the hard data bit is correct. The result of this operation is the generation of a plurality of bits expressing in absolute terms the level of lack of confidence that the hard data bit is correct. A selector 101 selects the largest level of lack of confidence in the bits of each successive 8-bit byte, to express the lack of confidence in the correctness of the byte considered as a whole. An adaptive threshold detector 102 compares the levels of lack of confidence for each byte in each successive (204, 188) Reed-Solomon codeword to a threshold value to generate a byte error indication for each byte having a level of lack of confidence that exceeds the threshold value. The adaptive threshold detector 102 adjusts the threshold value for each (204, 188) Reed-Solomon codeword individually, when necessary, so the number of byte errors in the codeword is no more than sixteen. The adaptive threshold detector 102 then supplies the RS decoder 88 with indications of the locations of the byte errors in the (204, 188) Reed-Solomon codeword that is to be corrected next.

FIGS. 15, 16, 17 and 18 together provide a generic schematic diagram of a mobile DTV receiver adapted for iterative-diversity reception of COFDM signals as transmitted by the portions of the DTV transmitter depicted in FIGS. 3 and 4. COFDM transmissions to mobile DTV receivers are presumed to employ 64QAM symbol constellations, rather than the 256QAM symbol constellations used in transmissions to stationary DTV receivers. Rather than 8K carrier waves in the COFDM used in transmissions to stationary DTV receivers, the COFDM used in transmissions to mobile DTV receivers uses only 4K carrier waves. The portion of the mobile DTV receiver shown in FIG. 15 differs from the portion of the stationary DTV receiver shown in FIG. 12 insofar as to take these differences into account. Otherwise, however, elements 159, 160, 161, 162, 163, 164, 165 and 166 shown in FIG. 15 correspond in general function to elements 59, 60, 61, 62, 63, 64, 65 and 66, respectively, shown in FIG. 12.

In FIG. 15 the output port of the front-end tuner 58 is connected for supplying digitized samples of baseband COFDM signal to the input port of a cyclic prefix detector 160. The output port of the cyclic prefix detector 160 is connected to supply indications of the phasing of COFDM symbols to a first of two input ports of timing synchronization apparatus 161. A first of two output ports of the timing synchronization apparatus 161 is connected for supplying gating control signal to the control input port of a guard-interval-removal unit 162. The signal input port of the guard-interval-removal unit 162 is connected for receiving digitized samples of baseband COFDM signal from the output port of the front-end tuner 58. The output port of the guard-interval-removal unit 162 is connected for supplying the input port of an OFDM demodulator 163 with windowed portions of the baseband COFDM signal that contain effective COFDM samples. A second of the output ports of the timing synchronization apparatus 161 is connected for supplying the OFDM demodulator 163 with synchronizing information concerning the effective COFDM samples.

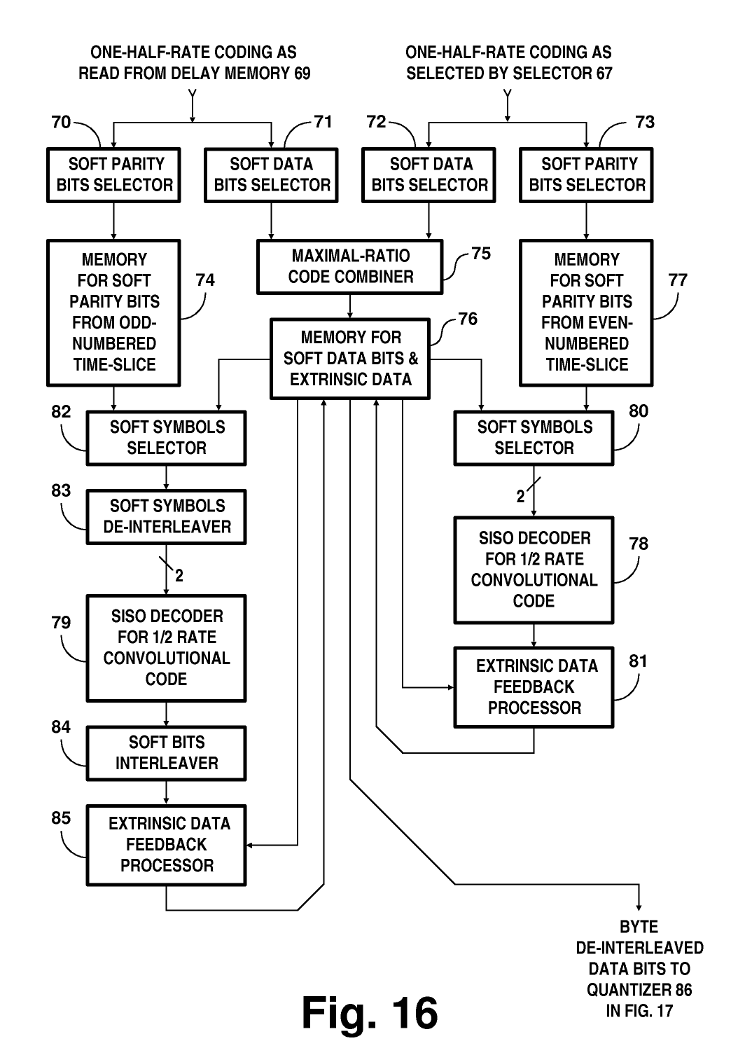

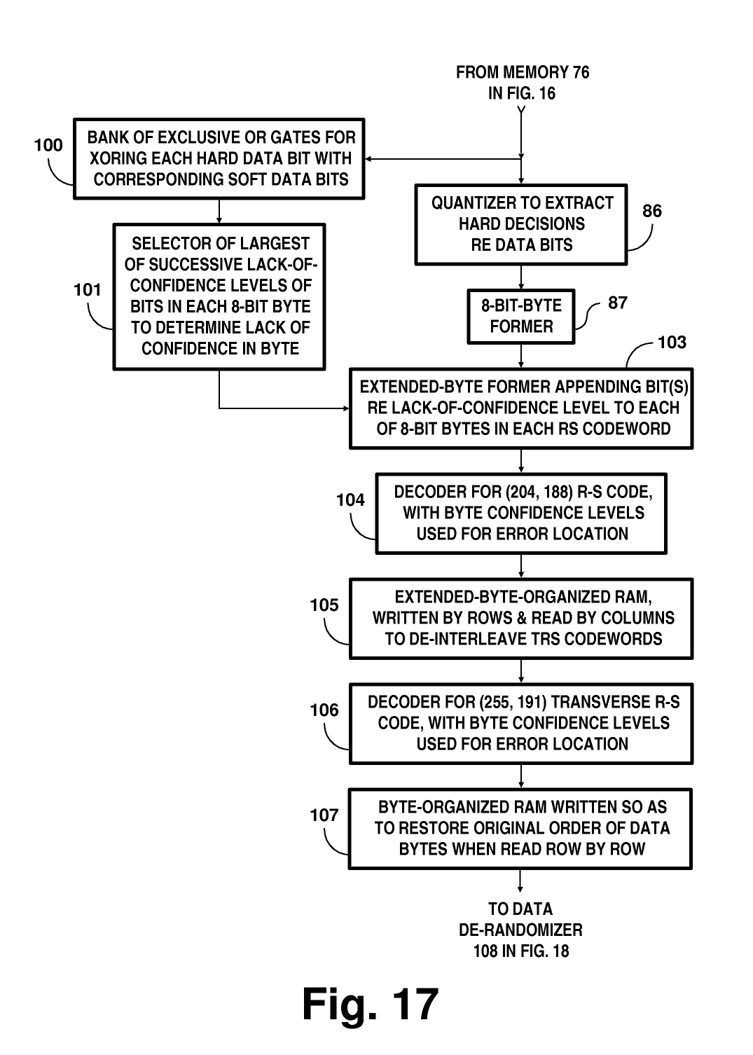

A first output port of the OFDM demodulator 163 is connected for supplying demodulated pilot carrier information to the input port of a pilot and TPS carriers processor 164. A first of four output ports of the pilot and TPS carriers processor 164 is connected for supplying more accurate window positioning information to the second input port of the timing synchronization apparatus 161. The second output port of the pilot and TPS carriers processor 164 is connected for supplying the TPS information to the SMT-MH processing unit 117 shown in FIG. 18. The third output port of the pilot and TPS carriers processor 164 is connected for forwarding unmodulated pilot carriers to the input port of the AFPC generator 159 that supplies AFPC signal to the front-end tuner 58 for controlling the final local oscillator therein. The fourth output port of the pilot and TPS carriers processor 164 is connected for supplying information concerning the respective energies of unmodulated pilot carriers to the maximal-ratio code combiner 75 in the FIG. 16 portion of the receiver.

A second output port of the OFDM demodulator 163 is connected to supply demodulated complex digital samples of 64QAM to a first input port of a frequency-domain channel equalizer 165. FIG. 15 shows the frequency-domain channel equalizer 165 having a second input port connected for receiving unmodulated pilot carriers supplied from the first input port of the OFDM demodulator 163. The amplitudes of these pilot carriers are measured for determining basic weighting coefficients for various portions of the frequency spectrum. The output port of the channel equalizer 165 is connected for supplying equalized carriers conveying CC in QAM format to the input port of a de-mapper 166 for 64QAM symbols. The de-mapper 166 is operable for reproducing at an output port thereof the one-half-rate CC supplied as response from the time-division multiplexer 15 in the FIG. 2 portion of the DTV transmitter.

The output port of the de-mapper 166 is connected for supplying one-half-rate CC to the input port of the selector 67 for reproducing at its output port just those transmissions that are not repeated and the final ones of those transmissions repeated for iterative-diversity reception. The output port of the de-mapper 166 is further connected for supplying one-half-rate CC to the input port of a selector 68 for reproducing at its output port just the initial ones of those transmissions subsequently repeated for iterative-diversity reception. The output port of the selector 68 is connected for writing to the input port of a delay memory 69 that delays the one-half-rate CC of the initial transmissions subsequently once-repeated for iterative-diversity reception. The delay is such that the transmissions subsequently repeated for iterative-diversity reception are supplied from the output port of the delay memory 69 concurrently with the corresponding final transmissions as repeated for iterative-diversity reception that are supplied from the output port of the selector 67. The output port of the selector 67 connects to the input ports of selectors 72 and 73 shown in FIG. 16. The output port of the delay memory 69 connects to the input ports of selectors 70 and 71 shown in FIG. 16.

The FIG. 16 portion of the M/H DTV receiver operates substantially the same as the FIG. 13 portion of the stationary DTV receiver. The elements of the FIG. 16 portion of the M/H DTV receiver are identified by the same reference numerals as the elements of the FIG. 13 portion of the stationary DTV receiver that perform similar functions. However, the memories 74, 76 and 77 in FIG. 16 do not require as much capacity for storage of bits in order to store a complete time-slice as the memories 74, 76 and 77 in FIG. 13 do.

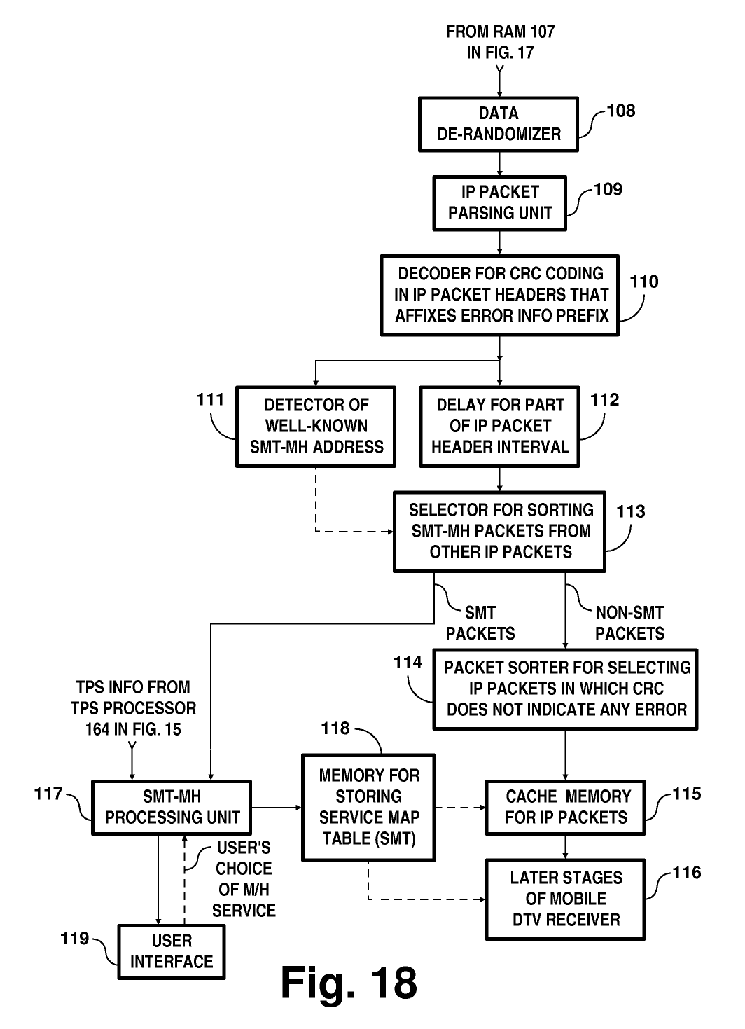

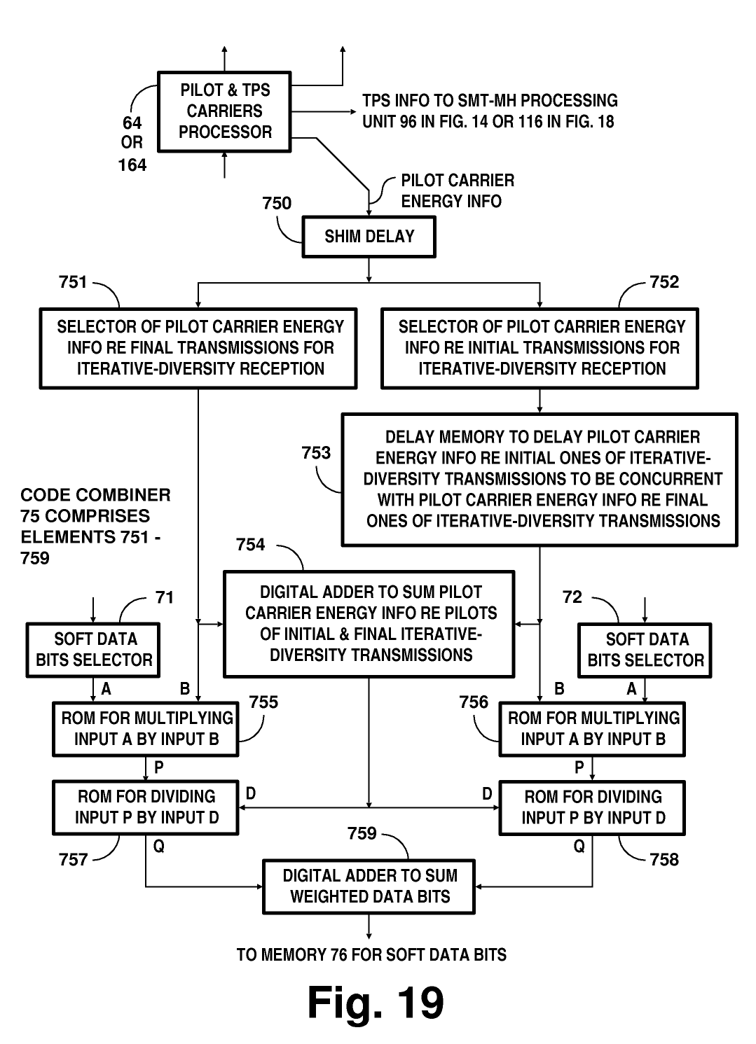

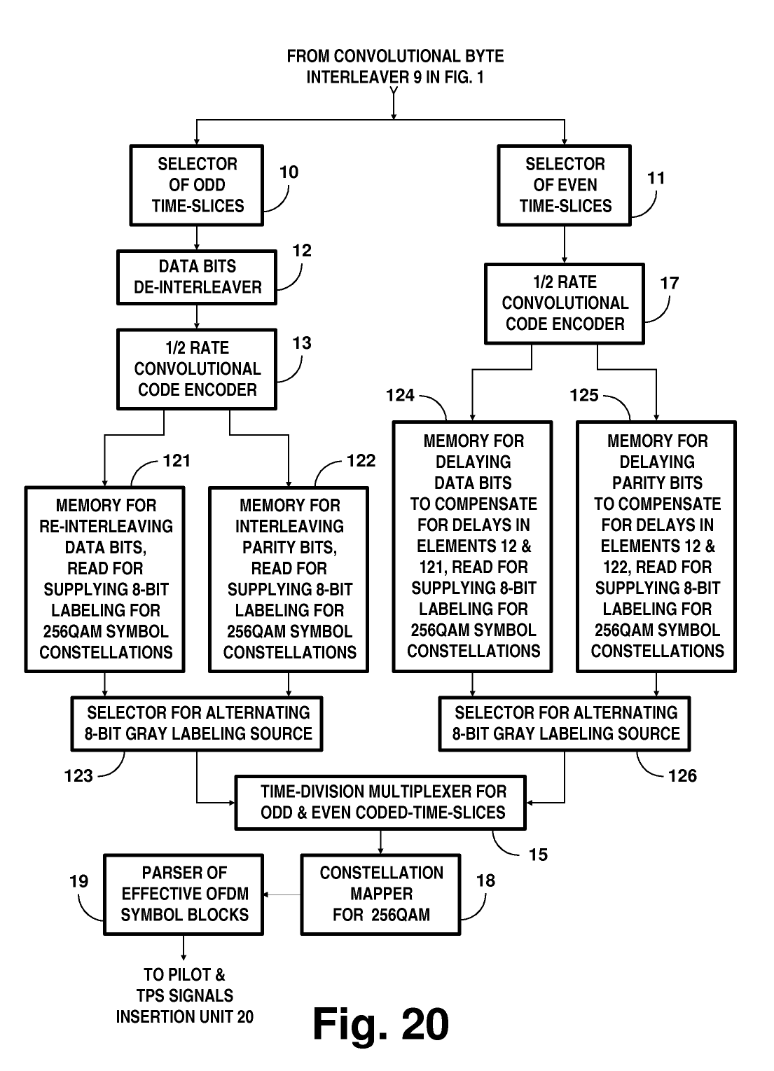

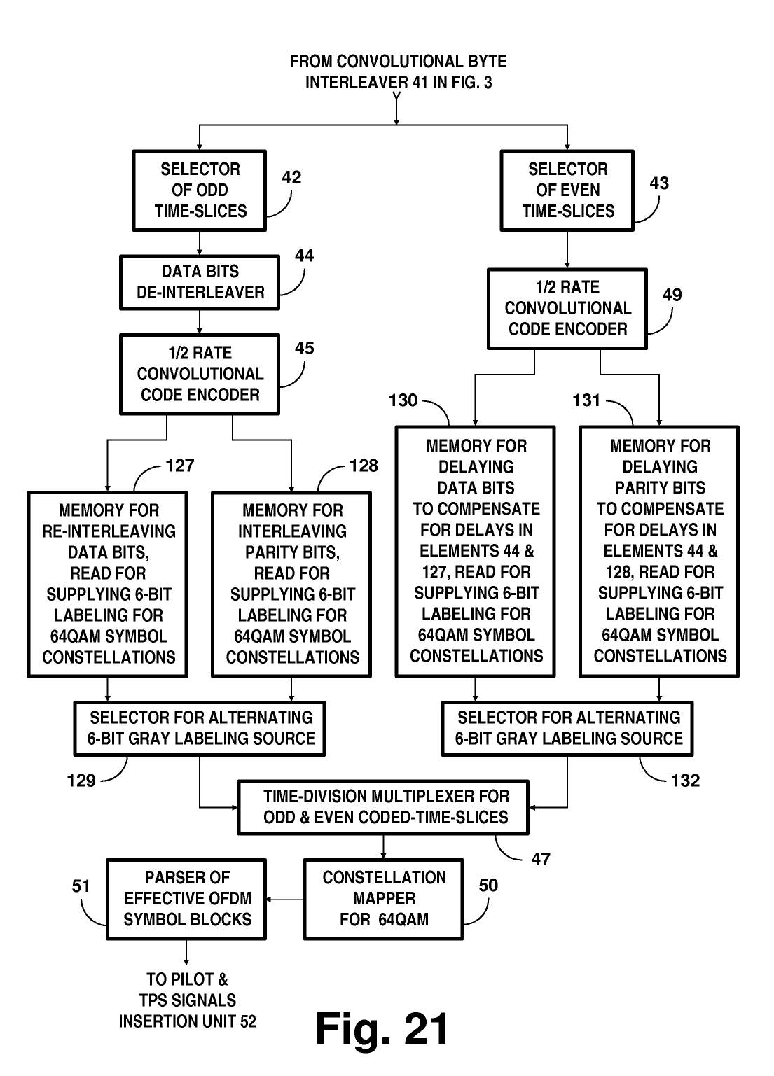

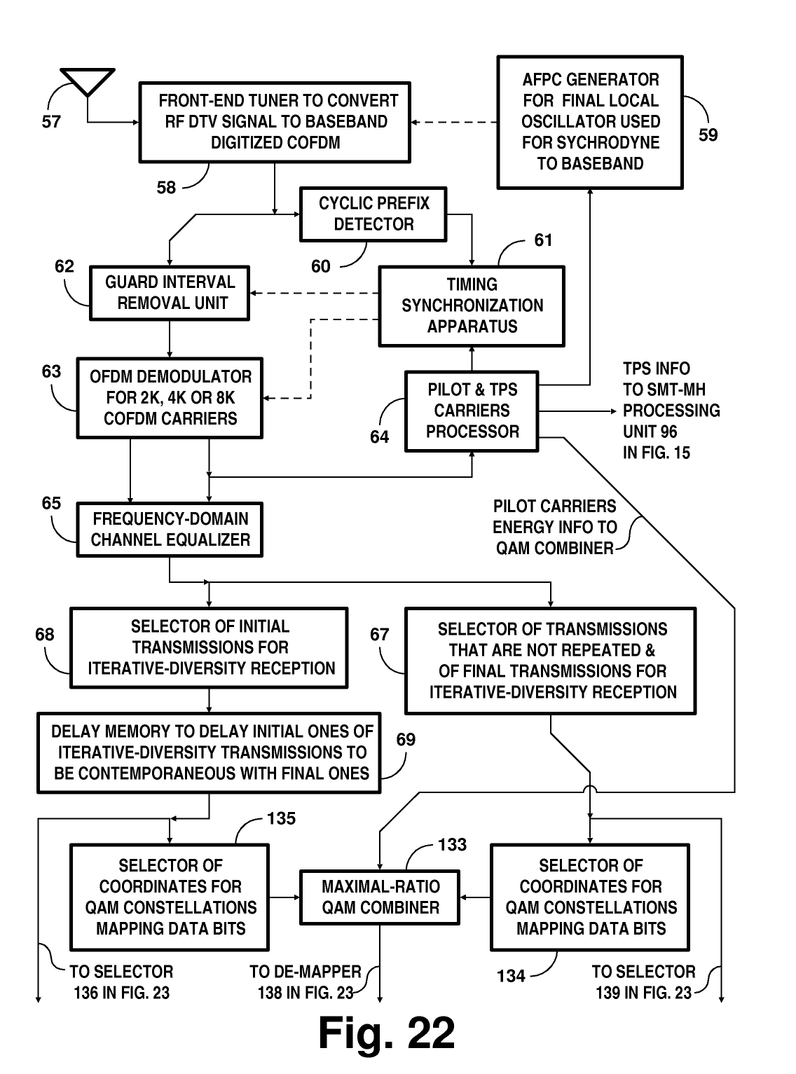

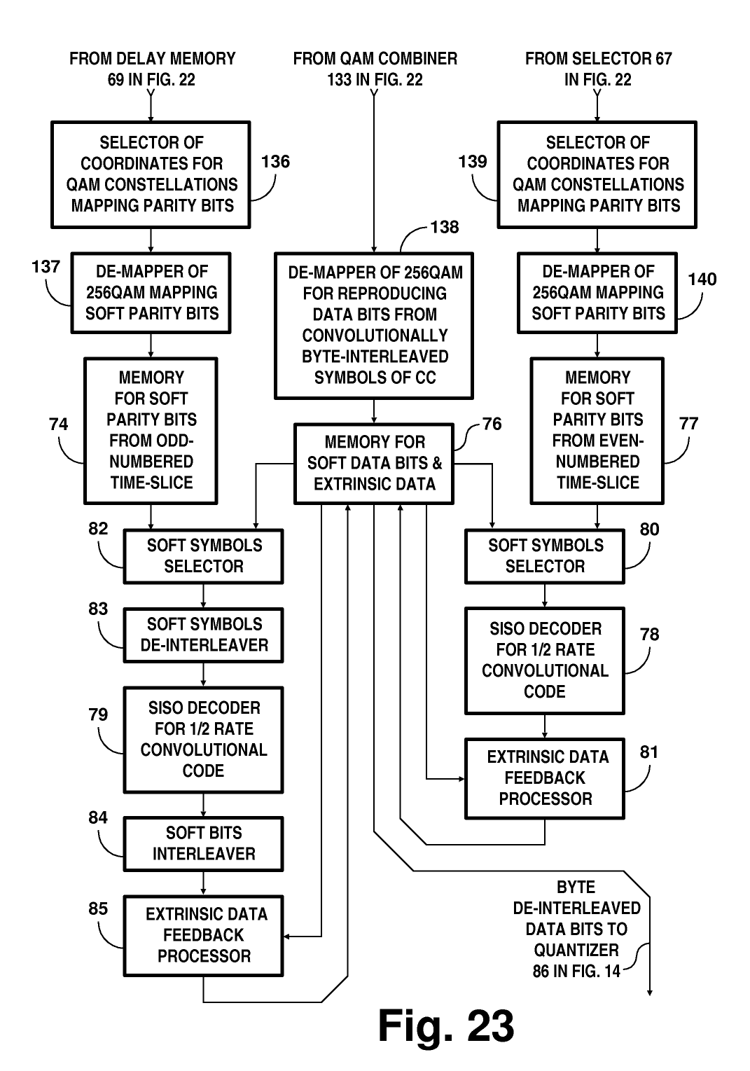

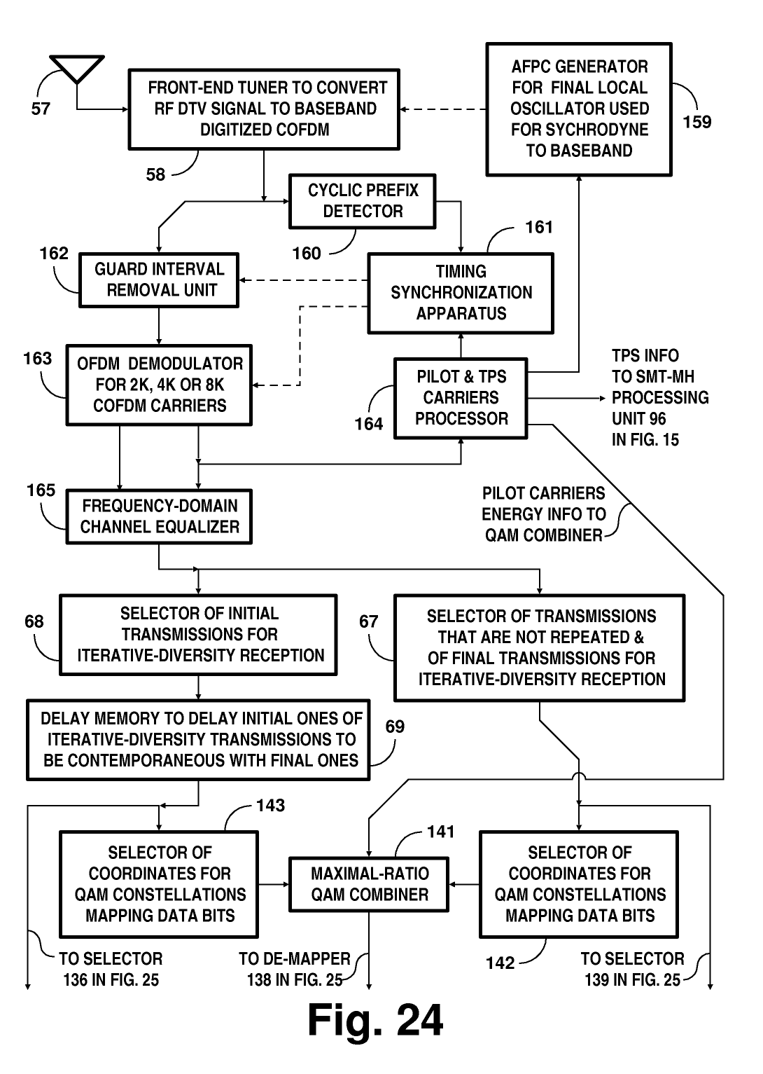

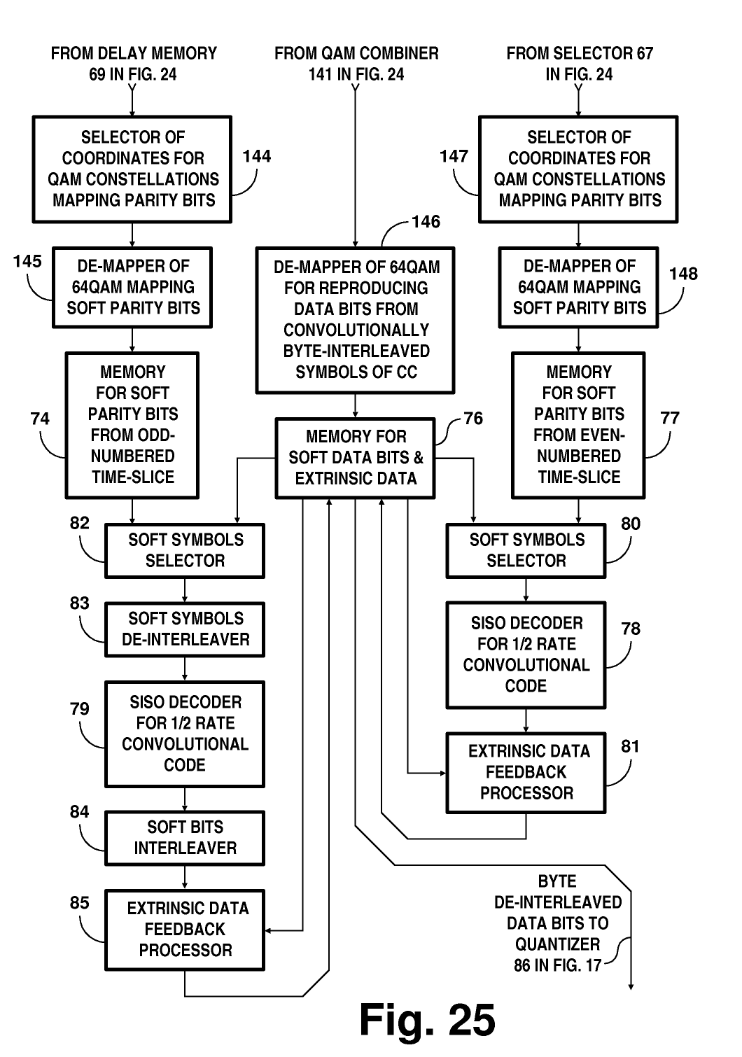

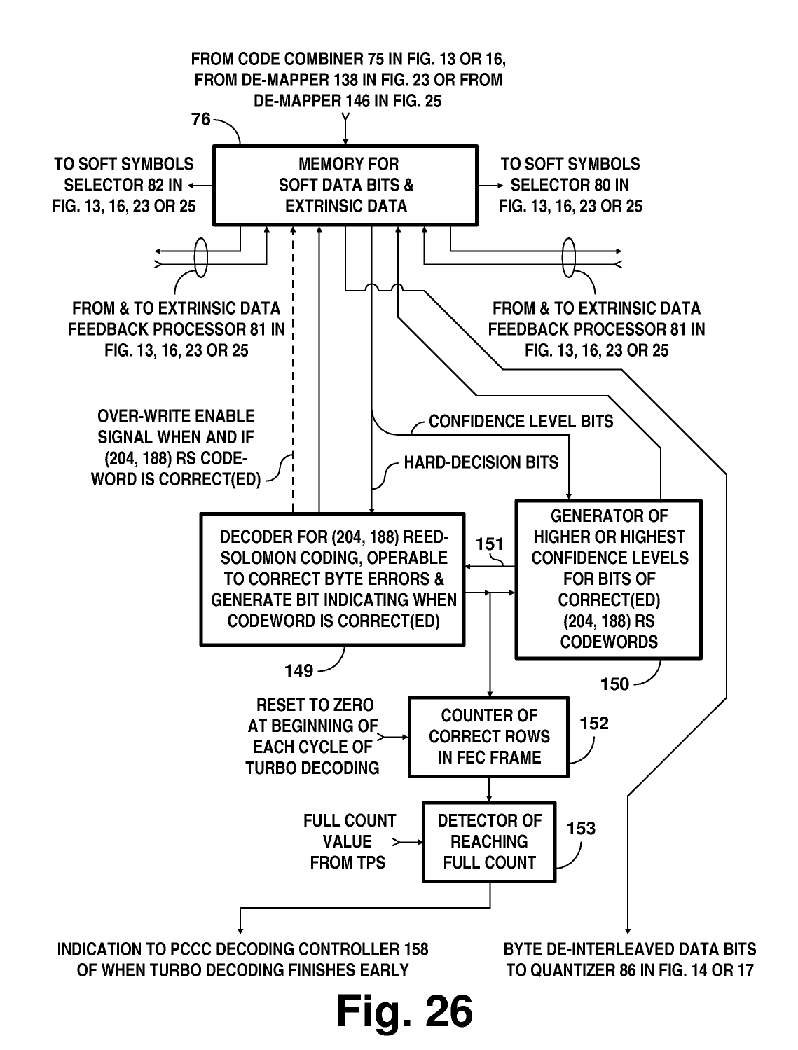

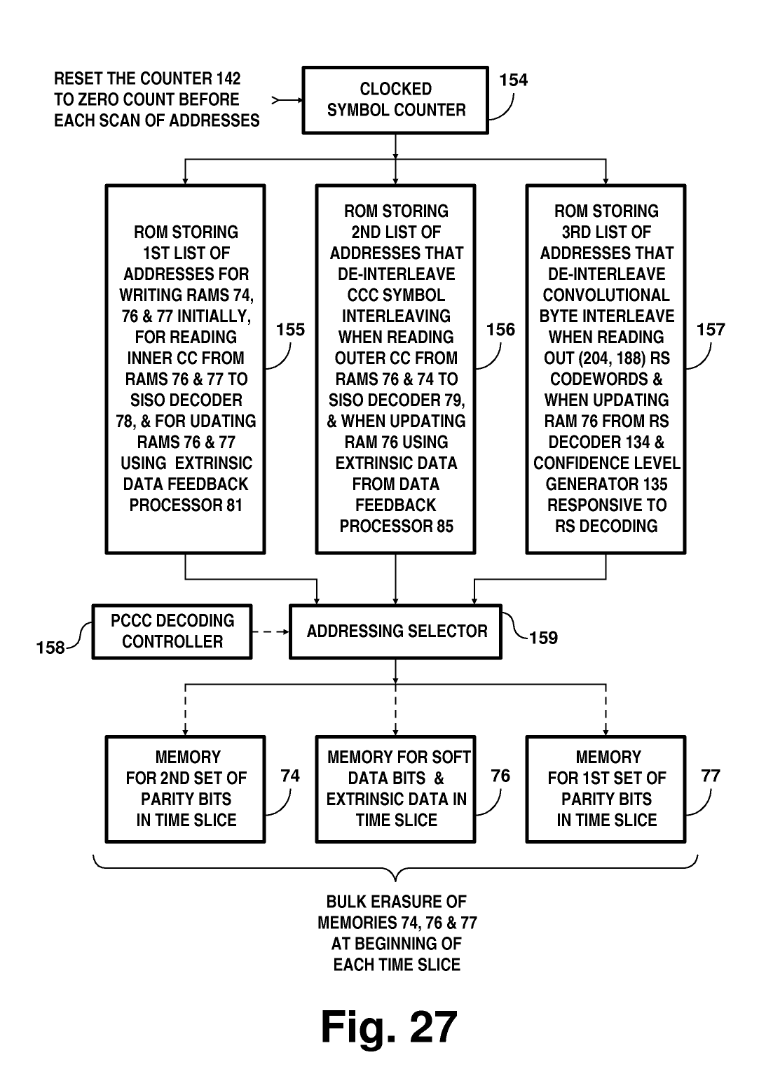

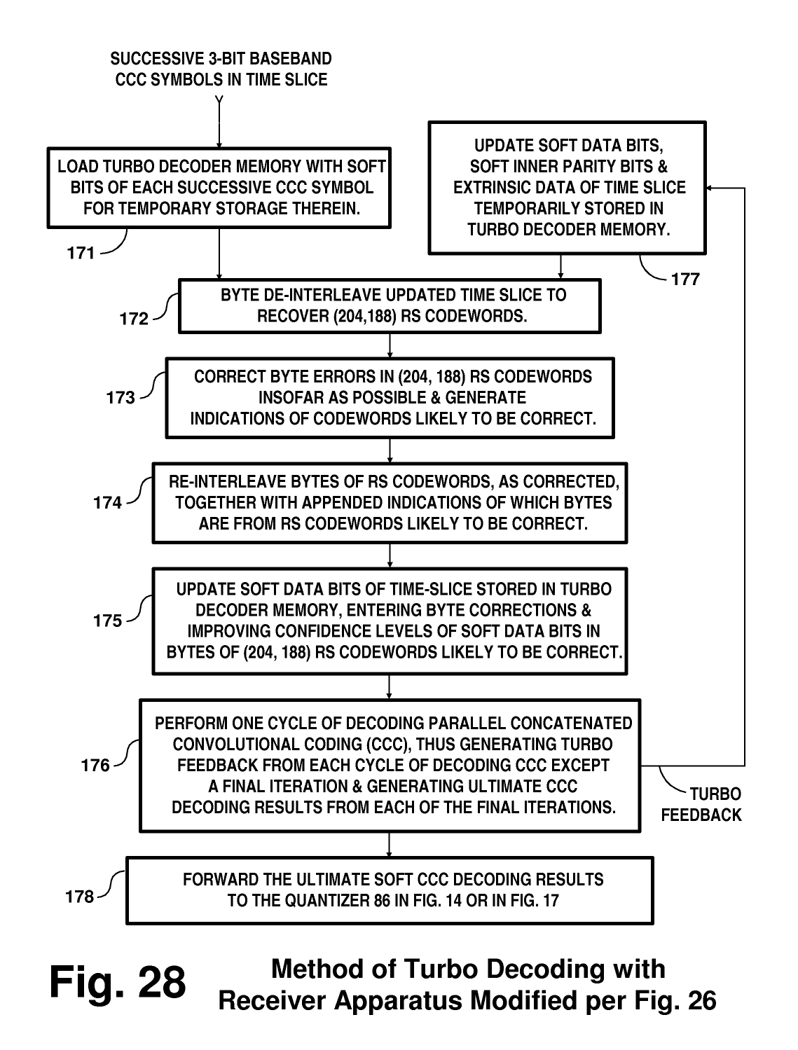

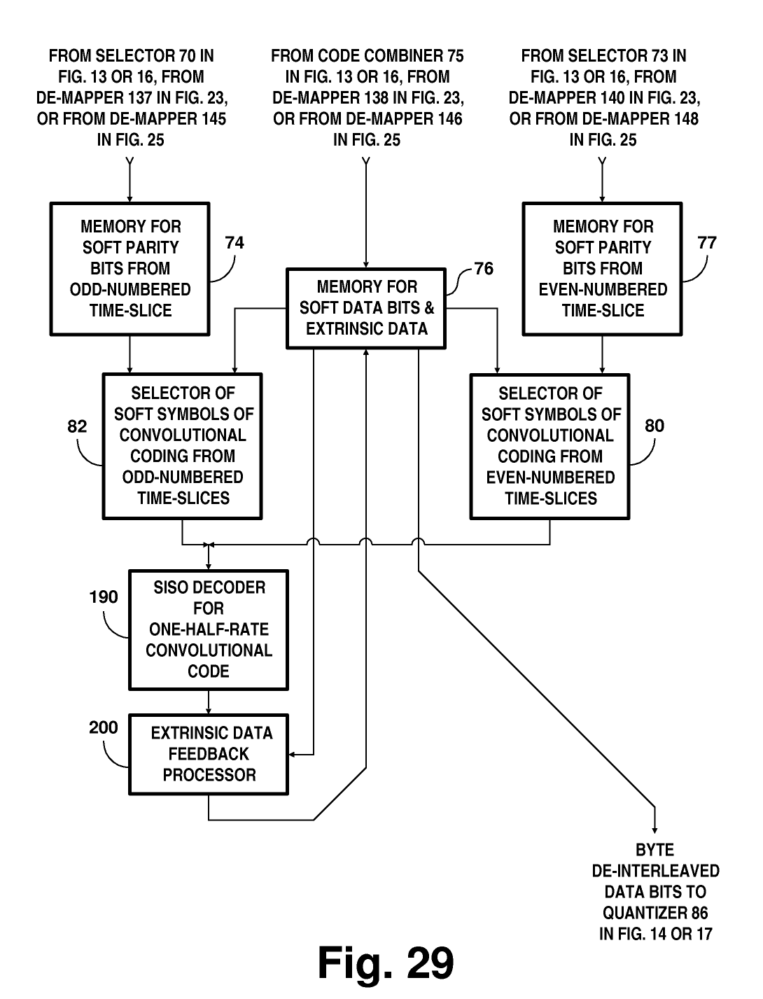

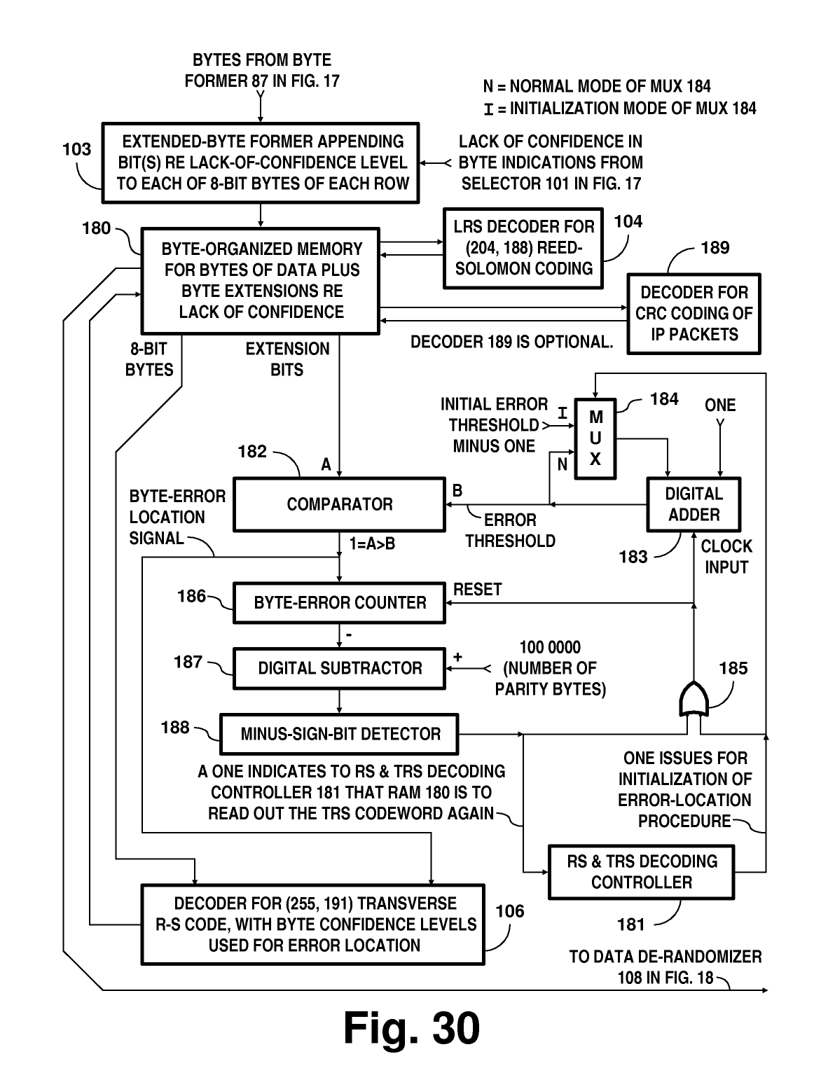

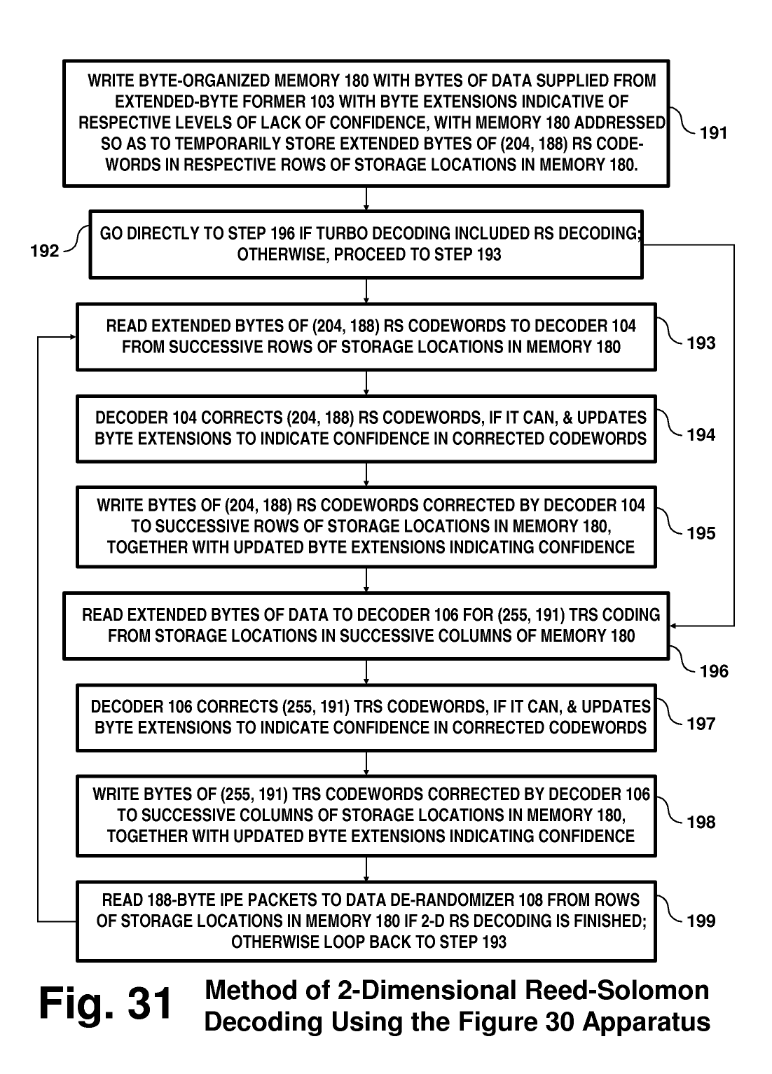

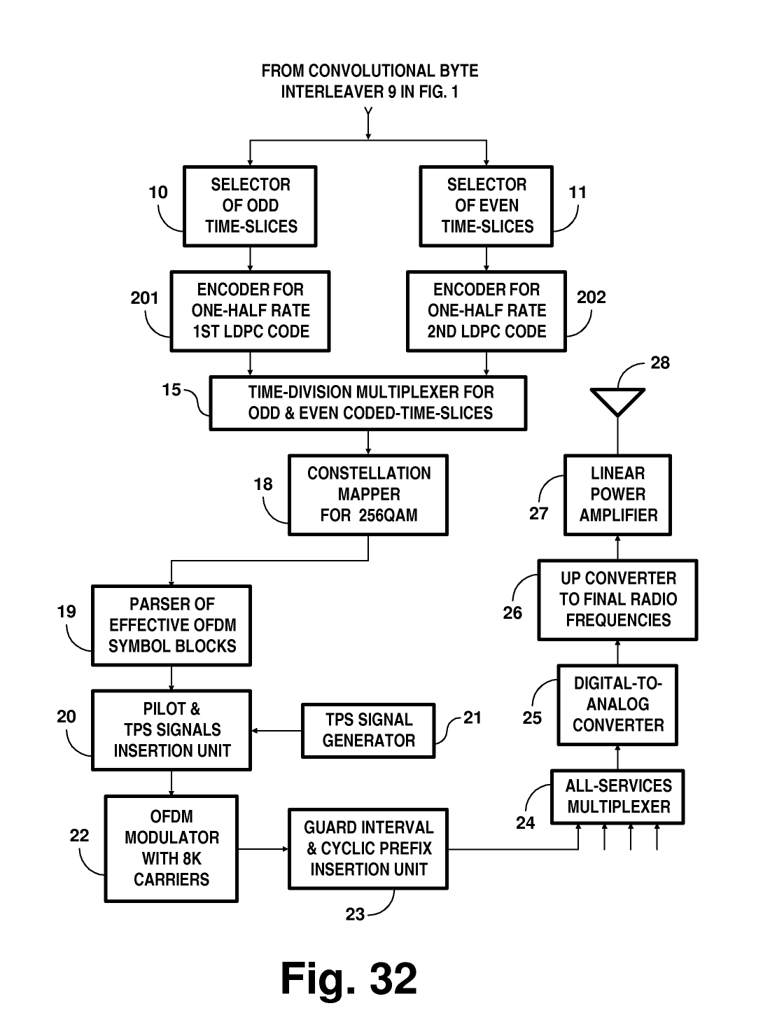

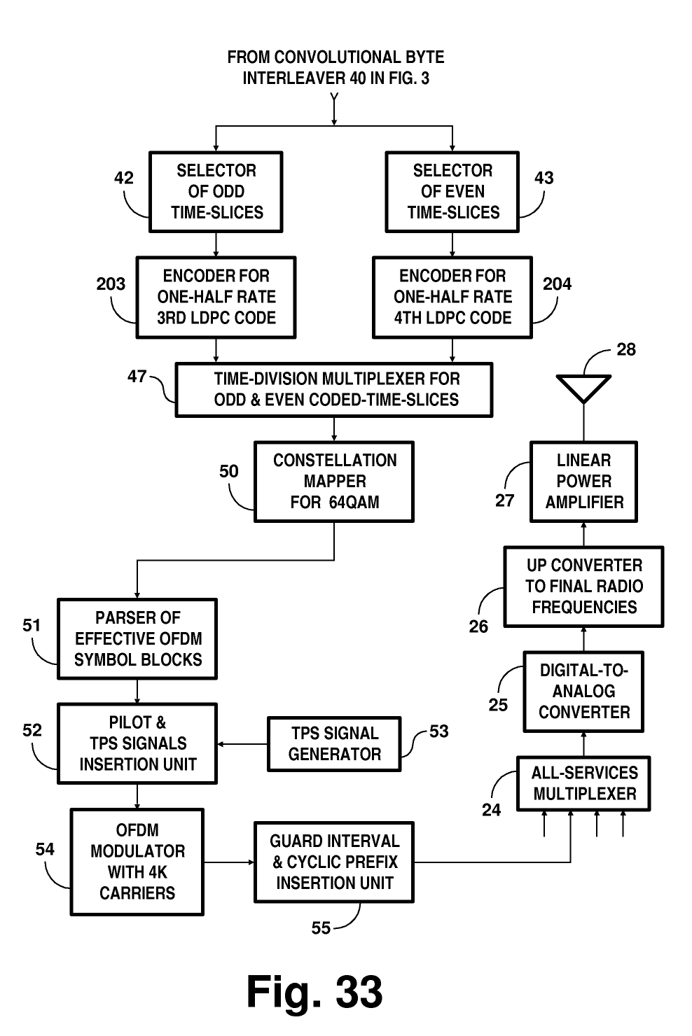

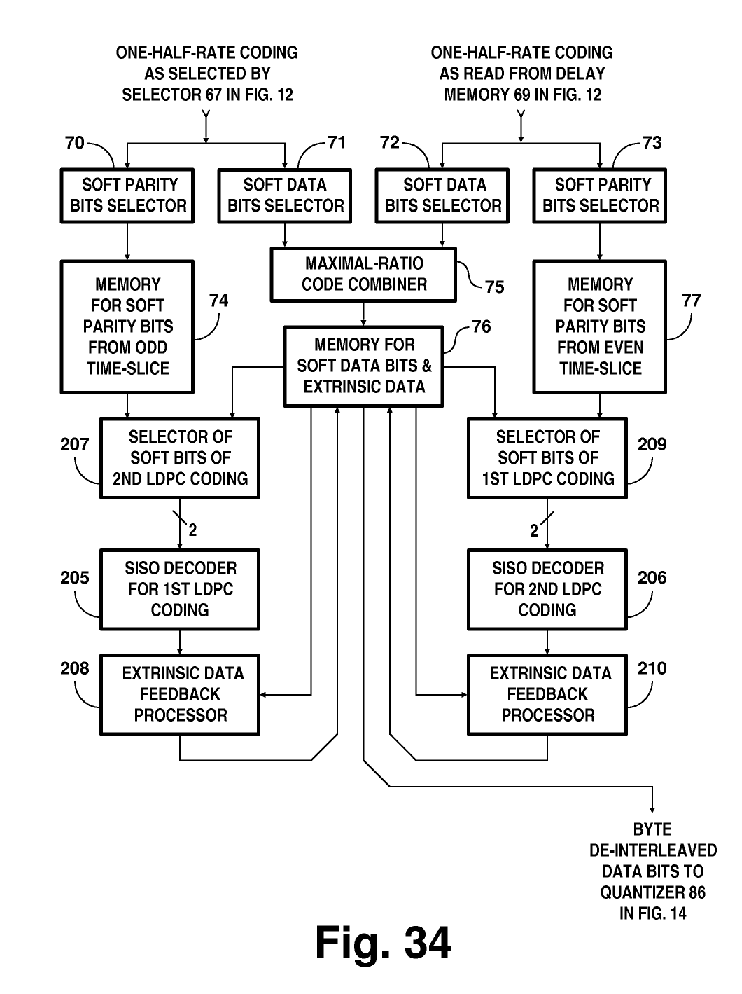

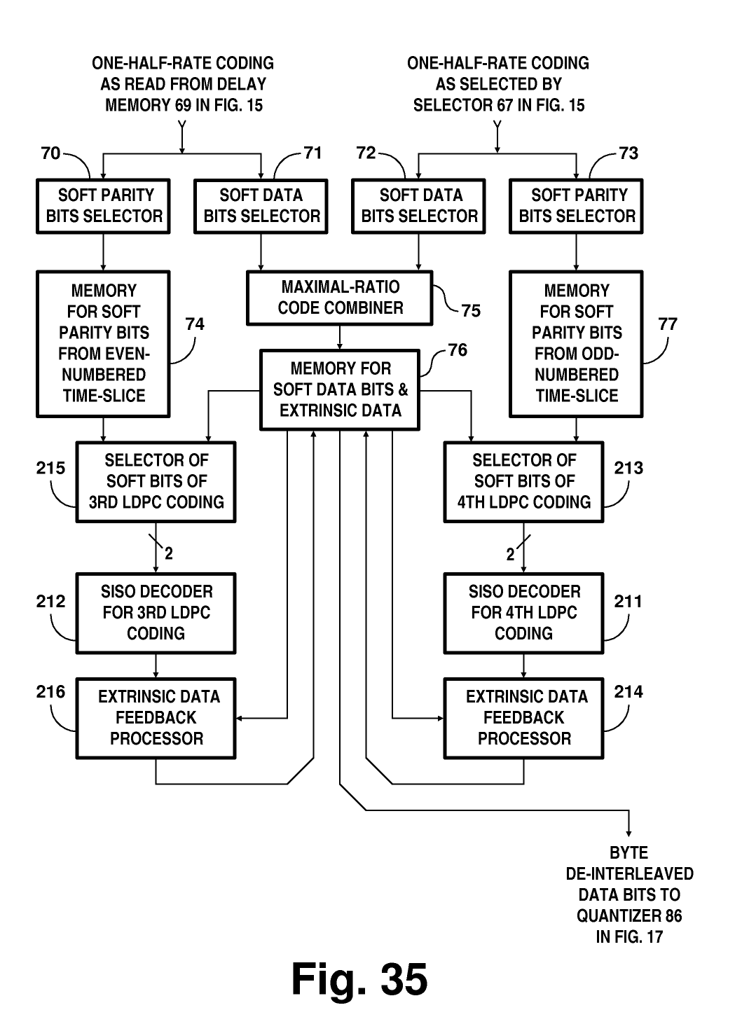

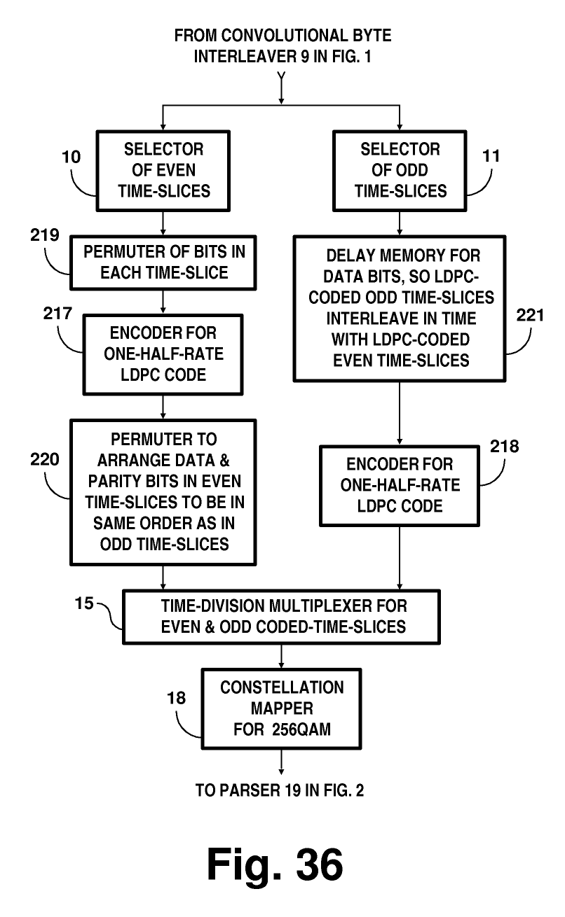

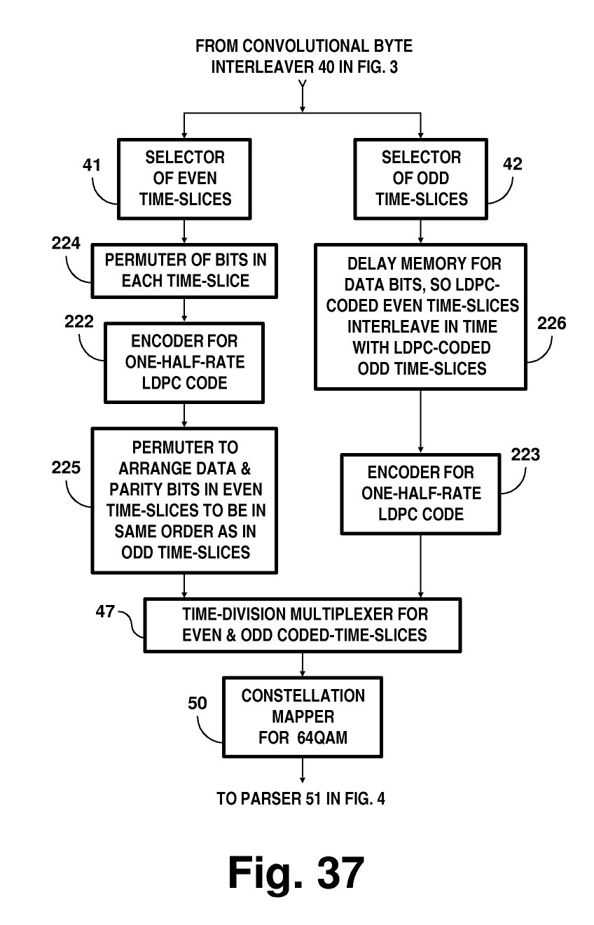

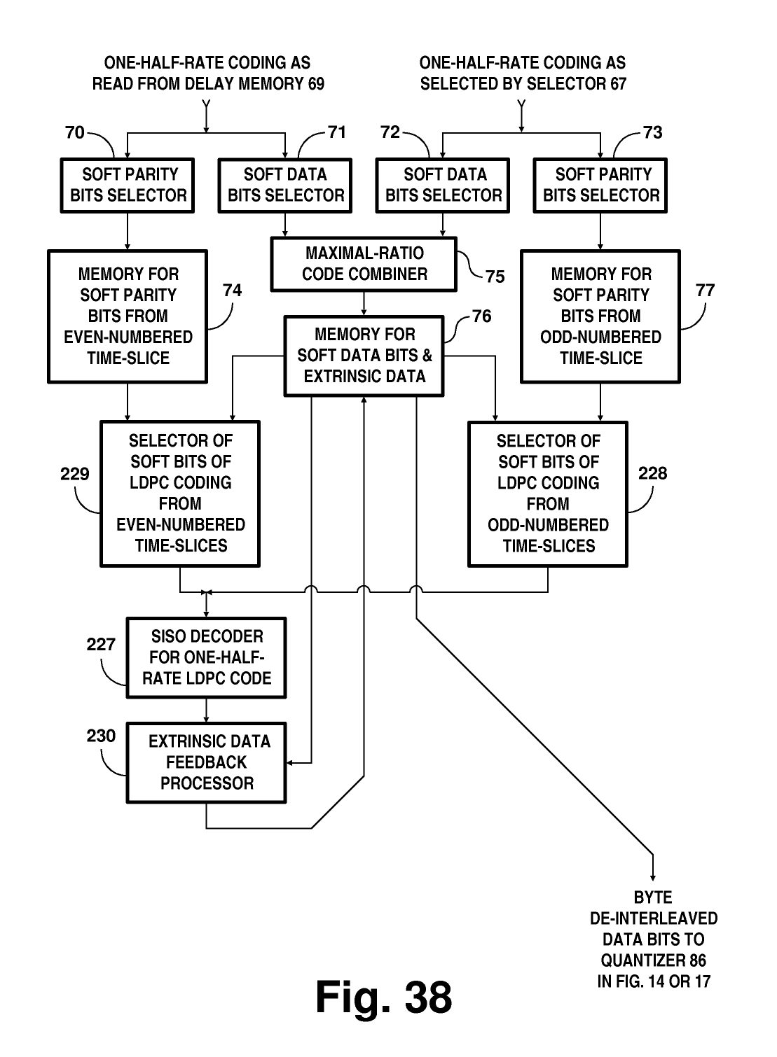

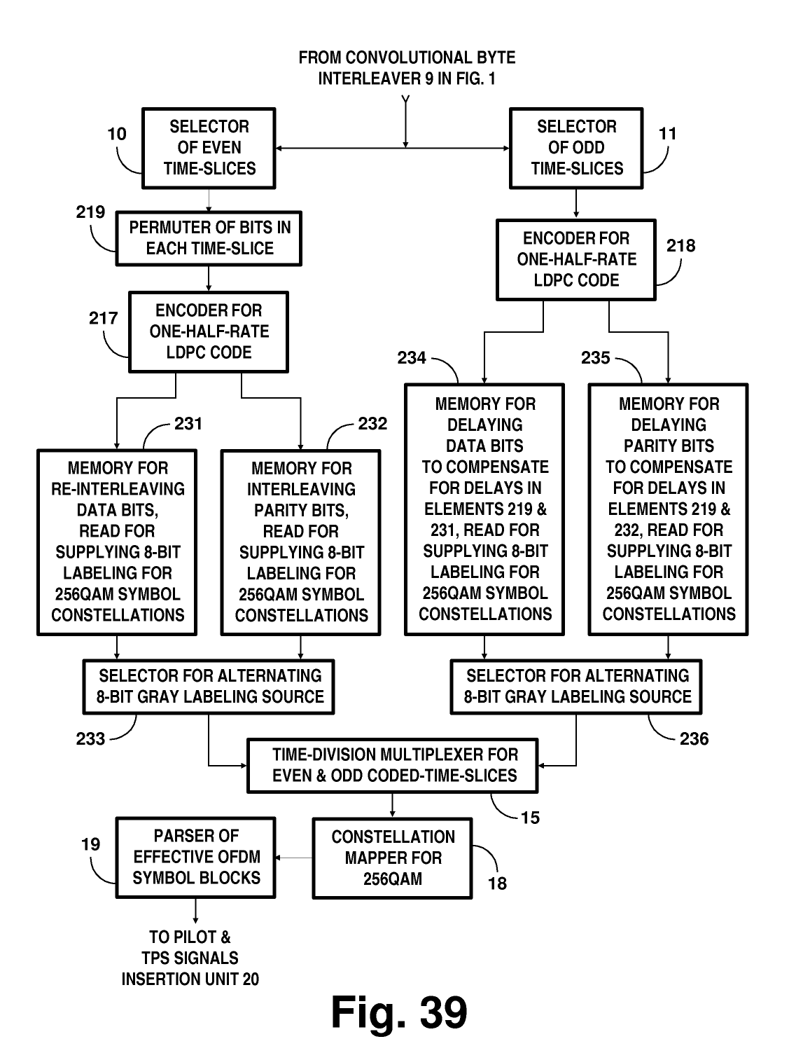

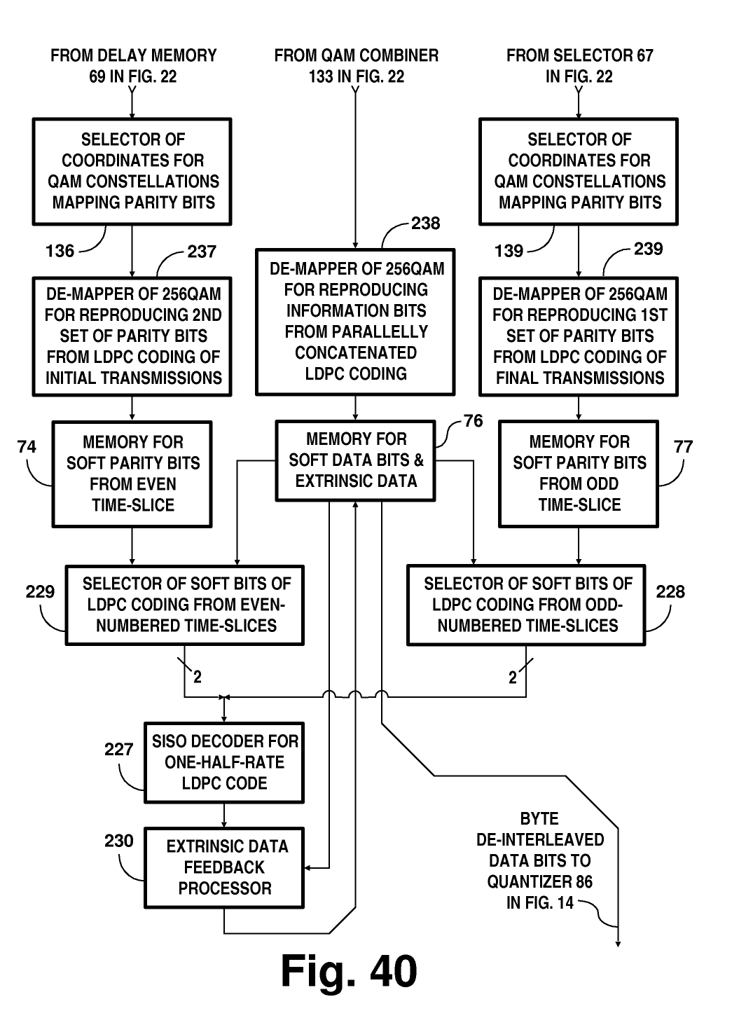

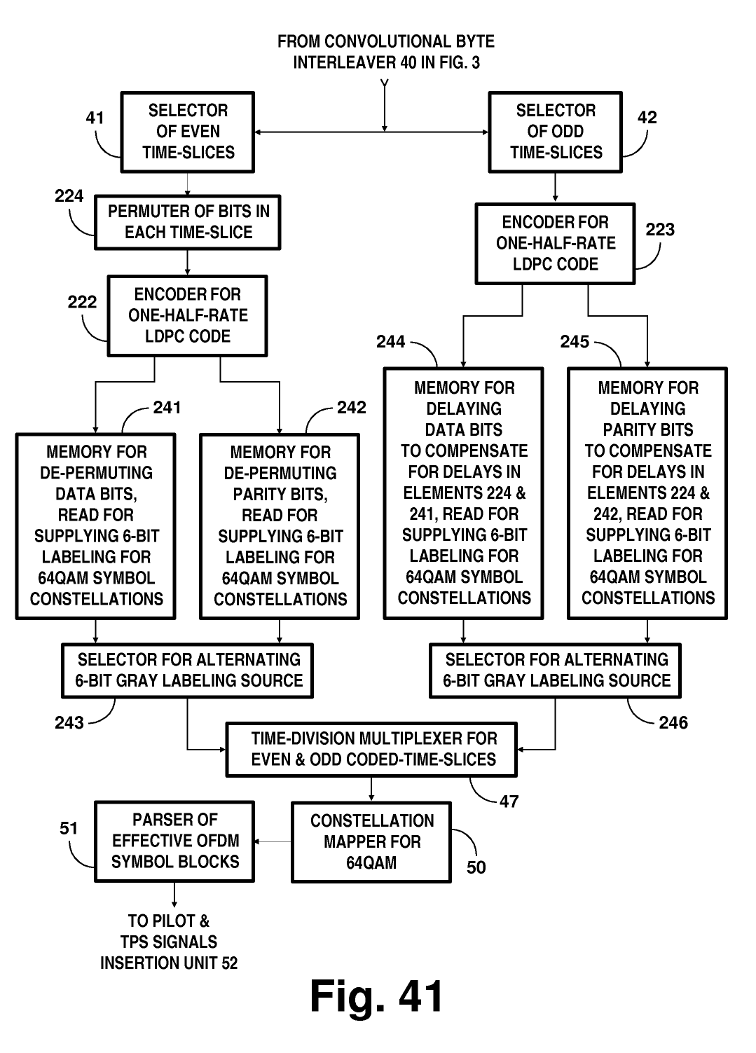

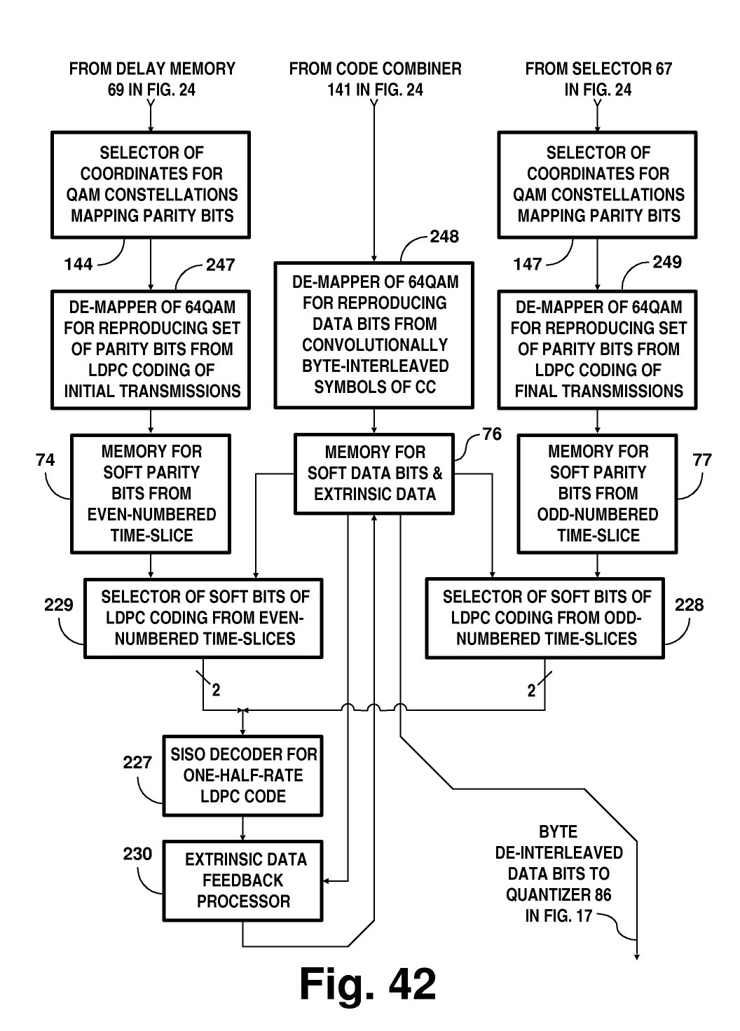

During the reading of soft data bits of the turbo decoding results from the memory 76 in FIG. 16, its read addressing is such as to counteract the convolutional byte interleaving introduced at the DTV transmitter by the convolutional byte interleaver 31 shown in FIG. 3. The soft data bits of the turbo decoding results read from the memory 76 are supplied to the input port of the quantizer 86 shown in FIG. 17. The soft data bits of the turbo decoding results read from the memory 76 are supplied also to the bank 100 of exclusive-OR gates shown in FIG. 17. FIG. 17 shows an 8-bit-byte former 87 connected for forming the serial-bit response of the quantizer 86 into eight-bit bytes. An extended-byte former 103 is connected for receiving the 8-bit bytes formed by the 8-bit-byte former 87 and appending to each of those bytes a number of bits indicative of the likelihood that that byte is in error. These bits indicative of the level of lack of confidence that a byte is correct are generated in the following way. The bank 100 of XOR gates is connected for exclusive-ORing the hard bit of each successive soft data bit in the turbo decoding results read from the memory 76 with each of the soft bits descriptive of the level of confidence that hard bit is correct. The bank 100 of XOR gates thus generates a respective set of bits indicative of the level of lack of confidence that each successive hard bit is correct. A selector 101 selects the largest of the successive lack-of-confidence levels regarding the eight bits in each 8-bit-byte, to determine a level of lack of confidence that the byte is correct. The selector 101 provides the extended-byte former 103 with bits indicative of the level of lack of confidence that the byte is correct, which bits are appended to the byte to generate an extended-byte. Typically, there are four to eight bits in the byte extensions. The output port of the extended-byte former 103 is connected for supplying successive extended-bytes to the input port of a decoder 104 for (204, 188) Reed-Solomon coding.

FIG. 17 shows the RS decoder 104 as being of a preferred type that uses a decoding algorithm for correcting up to sixteen byte errors in each (204, 188) Reed-Solomon codeword, but requires that byte errors be located by means other than that decoding algorithm. Accordingly, the RS decoder 104 can include a threshold detector that compares the levels of lack of confidence for each byte in each successive (204, 188) RS codeword to a threshold value. This threshold detector generates a byte error indication for each byte having a level of lack of confidence that exceeds the threshold value. The threshold detector then provides the RS decoder 104 with indications of the locations of the byte errors in the (204, 188) RS codeword next to be corrected. The RS decoder 104 is unusual also in that it is provided capability for adjusting the extension of each byte in the 188-byte IPE packets in the decoding results therefrom. The output port of the RS decoder 104 supplies 188-byte IPE packets with each byte accompanied by a byte extension indicative of the level of lack of confidence in that byte being correct. If the RS decoder 104 was capable of correcting the IPE packet, the byte extensions are zero-valued. If the RS decoder 104 was incapable of correcting the IPE packet, the byte extensions retain the values they had upon entry into the RS decoder 104.

The extended bytes of each IPE packet are written into a successive respective row of extended-byte storage locations in a random-access memory 105 operated to perform the matrix-type block de-interleaving procedure that is a first step of the TRS decoding routine. The RAM 105 is subsequently read one column of extended bytes at a time to a decoder 106 of (255, 191) Reed-Solomon code. The extension bits accompanying the 8-bit bytes of the TRS code are used to help locate byte errors for the TRS code, as will be described in further detail infra with reference to FIG. 30. Such previous location of byte errors facilitates successful use of a Reed-Solomon algorithm capable of correcting more byte errors than an algorithm that must locate byte errors as well as correct them. The 8-bit data bytes that have been corrected insofar as possible by the RS decoder 106 are written, column by column, into respective columns of byte-storage locations of a random-access memory 107. The RAM 107 is operated to perform the matrix-type block re-interleaving procedure for data in further steps of the TRS decoding routine. In a final step of the TRS decoding routine, the byte-storage locations in the RAM 107 are read from row by row for supplying reproduced randomized M/H data to the input port of a data de-randomizer 108 in the FIG. 18 portion of the M/H receiver.

Referring now to FIG. 18, the data de-randomizer 108 is connected for receiving the output signal read from the byte-organized RAM 107 in FIG. 17. The data de-randomizer 108 de-randomizes the bytes of that signal by converting them to serial-bit form and exclusive-ORing the bits with the pseudo-random binary sequence (PRBS) prescribed for data randomization. The data de-randomizer 108 then converts the de-randomized bits into bytes of IP data. From this point on, the receiver resembles a mobile/handheld (M/H) receiver for M/H transmissions made using 8VSB specified by the standard directed to broadcasting digital television and digital data to mobile receivers adopted by ATSC on 15 Oct. 2009. The IP data essentially correspond to the IP data that an M/H receiver recovers from M/H transmissions made using 8VSB.

The input port of a parsing unit 109 for parsing the data stream into internet-protocol (IP) packets is connected for receiving bytes of DVB-H data from the output port of the DVB-H data de-randomizer 108. The IP-packet parsing unit 109 performs this parsing responsive to two-byte row headers respectively transmitted at the beginning of each row of IP data in the FEC frame. This row header indicates where the earliest start of an IP packet occurs within the row of IP data bytes from the FEC frame. If a short IP packet is completely contained within a row of bytes within the FEC frame, the IP-packet parsing unit 109 calculates the start of a later IP packet proceeding from the packet length information contained in the earlier IP packet from that same row of bytes within the FEC frame.

The IP-packet parsing unit 109 is connected for supplying IP packets to a decoder 110 for cyclic-redundancy-check coding in IP packets. Each IP packet begins with a nine-byte header and concludes with a four-byte, 32-bit checksum for CRC coding of that IP packet. The decoder 110 is constructed to preface each IP packet that it reproduces with a prefix bit indicating whether or not error has been detected in that IP packet. The decoder 110 is connected to supply these IP packets as so prefaced to a detector 111 of a “well-known” SMT-MH address and to a delay unit 112. The delay unit 112 delays the IP packets supplied to a packet selector 113 for selecting SMT-MH packets from other IP packets. The delay unit 112 provides delay of a part of an IP packet header interval, which delay is long enough for the detector 111 to ascertain whether or not the “well-known” SMT-MH address is detected.

If the detector 111 does not detect the “well-known” SMT-MH address in the IP packet, the detector 111 output response conditions the packet selector 113 to reproduce the IP packet for application to a packet sorter 114 as input signal thereto. The packet sorter 114 sorts out those IP packets in which the preface provides no indication of CRC coding error for writing to a cache memory 115 for IP packets. The prefatory prefix bit before each of the IP packets that indicates whether there is CRC code error in its respective bytes is omitted when writing the cache memory 115. The cache memory 115 temporarily stores at least those IP packets not determined to contain CRC code error for possible future reading to the later stages 116 of the receiver.

If the detector 111 does detect the “well-known” SMT-MH address in the IP packet, establishing it as an SMT-MH packet, the detector 111 output response conditions the packet selector 113 to reproduce the SMT-MH packet for application to an SMT-MH processing unit 117, which includes circuitry for generating control signals for the later stages 116 of the mobile receiver. FIG. 18 shows the SMT-MH processing unit 117 connected for receiving FIC information from the TPS carriers processor 164 in FIG. 15. The SMT-MH processing unit 117 integrates this information with information from SMT-MH packets during the generation of Service Map Data. The Service Map Data generated by the SMT-MH processing unit 117 is written into memory 118 for temporary storage therein and subsequent application to the later stages 116 of the mobile receiver. The SMT-MH processing unit 117 relays those SMT-MH packets that have bit prefixes that do not indicate error in the packets to a user interface 119, which includes an Electronic Service Guide (ESG) and apparatus for selectively displaying the ESG on the viewing screen of the mobile receiver.

FIG. 19 is a more detailed schematic diagram showing the interconnection of elements 750, 751, 752, 753, 754, 755, 756, 757, 758 and 759 of the maximal-ratio code combiner 75 shown in FIGS. 13 and 16. In the stationary DTV receiver of FIGS. 12, 13 and 14, the code combiner 75 shown in FIG. 13 is connected for receiving pilot-carrier-energy information from a pilot and TPS carriers processor 64. In the M/H receiver of FIGS. 15, 16, 17 and 18 the code combiner 75 shown in FIG. 16 is connected for receiving pilot-carrier-energy information from a pilot and TPS carriers processor 164. The pilot and TPS carriers processor 64 or 164 squares the real and imaginary terms of each unmodulated pilot carrier, sums the resulting squares and square-roots the sum to determine the root-mean-square (RMS) energy of that unmodulated pilot carrier. This procedure can be carried out for each unmodulated pilot carrier using read-only memory addressed by the real and imaginary terms of each successively considered unmodulated pilot carrier. The RMS energies of the unmodulated pilot carriers are then summed by an accumulator to determine the total RMS energy of the unmodulated pilot carriers for each OFDM symbol epoch.

The value of the total RMS energy supplied from the pilot and TPS carriers processor 64 or 164 is delayed by shim delay 750 for application to the respective input ports of selectors 751 and 752. The selector 751 reproduces at its output port the total energy of the unmodulated pilot carriers during those transmissions that are not repeated and the final ones of the those transmissions repeated for iterative-diversity reception. The selector 752 reproduces at its output port the total energy of the unmodulated pilot carriers during the initial ones of those transmissions repeated for iterative-diversity reception. A delay memory 753 is connected for delaying the selector 752 response for supplying a delayed selector 752 response concurrent with the selector 751 response.

In the stationary receiver of FIGS. 12, 13 and 14 the length of delay afforded by the delay memory 753 is essentially the same as the length of delay afforded by the delay memory 69. The latent delay of the pilot and TPS carriers processor 64 in generating the total energy of the unmodulated pilot carriers is supposedly shorter than the combined latent delays through the channel equalizer 65 and the de-mapper 66. The shim delay 750 compensates for this. The latent delay of the pilot and TPS carriers processor 64 in generating the total energy of the unmodulated pilot carriers may be longer than the combined latent delays through the channel equalizer 65 and the de-mapper 66. If so, the shim delay 750 is replaced by direct connection from the pilot and TPS carriers processor 64 to the selectors 751 and 752. Shim delay is instead introduced in the cascade connection of the channel equalizer 65 and the de-mapper 66.

In the mobile receiver of FIGS. 15, 16, 17 and 18 the length of delay afforded by the delay memory 753 is essentially the same as the length of delay afforded by the delay memory 69. The latent delay of the pilot and TPS carriers processor 164 in generating the total energy of the unmodulated pilot carriers is supposedly shorter than the combined latent delays through the channel equalizer 165 and the de-mapper 166. The shim delay 750 compensates for this. The latent delay of the pilot and TPS carriers processor 64 in generating the total energy of the unmodulated pilot carriers may be longer than the combined latent delays through the channel equalizer 165 and the de-mapper 166. If so, the shim delay 750 is replaced by direct connection from the pilot and TPS carriers processor 164 to the selectors 751 and 752. Shim delay is introduced instead in the cascade connection of the channel equalizer 165 and the de-mapper 166.

A digital adder 754 is connected for adding the selector 751 response and the delayed selector 752 response read from the delay memory 753. The sum output response from the adder 754 combines the total energies of the initial and final transmissions for iterative-diversity reception, to be used for normalizing the weighting of the responses from the soft-data-bits selectors 71 and 72.

A read-only memory 755 is connected for multiplying the response from the soft-data-bits selector 71 by the total energy of a final transmission for iterative-diversity reception. A read-only memory 756 is connected for multiplying the response from the soft-data-bits selector 72 by the total energy of the corresponding initial transmission for iterative-diversity reception. The product from the ROM 755 is a weighted response from the soft-data-bits selector 72 that is then normalized with respect to the total energies of the initial and final transmissions for iterative-diversity reception. A read-only memory 757 is connected for performing this normalization, dividing the product from the ROM 755 by the sum output response from the adder 754. The product from the ROM 755 is a weighted response from the soft-data-bits selector 72 that is then normalized with respect to the total energies of the initial and final transmissions for iterative-diversity reception. A read-only memory 758 is connected for performing this normalization, dividing the product from the ROM 756 by the sum output response from the adder 754. A digital adder 759 is connected for summing the respective quotients from the ROMs 757 and 758 to generate the maximal-ratio code combiner response. This response is written to the memory 76 for soft data bits shown in FIG. 13, or to the memory 76 shown in FIG. 16.

One skilled in digital electronics design is apt to perceive that, alternatively, normalization of the coefficients for weighting of the responses from the soft-data-bits selectors 71 and 72 can be performed before such weighting, rather than after. A single read-only memory can be designed to perform the combined functions of the ROMs 755 and 757; and a single read-only memory can be designed to perform the combined functions of the ROMs 756 and 758. Alternatively, a very large single read-only memory can be designed to perform the combined functions of the digital adder 759 and of the ROMs 755, 756, 757 and 758. The computations can be performed by digital circuitry other than read-only memories, but problems with proper timing are considerably more difficult.

The operation of the maximal-ratio code combiner 75 following a change in RF channel or sub-channel is of interest. Following such a change, a DTV receiver as described supra will not have foregoing initial transmissions for iterative-diversity reception stored in its delay memory 69. Accordingly, the DTV receiver erases the contents of the delay memory 69 in bulk. The pilot and TPS carriers processor 64 or 164 will not have supplied the maximal-ratio code combiner 75 with information concerning the RMS-energy of pilot carriers accompanying the foregoing initial transmissions for iterative-diversity reception. Accordingly, the DTV receiver erases the contents of delay memory within the maximal-ratio code combiner 75 that stores such information. This erasure conditions the maximal-ratio code combiner 75 for single-transmission reception until the delay memory 753 therein refills with information concerning the RMS-energy of pilot carriers accompanying the foregoing initial transmissions for iterative-diversity reception. During this delay in the maximal-ratio code combiner 75 beginning iterative-diversity reception, the delay memory 69 fills with initial transmissions for iterative-diversity reception to be supplied with delay to the code combiner 75 when iterative-diversity reception begins.

The maximal-ratio code combiner 75 combines one-dimensional, real-only coded data obtained from separately de-mapping paired QAM constellation maps. In accordance with a further aspect of the invention, the QAM constellation maps are designed so as not to admix data bits and parity bits of the PCCC in the bits that they respectively map. This makes it possible to use maximal-ratio code combining of the complex coordinates of the QAM constellation maps of data bits from the pairs of transmissions designed for iterative-diversity reception. When both the earlier transmissions of the QAM constellations and the later transmissions of the same QAM constellations are received in strength, such combining of the complex coordinates of paired QAM constellation maps of data bits permits improvement of coordinates estimation in the presence of additive white Gaussian noise (AWGN). This is because the complex coordinates of the paired QAM constellation maps of data bits should be correlated, while the AWGN is uncorrelated. Accordingly, errors in de-mapping are less likely to occur, as well as gaps in reception tending to be filled. Maximal-ratio code combining performed on the results of de-mapping QAM constellation maps of data bits tends to fill gaps in reception, but is not adapted to reducing AWGN. The two-dimensional maximal-ratio code combining of the complex coordinates of two similar QAM constellation maps is referred to as “maximal-ratio QAM combining” in the rest of this specification, and the apparatus for performing such code combining is referred to as a “maximal-ratio QAM combiner”. The operation of the maximal-ratio QAM combiner following a change in RF channel or sub-channel is analogous to the operation of a maximal-ratio coder combiner following a change in RF channel or sub-channel, as described in the paragraph just previous. Separating the data bits and the parity bits of the PCCC from each other for mapping to different QAM symbol constellations entails some sacrifice in that elements of the PCCC can no longer be matched to the Gray mapping within each QAM symbol constellation as described supra.

FIG. 20 shows modifications of the FIG. 2 portion of the COFDM transmitter shown in FIGS. 1, 2, 3 and 4. The respective input ports of the selectors 10 and 11 are still connected for receiving the response of the convolutional byte interleaver 4 shown in FIG. 1. The output port of the selector 10 of even time-slices still connects to the input port of the data bits interleaver 12, and the output port of the data bits interleaver 12 still connects to the input port of the encoder 13 for one-half-rate convolutional coding (CC). However, in FIG. 20 the output port of the selector 11 of odd time-slices connects directly to the input port of the encoder 17 for one-half-rate convolutional coding (CC) rather than connecting via delay memory as shown in FIG. 2.

In FIG. 20 the symbols interleaver 14 shown in FIG. 2 is replaced by random-access memories 121 and 122. The RAM 121 has a write-input port connected to be written with the data bits of one-half-rate CC of initial transmissions that subsequently are repeated for iterative-diversity reception, as supplied from a first output port of the CC encoder 13. The RAM 121 has a read-output port connected for supplying bytes of data bits to a first input port of a selector 123 of the 8-bit Gray labeling used by the 256QAM symbol constellation mapper 18 during even time-slices. The RAM 122 has a write-input port connected to be written with the parity bits of the one-half-rate CC of the initial transmissions that subsequently are repeated for iterative-diversity reception, as supplied from a second output port of the CC encoder 13. The RAM 122 has a read-output port connected for supplying bytes of parity bits to a second input port of the selector 123 of the 8-bit Gray labeling used by the 256QAM symbol constellation mapper 18 during even time-slices. The write addressing and read addressing of the RAMs 121 and 122 are co-operative to implement coded (or “implied”) symbol interleaving of the one-half-rate CC of initial transmissions that subsequently are repeated for iterative-diversity reception. This form of symbol interleaving cooperates with the bit de-interleaver 12 preceding the encoder 13 of one-half-rate CC to restore the order of the data bits supplied from the output port of the selector 10. FIG. 20 shows the output port of the selector 123 connected to supply a first input port of the time-division multiplexer 15 with 8-bit Gray labels for 256QAM constellation maps in even-numbered time-slices of COFDM signals intended for iterative-diversity reception.

In FIG. 20 the delay to compensate for the latencies of the bits de-interleaver 12 and of the RAMs 121 and 122 is provided for by random-access memories 124 and 125. The RAM 124 has a write-input port connected to be written with the data bits of one-half-rate CC of those transmissions that are not repeated and of the final ones of those transmissions that are repeated, as supplied from a first output port of the CC encoder 17. The RAM 124 has a read-output port connected for supplying bytes of data bits to a first input port of a selector 126 of the 8-bit Gray labeling used by the 256QAM symbol constellation mapper 18 during odd time-slices. The RAM 125 has a write-input port connected to be written with the parity bits of the one-half-rate CC of those transmissions that are not repeated and of the final ones of those transmissions that are repeated for iterative-diversity reception, as supplied from a second output port of the CC encoder 17. The RAM 125 has a read-output port connected for supplying bytes of parity bits to a second input port of the selector 126 of the 8-bit Gray labeling used by the 256QAM symbol constellation mapper 18 during odd time-slices. FIG. 20 shows the output port of the selector 126 connected to supply a second input port of the time-division multiplexer 15 with 8-bit Gray labels for 256QAM constellation maps in odd-numbered time-slices of COFDM signals intended for iterative-diversity reception.

The time-division multiplexer 15 and the selectors 123 and 126 are depicted as physically separate elements as an aid to the reader in understanding the desired operation of the FIG. 20 configuration. In actual practice the functions of the time-division multiplexer 15 and of the selectors 123 and 126 can be subsumed into the read-control circuits of the RAMs 121, 122, 124 and 125, as one skilled in digital electronics design will understand.

FIG. 21 shows modifications of the FIG. 4 portion of the COFDM transmitter shown in FIGS. 1, 2, 3 and 4. The respective input ports of the selectors 42 and 43 are still connected for receiving the response of the convolutional byte interleaver 41 shown in FIG. 3. The output port of the selector 42 of even time-slices still connects to the input port of the data bits interleaver 44, and the output port of the data bits interleaver 44 still connects to the input port of the encoder 45 for one-half-rate convolutional coding (CC). The output port of the selector 42 of odd time-slices still connects directly to the input port of the encoder 49 for one-half-rate convolutional coding (CC).

In FIG. 21 the symbols interleaver 46 shown in FIG. 4 is replaced by random-access memories 127 and 128. The RAM 127 has a write-input port connected to be written with the data bits of one-half-rate CC of initial transmissions that subsequently are repeated for iterative-diversity reception, as supplied from a first output port of the CC encoder 45. The RAM 127 has a read-output port connected for supplying data bits to a first input port of a selector 129 of the 6-bit Gray labeling used by the 64QAM symbol constellation mapper 47 during even time-slices. The RAM 127 has a write-input port connected to be written with the parity bits of the one-half-rate CC of the initial transmissions that subsequently are repeated for iterative-diversity reception, as supplied from a second output port of the CC encoder 45. The RAM 128 has a read-output port connected for supplying data bits to a second input port of the selector 129 of the 6-bit Gray labeling used by the 64QAM symbol constellation mapper 50 during even time-slices. The write addressing and read addressing of the RAMs 127 and 128 are co-operative to implement coded (or “implied”) symbol interleaving of the one-half-rate CC of initial transmissions that subsequently are repeated for iterative-diversity reception. FIG. 21 shows the output port of the selector 129 connected for supplying a first input port of the time-division multiplexer 47 with 6-bit Gray labels for 64QAM constellation maps for just data bits, alternating with 6-bit Gray labels for 64QAM constellation maps for just parity bits.

In FIG. 21 the delay to compensate for the latencies of the bits de-interleaver 44 and of the RAMs 127 and 128 is provided for by random-access memories 130 and 131. The RAM 130 has a write-input port connected to be written with the data bits of one-half-rate CC of those transmissions that are not repeated and of the final ones of those transmissions that are repeated, as supplied from a first output port of the CC encoder 49. The RAM 131 has a read-output port connected for supplying data bits to a first input port of a selector 132 of the 6-bit Gray labeling used by the 64QAM symbol constellation mapper 50 during odd time-slices. The RAM 131 has a write-input port connected to be written with the parity bits of the one-half-rate CC of those transmissions that are not repeated and of the final ones of those transmissions that are repeated for iterative-diversity reception, as supplied from a second output port of the CC encoder 49. The RAM 131 has a read-output port connected for supplying parity bits to a second input port of the selector 132 of the 6-bit Gray labeling used by the 64QAM symbol constellation mapper 50 during odd time-slices. FIG. 21 shows the output port of the selector 132 connected for supplying a second input port of the time-division multiplexer 47 with 6-bit Gray labels for 64QAM constellation maps for just data bits, alternating with 6-bit Gray labels for 64QAM constellation maps for just parity bits.

The time-division multiplexer 47 and the selectors 129 and 132 are depicted as physically separate elements as an aid to the reader in understanding the desired operation of the FIG. 21 configuration. In actual practice the functions of the time-division multiplexer 47 and of the selectors 129 and 132 can be subsumed into the read-control circuits of the RAMs 127, 128, 130 and 131, as one skilled in digital electronics design will understand.

FIGS. 22 and 23 show modifications made to FIGS. 12 and 13 of the stationary DTV receiver of FIGS. 12, 13 and 14 in an alternative stationary DTV receiver suited for receiving transmissions from the DTV transmitter of FIGS. 1, 2, 3 and 4 with its FIG. 2 portion modified per FIG. 20. FIG. 22 differs from FIG. 12 in that the de-mapper 66 is omitted and the response of the frequency-domain channel equalizer 65 is supplied directly to the input ports of the selectors 67 and 68. In the FIG. 22 configuration the selectors 67 and 68 selectively respond to the complex coordinates of 256QAM symbol constellations supplied from the frequency-domain channel equalizer 65, rather than to demodulated PCCC from the omitted de-mapper 66 of 256QAM symbol constellations. The delay memory 69 delays the complex coordinates of 256QAM symbol constellations from the initial transmissions that subsequently are repeated for iterative-diversity reception, as reproduced at the output port of the selector 68. The complex coordinates of 256QAM symbol constellations from the initial transmissions reproduced after delay at the output port of the delay memory 69 are concurrent with the complex coordinates of corresponding 256QAM symbol constellations from the final transmissions reproduced at the output port of the selector 67.

FIG. 22 shows a maximal-ratio QAM combiner 133 for combining the complex coordinates of 256QAM symbol constellations descriptive of data bits, as selected from the initial transmissions for iterative-diversity reception, with the complex coordinates of corresponding 256QAM symbol constellations descriptive of data bits, as selected from the final transmissions for iterative-diversity reception. The complex coordinates of 256QAM symbol constellations descriptive of data bits, as selected from the final transmissions for iterative-diversity reception, are supplied to a first of the two input ports of the QAM combiner 133 from the output port of a selector 134. The input port of the selector 134 is connected for receiving the response of the selector 67 from the output port thereof. The input port of a selector 135 is connected for receiving the delayed response of the delay memory 69 to the complex coordinates of 256QAM symbol constellations, as selected by the selector 68 from the initial transmissions for iterative-diversity reception. The output port of the selector 135 is connected for supplying the second input port of the QAM combiner 133 with complex coordinates of 256QAM symbol constellations descriptive of data bits, as selected from the delayed initial transmissions for iterative-diversity reception read from the delay memory 69.

FIG. 23 shows a selector 136 with an input port connected for receiving the response of the delay memory 69. The selector 136 is operable for selectively reproducing the complex coordinates of 256QAM symbol constellations descriptive of parity bits from the delayed initial transmissions for iterative-diversity reception. The output port of the selector 136 is connected for supplying these selectively reproduced complex coordinates to the input port of a de-mapper 137 of 256QAM symbol constellations. The de-mapper 137 de-maps a first set of PCCC parity bits, supplying them from its output port to the write-input port of the memory 74 for that first set of PCCC parity bits.

FIG. 23 shows the input port of a de-mapper 138 of 256QAM symbol constellations connected for receiving the response of the QAM combiner 133, which response supplies the complex coordinates of 256QAM symbol constellations descriptive of data bits of the PCCC. The de-mapper 138 de-maps these data bits, supplying soft data bits of the PCCC from its output port to the random-access port of the memory 76 for soft data bits and extrinsic data. The soft data bits are written into the storage locations for soft data bits within the memory 76.

FIG. 23 shows a selector 139 with an input port connected for receiving the response of the selector 67. The selector 139 is operable for selectively reproducing the complex coordinates of 256QAM symbol constellations descriptive of parity bits from the final transmissions for iterative-diversity reception. The output port of the selector 139 is connected for supplying these selectively reproduced complex coordinates to the input port of a de-mapper 140 of 256QAM symbol constellations. The de-mapper 140 de-maps a second set of PCCC parity bits, supplying them from its output port to the write-input port of the memory 77 for that second set of PCCC parity bits.

FIGS. 24 and 25 show modifications made to FIGS. 15 and 16 of the mobile DTV receiver of FIGS. 15, 16, 17 and 18 in an alternative stationary DTV receiver suited for receiving transmissions from the DTV transmitter of FIGS. 1, 2, 3 and 4 with its FIG. 4 portion modified per FIG. 21. FIG. 24 differs from FIG. 15 in that the de-mapper 166 is omitted and the response of the frequency-domain channel equalizer 165 is supplied directly to the input ports of the selectors 67 and 68. In the FIG. 24 configuration the selectors 67 and 68 selectively respond to the complex coordinates of 64QAM symbol constellations supplied from the frequency-domain channel equalizer 165, rather than to demodulated PCCC from the omitted de-mapper 166 of 64QAM symbol constellations. The delay memory 69 delays the complex coordinates of 64QAM symbol constellations from the initial transmissions that subsequently are repeated for iterative-diversity reception, as reproduced at the output port of the selector 68. The complex coordinates of 64QAM symbol constellations from the initial transmissions reproduced after delay at the output port of the delay memory 69 are concurrent with the complex coordinates of corresponding 64QAM symbol constellations from the final transmissions reproduced at the output port of the selector 67.

FIG. 24 shows a maximal-ratio QAM combiner 141 for combining the complex coordinates of 64QAM symbol constellations descriptive of data bits, as selected from the initial transmissions for iterative-diversity reception, with the complex coordinates of corresponding 64QAM symbol constellations descriptive of data bits, as selected from the final transmissions for iterative-diversity reception. The complex coordinates of 64QAM symbol constellations descriptive of data bits, as selected from the final transmissions for iterative-diversity reception, are supplied to a first of the two input ports of the QAM combiner 141 from the output port of a selector 142. The input port of the selector 142 is connected for receiving the response of the selector 67 from the output port thereof. The input port of a selector 143 is connected for receiving the delayed response of the delay memory 69 to the complex coordinates of 64QAM symbol constellations, as selected by the selector 68 from the initial transmissions for iterative-diversity reception. The output port of the selector 143 is connected for supplying the second input port of the QAM combiner 141 with complex coordinates of 64QAM symbol constellations descriptive of data bits, as selected from the delayed initial transmissions for iterative-diversity reception read from the delay memory 69.

FIG. 25 shows a selector 144 that has an input port connected for receiving the response of the delay memory 69. The selector 144 is operable for selectively reproducing the complex coordinates of 64QAM symbol constellations from the final transmissions for iterative-diversity reception, the Gray labeling of which 64QAM symbol constellations are descriptive of a first set of PCCC parity bits. The output port of the selector 144 is connected for supplying these selectively reproduced complex coordinates to the input port of a de-mapper 145 of 64QAM symbol constellations. The de-mapper 145 de-maps the first set of PCCC parity bits, supplying them from its output port to the write-input port of the memory 74 for that first set of PCCC parity bits.

FIG. 25 shows the input port of a de-mapper 146 of 64QAM symbol constellations connected for receiving the response of the QAM combiner 141, which response supplies the complex coordinates of 64QAM symbol constellations, the Gray labeling of which 64QAM symbol constellations are descriptive of data bits of the PCCC. The de-mapper 146 de-maps these data bits, supplying soft data bits of the PCCC from its output port to the random-access port of the memory 76 for soft data bits and extrinsic data. The soft data bits are written into the storage locations for soft data bits within the memory 76.

FIG. 25 shows a selector 147 that has an input port connected for receiving the response of the selector 67. The selector 147 is operable for selectively reproducing the complex coordinates of 64QAM symbol constellations from the final transmissions for iterative-diversity reception, the Gray labeling of which 64QAM symbol constellations are descriptive of a second set of PCCC parity bits. The output port of the selector 147 is connected for supplying these selectively reproduced complex coordinates to the input port of a de-mapper 148 of 64QAM symbol constellations. The de-mapper 148 de-maps the second set of PCCC parity bits, supplying them from its output port to the write-input port of the memory 77 for that second set of PCCC parity bits.

FIG. 26 shows further elements included in preferred connections to and from the memory 76 in the various turbo decoder embodiments shown in FIGS. 13, 16, 23 and 25. These further elements are operable to increase confidence levels of data bits of correct (204, 188) Reed-Solomon codewords temporarily stored within the memory 76 during the performance of turbo decoding procedures. A third address generator comprising a read-only memory 157 shown in FIG. 27, but not explicitly shown in FIG. 26, is used for addressing the memory 76 so as to de-interleave the convolutional byte interleaving of soft bits of (204, 188) Reed-Solomon codewords read from the memory 76 during a break in a normal cycle of turbo decoding procedure. The respective hard-decision bits of these soft bits of (204, 188) Reed-Solomon codewords are supplied to the input port of a decoder 149 for (204, 188) Reed-Solomon coding. The respective further bits of these soft bits expressive of confidence levels for their respective hard-decision bits are supplied to an input port of a generator 150 of high or highest confidence levels for bits of (204, 188) Reed-Solomon codewords that are correct(ed). I.e., for bits of (204, 188) RS codewords that were originally correct or that have been corrected by the decoder 149 for (204, 188) RS coding. The confidence-level generator 150 includes a temporary storage register for the confidence levels of each successive (204, 188) RS codeword.

The confidence-level generator 150 can include circuitry responsive to the confidence levels of hard-decision bits in each (204, 188) RS codeword to locate byte errors for the RS decoder 149. This allows the RS decoder 149 to use a byte-error-correction-only algorithm that can correct sixteen byte errors per (204, 188) RS codeword, rather than a byte-error-location-and-correction-only algorithm that can correct only eight byte errors per (204, 188) RS codeword. FIG. 26 shows a connection 151 for conveying byte-error-location from the confidence-level generator 150 to the RS decoder 149.

When the RS decoder 149 finds a (204, 188) RS codeword to be correct or is able to correct it, the RS decoder 149 supplies the memory 76 an over-write enable signal conditioning the memory 76 to accept over-writing of the soft data bits regarding that (204, 188) RS codeword. The soft data bits used for such over-writing are composed of hard-decision bits supplied by the RS decoder 149 and accompanying further bits indicative of the confidence levels regarding those hard-decision bits, which further bits are supplied by the confidence-level generator 150. The over-write enable signal conditions the third address generator comprising the ROM 157, used to address the memory 76 during over-writing the soft data bits regarding a (204, 188) RS codeword, so as to convolutionally interleave the bytes of the correct(ed) RS codeword.

When the RS decoder 149 finds a (204, 188) RS codeword to be correct or is able to correct it, the RS decoder 149 supplies the confidence-level generator 150 a pulse indication that this is so. The confidence-level generator 150 responds to this pulse indication to increase, if possible, the confidence levels of the bits of the correct(ed) RS codeword written back to the memory 76. This can be done, for example, by adding a specified increment to the confidence level of each soft data bit stored in the temporary storage register and replacing any confidence level higher than the maximum confidence level with the maximum confidence level.

FIG. 26 shows a counter 152, the count input port of which is connected for receiving the pulse indications the RS decoder 149 supplies responsive to finding (204, 188) RS codewords to be correct(ed). The count supplied from the count output port of the counter 152 is reset to zero at the beginning of each cycle of turbo decoding. The count output port of the counter 152 is connected for supplying the count of correct (204, 188) RS codewords per time-slice to the input port of a detector 153 of reaching the full count of correct (204, 188) RS codewords per time-slice. That is, the count of correct (204, 188) RS codewords per time-slice associated with every one of the (204, 188) RS codewords in a time-slice being correct. The value for such full count for a time-slice is specified to the detector 153 from the pilot and TPS carriers processor 64 or 164. If the full count of correct (204, 188) RS codewords per time-slice is reached at the conclusion of a cycle of turbo decoding, the detector 153 supplies a PCCC decoding control unit 158 an indication of this condition. The PCCC decoding control unit 158, shown in FIG. 27, can respond by concluding turbo decoding of the time-slice.

Variants of the confidence-level generator 150 described above simply replace the confidence levels of all the soft bits of correct(ed) RS codewords written back to the memories 76 with confidence levels of maximum or close to maximum value. The convolutional byte interleaving of a correct(ed) RS codeword written back to the memory 76 disperses the soft data bits with increased levels of confidence throughout the CC presented to the SISO decoder 78 for decoding. The convolutional byte interleaving of the correct(ed) RS codeword also disperses the soft data bits with increased levels of confidence throughout the CC presented to the SISO decoder 79 for decoding. The dispersal of data bits with high confidence levels throughout the CC presented to the SISO decoder 78 facilitates its selecting data bit sequences most likely to be correct as its decoding results. The dispersal of data bits with high confidence levels throughout the CC presented to the SISO decoder 79 facilitates its selecting data bit sequences most likely to be correct as its decoding results.

FIG. 27 depicts apparatus for addressing memories 74, 76 and 77 of any of the turbo decoders shown FIGS. 13, 16, 23 and 25, as modified per FIG. 26. The previous contents of memories 74, 76 and 77 are erased in bulk before writing PCCC of new time-slices into those memories. A clocked symbol counter 154 is reset to initial count, ordinarily arithmetic zero for an up counter, at the beginning of each address scan of the memories 74, 76 and 77. The count from the symbol counter 154 is supplied as read addressing to each of three read-only memories 155, 156 and 157.

The ROM 155, storing a first list of addresses for the memories 74, 76 and 77, functions as a first address generator. The memories 74, 76 and 77 as shown in FIG. 13 or FIG. 16 are addressed according to this first list when they are written with soft-bit responses from the soft parity bits selector 70, from the code combiner 75 and from the soft parity bits selector 73, respectively. The memories 74, 76 and 77 as shown in FIG. 23 are addressed according to this first list when they are written with soft-bit responses from the de-mapper 137, from the de-mapper 138 and from the de-mapper 140, respectively. The memories 74, 76 and 77 as shown in FIG. 25 are addressed according to this first list when they are written with soft-bit responses from the de-mapper 145, from the de-mapper 146 and from the de-mapper 148, respectively. The memories 76 and 77 are addressed according to this first list when they read soft data bits, soft extrinsic-data bits and soft parity bits of first CC to the SISO decoder 78 for decoding of first CC in the time-slices. The memory 76 is addressed according to this second list when soft extrinsic data bits are updated by the extrinsic data feedback processor 81 responsive to decoding results from the SISO decoder 78.

The ROM 156, storing a second list of addresses for the memories 76 and 77, functions as a second address generator. The memories 76 and 77 are addressed according to this second list stored in the ROM 156 when reading soft data bits, soft extrinsic-data bits and soft parity bits of second CC to the SISO decoder 79 for decoding of second CC in the time-slices. Such read addressing provides de-interleaving to counteract symbol interleaving introduced at the DTV transmitter. The memory 76 is addressed according to this second list when soft extrinsic data bits are updated by the extrinsic data feedback processor 85 responsive to decoding results from the SISO decoder 79.

The ROM 157, storing a third list of addresses for the memories 76 and 77, functions as a third address generator. The memories 76 and 77 are addressed according to this third list stored in the ROM 157 when reading (204, 188) RS codewords from the memories 76 and 77. Such read addressing provides de-interleaving to counteract the convolutional byte interleaving introduced at the DTV transmitter. The memories 76 and 77 are also addressed according to this third list stored in the ROM 157 when writing corrected (204, 188) RS codewords back into the memories 76 and 77 together with updated confidence levels regarding the hard data bits in those codewords. Such write addressing restores the convolutional byte interleaving introduced at the DTV transmitter.

An addressing selector 159 is operable for reproducing at its output port the read output response from a selected one of the ROMs 155, 156 and 157 connected for supplying their respective read output responses to respective ones of first, second and third input ports of the addressing selector 159. The PCCC decoding controller 158 is connected for supplying a dual-bit control signal to the addressing selector 159 to control selection of the appropriate one of the addressing scans read from the ROMs 155, 156 and 157.

FIG. 28 is an informal flow chart illustrating the improved method of turbo decoding employed by the turbo decoders shown in FIGS. 13, 16, 23 and 25 as modified to include the further elements shown in FIG. 26. In those turbo decoders the memories 74, 76 and 77 together are referred to as the turbo decoder memory. In an initial step 171 of the method, each set of three soft bits descriptive of a PCCC symbol are loaded into a respective one of the addressed storage locations within that turbo decoder memory.

FIG. 28 shows a next step 172 of the improved turbo decoding method, wherein the contents of the addressed storage locations within turbo decoder memory temporarily storing data bits are read using addressing that de-interleaves the convolutional byte interleaving of the (204, 188) RS codewords of the time-slice temporarily stored in turbo decoder memory. The step 172 supplies the RS decoder 149 shown in FIG. 26 with (204, 188) RS codewords of a time-slice, as transmitted only one time or as finally transmitted for iterative-diversity reception.

FIG. 28 shows a next step 173 of the improved turbo decoding method, wherein each of the (204, 188) RS codewords are decoded and byte errors are corrected insofar as possible. In the portion of the turbo decoder shown in FIG. 26, the decoder 149 for (204, 188) RS codewords performs this part of the step 173. The step 173 is a compound step in which indications are generated as to whether or not each byte of the (204, 188) RS codewords is correct at the conclusion of the step 173. In this part of the step 173, the decoder 149 generates a respective bit indicating whether or not each RS codeword it has processed will be correct at the conclusion of the step 173.

FIG. 28 shows a next step 174 of the improved turbo decoding method, wherein the bytes of (204, 188) RS codewords are re-interleaved while being written back to turbo decoding memory after decoding and possible correction. The re-interleaved bytes, together with appended indications as to whether each byte is correct supplied by the generator 150 shown in FIG. 26, update the temporarily stored contents of the turbo decoding memory in step 175 of the improved turbo decoding method.

The steps 172, 173 and 174 provide the crux of the improvement in the FIG. 28 method of turbo decoding. FIG. 28 shows these steps being carried out successively, processing consecutive (204, 188) RS codewords from each time-slice as a group, rather than individually. This facilitates understanding the general concept of what the improvement is in the turbo decoding method. However, processing the consecutive (204, 188) RS codewords of each time-slice as a group, rather than individually, requires the RS decoder 149 to have a considerable amount of memory of its own. This memory is needed to temporarily store each RS codeword as it is corrected until such time as the group of corrected RS codewords is written back to turbo decoding memory to update the contents temporarily stored therein. Preferably, the steps 172, 173 and 174 are performed sequentially for each (204, 188) RS codeword read from a turbo decoding memory. In the turbo decoding circuitry, such procedure substantially reduces the requirement for memory in the RS decoder 149 shown in FIG. 26. Such procedure moves to the memory 76 the temporary storage of (204, 188) RS codewords required after their correction insofar as possible by the RS decoder 149. The temporary storage of the (204, 188) RS codewords after processing by the RS decoder 149 updates addressed storage locations in the memory 76, without requiring additional byte storage capability.

After the steps 172, 173, 174 and 175 are carried out for all (204, 188) RS codewords from a time-slice, one cycle of PCCC decoding is performed in step 176 of the improved method of PCCC decoding shown in FIG. 28. If the cycle of PCCC decoding performed in step 176 is not the sole one nor the final iteration of a series of PCCC decoding cycles in a turbo decoding procedure, the results from this cycle of PCCC decoding provide turbo feedback for a subsequent step 177. In the step 177 the extrinsic data concerning soft data bits from decoding the outer CC that are temporarily stored in the turbo decoding memory are updated dependent on the turbo feedback provided by the immediately preceding step 176. The step 177 concludes one cycle of PCCC decoding and begins the next cycle of PCCC decoding in which the step 177 is followed by repeated steps 172, 173 and 174.

The step 176 is followed by a step 178 if the cycle of PCCC decoding performed in step 176 is the sole one or is the final iteration of a series of PCCC decoding cycles in a turbo decoding procedure. In the step 178 the soft data bits of the ultimate PCCC decoding results are forwarded to the quantizer 86 as shown in FIG. 14 or in FIG. 17.

The implied interleaving of data bits in the PCCC, the implied interleaving of (204, 188) RS coding and the avoidance of the internal interleaving used in DVB-T aid TRS decoding in regard to suppressing the effects of burst noise in the reception channel. The implied interleaving of data bits in the PCCC reduces the number of bytes that are corrupted by a burst noise sequence of any specific duration. The implied interleaving of (204, 188) RS coding and the avoidance of the internal interleaving used in DVB-H prevent bytes corrupted by burst noise being dispersed in the FEC frame. Such dispersal tends to increase the number of (255, 191) TRS codewords in an FEC frame that contain bytes corrupted by burst noise. Such dispersal may increase the number of corrupted bytes in some of the (255, 191) TRS codewords in an FEC frame. If a burst noise sequence cannot be corrected in the FEC frame, keeping its effects confined to as few rows of bytes in the FEC frame as possible reduces the number of IP data packets spoiled by the burst sequence.

FIG. 29 shows alternative turbo decoding apparatus that can replace the turbo decoding apparatus shown in any of the FIGS. 13, 16, 23 and 25. The FIG. 29 turbo decoding apparatus employs a single SISO decoder 190 together with a single extrinsic data feedback processor 200, instead of the two SISO decoders 78 and 79 together with respective extrinsic data feedback processors 81 and 85 shown in FIGS. 13, 16, 23 and 25. In the FIG. 9 turbo decoding apparatus the function of the soft-symbols de-interleaver 83 shown in FIGS. 13, 16, 23 and 25 is subsumed into the memories 74 and 76 by suitable addressing of them when selecting soft data bits and soft parity bits as input signal to the SISO decoder 190. In the FIG. 9 turbo decoding apparatus the function of the soft-bits interleaver 84 shown in FIGS. 13, 16, 23 and 25 is subsumed into the memory 76 by suitable addressing during operation of the extrinsic feedback data processor 200.

In DVB-H the number of (255, 191) outer RS codewords in the MPE-FEC frame is signaled in the service information (SI) and may take any of the values 256, 512, 768, or 1024. In a newly developed system using COFDM for DTV broadcasting in the United States of America, it would be preferable if the number of (255, 191) outer RS codewords in the MPE-FEC frame were to be multiples of 188, rather than multiples of 256. The reason is that this makes it much, much simpler to perform 2-dimensional decoding of the cross-interleaved RS coding (CIRC) in a DTV receiver. The byte-extended (204, 188) codewords of the inner RS coding that result from “soft” decoding the inner convolutional coding or other bit-wise FEC coding, when written to rows of extended-byte storage locations in a framestore memory, will then be aligned so that parity bytes of the inner RS coding are confined to columns of extended-byte storage separate from those containing the (255, 191) codewords of the outer RS coding.

FIG. 30 shows modifications that can be made to the mobile DTV receiver apparatus shown in FIG. 17 if the standard for using COFDM to broadcast DTV in the United States of America employs MPE-FEC frames of the type proposed in the foregoing paragraph. In FIG. 30 a byte-organized plural-port random-access memory 180 for 8-bit bytes of data plus respective byte extensions concerning the lack of confidence in each of those 8-bit bytes of data replaces the RAMs 105 and 107 shown in FIG. 17. The RAM 180 supports iterative decoding of 2-dimensional Reed-Solomon coding by the decoder 104 for (204, 188) RS coding and the decoder 106 for (255, 191) TRS coding. An RS and TRS decoding controller 181 controls the decoding operations both for (204, 188) LRS coding and for (255, 191) TRS coding in the FIG. 30 configuration. The extended-byte former 103 supplies 8-bit bytes of data plus respective byte extensions to the random-access port of the RAM 180 for writing into rows of extended-byte storage locations therein. The write addressing is such that each successive (204, 188) RS codeword extracted from a pair of time-slices is temporarily stored together with byte extensions of its bytes in a respective successive row of extended-byte storage locations in the RAM 180.

FIG. 30 shows in detail an arrangement of elements 182-189 that locates byte errors for the decoder 106 for (255, 191) transverse Reed-Solomon coding. Initially, the decoder 106 is operated so as to attempt to correct the TRS codeword using a byte-error-location-and-correction decoding algorithm. If a TRS codeword is initially correct or has been corrected, the extension bits appended to each of its bytes are revised to indicate that those bytes are now correct. If the TRS codeword has too many byte errors to be corrected by this algorithm, the decoder 106 then resorts to a byte-error-correction-only decoding algorithm. The extension bits accompanying each successive 8-bit byte of a TRS codeword from the RAM 180 are supplied to a comparator 182 used as a threshold detector. The extension bits indicate the likelihood that the 8-bit byte is in error, and comparator 182 compares them to an error threshold. If the likelihood that the 8-bit byte is in error exceeds the error threshold, the comparator 182 responds with a logic ONE indicative that the byte is presumably in error. Otherwise, the comparator 182 responds with a logic ZERO indicative that the byte is presumably correct.

FIG. 30 shows the sum output signal from a clocked digital adder 183 supplied to the comparator 182 as the error threshold. The value of the error threshold is initialized in the following way at the outset of each TRS codeword being read from the RAM 180. A two-input multiplexer 184 is connected to supply its response as a first of two summand signals supplied to the adder 183, the second summand signal being arithmetic one. The sum output signal from the clocked adder 183 is applied as one of two input signals to the multiplexer 184, and an initial error threshold value less one is applied as the other input signal to the multiplexer 184. Just before each TRS codeword is read from the RAM 180 a respective pulsed logic ONE is generated by the RS and TRS decoding controller 181. The pulsed logic ONE is applied as control signal to the multiplexer 184, conditioning it to reproduce the initial error threshold value less one in its response supplied to the adder 183 as a summand input signal. The clocked adder 183 receives its clock signal from an OR gate 185 connected to receive the pulsed logic ONE at one of its input connections. The response of the OR gate 185 reproduces the pulsed logic ONE, which clocks an addition by the adder 183. The adder 183 adds its summand input signal that is arithmetic one to its summand input signal that is the initial error threshold value less arithmetic one, as received from the multiplexer 184, generating the initial error threshold value as its sum output signal supplied to the comparator 182.

The pulsed logic ONE from the controller 181 also resets to arithmetic zero the output count from a byte-error counter 186 that is connected for counting the number of logic ONEs that the comparator 182 generates during each TRS codeword. This output count is applied as subtrahend input signal to a digital subtractor 187. A read-only memory 188 supplies the binary number 100 0000, equal to the number of parity bytes in the (255, 191) TRS codewords, which number is supplied as minuend input signal to the digital subtractor 187. Alternatively, the minuend input signal is simply a hard-wired binary number 100 0000. A minus-sign-bit detector 189 generates a logic ONE if and when the number of byte errors in a TRS codeword counted by the counter 186 exceeds the number of parity bytes in a TRS codeword. This logic ONE is supplied to the RS and TRS decoding controller 181 as an indication that the current TRS codeword is to be read out from the RAM 180 again. This logic ONE is supplied to the OR gate 185 as an input signal thereto. The OR gate 185 responds with a logic ONE that resets the counter 186 to zero output count and that clocks the clocked digital adder 183. Normally, the multiplexer 184 reproduces the error threshold supplied as sum output from the adder 183. This reproduced error threshold is applied to the adder 183 as a summand input signal, connecting the clocked adder 183 for clocked accumulation of arithmetic ones in addition to the previous error threshold. The logic ONE from the OR gate 185 causes the error threshold supplied as sum output from the adder 183 to be incremented by arithmetic one, which tends to reduce the number of erroneous bytes located within the TRS codeword upon its being read again from the RAM 180.

If and when the number of erroneous bytes located in the TRS codeword is fewer than the number of parity bytes that the ROM 188 indicates that the TRS codeword should have, the RS and TRS decoding controller 181 will cause the next TRS codeword in the RS Frame to be processed if such there be. The decoding controller 181 will initiate reading such next TRS codeword from the RAM 180 to the RS decoder 106 and writing the RS decoding results from the just previous RS codeword into the RAM 180

If the turbo decoder as shown in FIG. 16 or in FIG. 25 does not include a component decoder for (204, 188) RS coding per FIG. 26, extended-byte storage locations in the RAM 180 are read one row at a time from a serial-output port to the decoder 104 for (204, 188) RS coding before an initial step of the TRS decoder 106 decoding all the (255, 191) TRS codewords in an FEC frame. If the turbo decoder shown in FIG. 16 or FIG. 25 is modified per FIG. 26 to include a component decoder for (204, 188) RS coding), the step of decoding of (204, 188) RS codewords by the RS decoder 104 is omitted before an initial step of the TRS decoder 106 decoding all the (255, 191) TRS codewords in an FEC frame. If a step of the TRS decoder 106 decoding all the (255, 191) TRS codewords in an FEC frame does not result in all the byte errors in an FEC frame being corrected, the extended-byte storage locations in the RAM 180 can be read one row at a time to the decoder 104 for (204, 188) RS coding. If the time available for iterative decoding of the 2-dimensional RS coding runs out, such further decoding by the RS decoder 104 will not occur. The time required for iterative decoding by the RS decoder 104 and the TRS decoder 106 can be shortened by decoding only those (204, 188) RS codewords and those (255, 191) TRS codewords not yet corrected. Accordingly, the RS and TRS decoding controller 181 preferably includes a respective register associated therewith for keeping account of which of the codewords each of the decoders 104 and 106 is called upon to decode is found to be correct.

When extended-byte storage locations in the RAM 180 are read one row at a time to the decoder 104 for (204, 188) RS coding, the threshold detector in the RS decoder 104 responds to the respective byte extensions concerning the lack of confidence in each of the 8-bit bytes of data for determining the locations of byte errors in each (204, 188) RS codeword. The RS decoder 104 is provided capability for adjusting the extension of each byte in a 204-byte RS codeword that it can correct, which RS codeword includes a respective 188-byte IPE packet. If the RS decoder 104 was capable of correcting the RS codeword, the byte extensions of its bytes are reduced in value, possibly to zero value. The 204 bytes of the corrected RS codeword and its adjusted byte-extensions are supplied to the random-access port of the RAM 180 as decoding results for updating the contents of the row of extended-byte storage locations in the RAM 180 used for temporarily storing those bytes and their extensions. If the RS decoder 104 was incapable of correcting the RS codeword, updating the contents of the row of extended-byte storage locations in the RAM 180 used for temporarily storing its bytes and their extensions can be skipped. If that row of extended-byte storage locations in the RAM 180 is updated, however, the byte extensions retain the values they had upon entry into the RS decoder 104.

The extended-byte storage locations in the RAM 180 are read one column at a time from a serial-output port to supply 8-bit data bytes to the TRS decoder 106 during each step of decoding all the (255, 191) TRS codewords in an FEC frame. Before the time allotted for decoding the FEC frame expires, the RS and TRS decoding controller 181 register that keeps account of which of the (255, 191) TRS codewords in an FEC frame are found to be correct can fill with indications that all of them have been found to be correct. A decoder composed of a tree of AND gates can detect this condition, presuming the register is written with ONEs representative of correct (255, 191) TRS codewords. If such condition obtains, iterative 2-dimensional decoding of the FEC frame is discontinued until the next FEC frame is to be decoded. If some of the (255, 191) TRS codewords in an FEC frame remain in error and there is still enough allotted time left for further decoding of the FEC frame, the RS decoder 104 begins the next step in the iterative 2-dimensional decoding procedure.

FIG. 30 shows an optional decoder 190 for the CRC coding of IP packets temporarily stored in the byte-organized RAM 180, the operation of which will be described further on in this specification. FIG. 31 is an informal flow chart illustrating a method of operating the FIG. 30 configuration, considered generally, if the optional decoder 190 for CRC coding of IP packets is omitted from the FIG. 30 configuration or at least is not used in the method that FIG. 31 illustrates. In a first step 191 the byte-organized random-access memory 180 is written by data bytes supplied from the extended-byte former 103 with respective byte extensions indicative of the lack of confidence in those data bytes being correct. The RAM 180 is addressed during this writing such that the extended bytes of (204, 188) RS codewords are temporarily stored in respective rows of storage locations within the RAM 180. If the convolutional byte interleaving of the (204, 188) RS codewords was de-interleaved during their being read from memory in the turbo decoding apparatus, the storage locations in the RAM 180 are addressed by row during their being written to from the extended-byte former 103. Alternatively, the (204, 188) RS codewords supplied from the extended-byte former 103 may retain convolutional byte interleaving, not having been de-interleaved when read from memory in the turbo decoding apparatus. In such case, the storage locations in the RAM 180 are addressed for de-interleaving the (204, 188) RS codewords when writing their bytes together with extensions thereof to respective rows of storage locations in the RAM 180.

In a second step 192 of the method of operating the FIG. 30 configuration, steps 193-195 are skipped to go directly to step 196 if the turbo decoder shown in FIG. 16 or FIG. 25 is modified per FIG. 26 to include decoding of (204, 188) RS codewords. For example, the inclusion of the decoding of RS codewords in an iterative decoder of SCCC is described in U.S. patent application Ser. No. 12/931,688 filed by A. L. R. Limberg on 8 Feb. 2011 with the title “Utilization of non-systematic (207, 187) Reed-Solomon coding in mobile/handheld digital television receivers”. If iterative decoding in the turbo decoder as shown in FIG. 16 or in FIG. 25 is not modified to include decoding of (204, 188) RS codewords, the method of operating the FIG. 30 configuration proceeds to the step 193 thereof.

In the step 193 extended bytes of the (204, 188) RS codewords are read from rows of storage locations in the memory 180 to the decoder 104 for (204, 188) RS codewords. In a subsequent step 194 the decoder 104 corrects the (204, 188) RS codewords, if it can, and updates the byte extensions of the bytes in corrected (204, 188) RS codewords to indicate confidence in their being correct. Since the byte extensions indicate levels of lack of confidence in associated bytes, these levels are reduced possibly to zero value for bytes in corrected (204, 188) RS codewords. In a subsequent step 195 bytes of corrected (204, 188) RS codewords together with their adjusted byte extensions are written back to update respective rows of storage locations in the memory 180. The method of operating the FIG. 30 configuration then proceeds to its step 196 following the step 195.

In the step 196 extended bytes of the (255, 191) TRS codewords are read from columns of storage locations in the memory 180 to the decoder 106 for (255, 191) TRS codewords. In a subsequent step 197 the decoder 106 corrects the (255, 191) TRS codewords, if it can, and updates the byte extensions of the bytes in corrected (255, 191) TRS codewords to indicate confidence in their being corrected. Since the byte extensions indicate levels of lack of confidence in associated bytes, these levels are reduced possibly to zero value for bytes in corrected (255, 191) TRS codewords. In a subsequent step 198 bytes of corrected (255, 191) TRS codewords together with their adjusted byte extensions are written back to update respective columns of storage locations in the memory 180. The method of operating the FIG. 30 configuration then proceeds to its step 199 following the step 198.

In the step 199 IPE packets are read from 188-byte portions of the rows of storage locations in the memory 180 to the data de-randomizer 108 when the decoding of the two-dimensional Reed-Solomon coding of an FEC frame has concluded. Otherwise, if correcting more byte errors in the FEC frame is attempted, operation loops back from the step 199 to the step 193 of the method of operating the FIG. 31 configuration and continues therefrom.

Referring back to FIG. 30, the operation of the configuration depicted therein is next described, presuming that the decoder 190 for the CRC coding of IP packets temporarily stored in the byte-organized RAM 180 is included and is used in the DTV receiver. Before the decoding of the (255, 191) codewords of TRS coding in an FEC frame begins the extended bytes of temporarily stored IP packets in the FEC frame are read from the RAM 180 to the input port of the decoder 190. The decoder 190 updates the byte extensions of bytes of IP packets that it finds to be correct, lowering their lack-of-confidence levels in some degree if they are not already low, and over-writes the extended bytes of IP packets temporarily stored in the RAM 180. Since (204, 288) RS coding is stronger than the CRC coding of IP packets, there is some preference for procedure being done after the byte extensions of bytes of (204, 288) RS codewords temporarily stored in the RAM 180 have already been updated by the decoder 104 for (204, 288) RS coding. If the decoding of the (255, 191) codewords of TRS coding in an FEC frame is repeated, the repeat of that decoding is preceded by the decoders 93 and 158 operating to update the byte extensions of bytes of temporarily stored in the RAM 180.

DTV receivers for DVB-H signals have decoded the CRC coding of IP packets recovered from the decoding of (204, 188) LRS codewords to generate indications of which IP packets contain error. These indications of error have then been used to implement subsequent erasure decoding of the (255, 191) TRS codewords, in the attempt to correct those IP packets that decoding CRC coding found to contain error. The problem with this previously known technique is that only as few as a single erroneous bit in an IP packet many bytes in length causes erasure of all the bits from that IP packet, which is apt to affect a large percentage if not all the (255, 191) TRS codewords in an FEC frame. Error location is less precise than using error indications from the decoding of (204, 188) LRS codewords, since IP packets are generally contain many more bits than the 188-byte segments resulting from the decoding of (204, 188) LRS codewords. The results of error location from the CRC coding of IP packets can be logic-ORed with results of error location from the decoding of (204, 188) LRS codewords to refine error location to a degree. However, error location is still apt to be much, much less precise than locating byte errors based on the confidence levels of soft bits of turbo decoding results.

The method of operating the FIG. 30 configuration illustrated in FIG. 31 utilizes the LRS decoder 104 finding 188-byte segments to be correct or corrected to update the lack-of-confidence levels of the bytes of those 188-byte segments as temporarily stored in the RAM 180 to indicate greater confidence that those bytes are correct. This does not reduce the precision of locating byte errors based on the confidence levels of soft bits of turbo decoding results, but rather tends to locate byte errors still more precisely by reducing the number of bytes in which errors may be found. Decoding results from the decoder 190 for the CRC coding of IP packets are utilized similarly. Some bytes that would not have their lack-of-confidence levels updated by the LRS decoder 104 may have their lack-of-confidence confidence levels updated by the decoder 190 for CRC coding. Still more sophisticated receiver designs may update the lack-of-confidence levels of bytes stored in the RAM 180 taking into account whether the decoders 104 and 190 concur that the bytes are correct.

The iterative techniques described supra for 2-dimensional decoding of the cross-interleaved RS coding (CIRC) in a DTV receiver are adapted to accommodate the number of (255, 191) codewords in the MPE-FEC frame being multiples of 256, rather than multiples of 188 as would be preferable, in alternative embodiments of this aspect of the invention. However, memory structures to support these operations are not as simple, and many of these alternative memory structures require more storage locations for extended bytes than the memory 180 depicted in FIG. 29. These alternative memory structures include a memory for supporting operations associated with the iterative decoding of TRS coding by the TRS decoder 106 and elements 181-189, which memory differs from memory 180 in not having columns of byte storage locations for the extended bytes of parity for (204, 188) LRS coding. This memory differs also in that it does not interchange information directly with the LRS decoder 104, but rather interchanges information with further memory supporting operations associated with the iterative decoding of LRS coding by the LRS decoder 104. This further memory can be arranged for temporarily storing all the (204, 188) LRS codewords in a time-slice, by way of example. Such further memory is interposed between the extended-byte former 103 and the memory for supporting operations associated with the iterative decoding of TRS coding, with the output port of the extended-byte former 103 connecting to a random-access write-input port of this further memory, and with a read-output port of this further memory connected to a random-access write-input port of the memory for supporting operations associated with the iterative decoding of TRS coding. The LRS decoder 104 is then connected for receiving (204, 188) LRS codewords with accompanying byte extensions from the read-output port of such further memory and for supplying corrected (204, 188) LRS codewords with appropriately adjusted byte extensions to over-write the storage locations of such further memory previously storing the extended bytes of those (204, 188) LRS codewords. Reduction of the total number of storage locations in the memory structure is possible using complicated write-addressing and read-addressing generators, as will be apparent to one skilled in the art of memory utilization within digital electronics.

FIGS. 2 and 20 show bits from even time-slices being de-interleaved before CC encoding; but bits from odd-time-slices are not de-interleaved before CC encoding. Variants of the portions of transmitter apparatuses shown in FIGS. 2 and 20 switch positions of the selectors 10 and 11, so bits from odd-time-slices are de-interleaved before CC encoding, but bits from even time-slices are not. A variant of the FIG. 19 receiver apparatus switches positions of the selectors 67 and 68 to accommodate the positions of the selectors 10 and 11 being switched in the variant of FIG. 2. A variant of the FIG. 22 receiver apparatus switches positions of the selectors 67 and 68 to accommodate the positions of the selectors 10 and 11 being switched in the variant of FIG. 20.

FIGS. 4 and 21 show bits from even time-slices being de-interleaved before CC encoding; but bits from odd-time-slices are not de-interleaved before CC encoding. Variants of the transmitter apparatuses shown in FIGS. 4 and 21 switch positions of the selectors 41 and 42, so bits from odd-time-slices are de-interleaved before CC encoding, but bits from even time-slices are not. A variant of the FIG. 15 receiver apparatus switches positions of the selectors 67 and 68 to accommodate the positions of the selectors 41 and 42 being switched in the variant of FIG. 4. A variant of the FIG. 24 receiver apparatus switches positions of the selectors 67 and 68 to accommodate the positions of the selectors 41 and 42 being switched in the FIG. 21 variant of FIG. 21.

The operations of the turbo decoders in FIGS. 13, 16, 23 and 25 are described supra with the CC that does not employ coded interleaving being decoded in the initial half of each turbo decoding cycle and the CC that employs coded interleaving being decoded in the final half of each turbo decoding cycle. Variants of such operation are possible in which the CC that employs coded interleaving is decoded in the initial half of each turbo decoding cycle and the CC that does not employ coded interleaving is decoded in the final half of each turbo decoding cycle.

The SISO decoders 78 and 79 shown in FIGS. 13, 16, 23 and 25 perform their decoding procedures in different halves of the turbo decoding cycle. Accordingly, receiver apparatus can use the same physical structural elements for the SISO decoder 79 and the extrinsic-data feedback processor 85 as used for the SISO decoder 78 and the extrinsic-data feedback processor 81. This is facilitated by subsuming the functions of the soft symbols de-interleaver 83 and the soft bits interleaver 84 into the addressing of the memories 74 and 76. Such receiver apparatuses are to be considered equivalents of ones shown in the drawing.

In the embodiments of the invention as described supra in detail, the parallel concatenated coding is PCCC composed of two convolutional coding (CC) components. Embodiments of the invention that employ parallel concatenated low-density parity-check (PCLDPC) coding are described in detail infra with reference to FIGS. 32-42.

FIG. 32 combines with FIG. 1 to provide a schematic diagram of a portion of a COFDM transmitter for a DTV system, which transmitter is capable of transmitting pairs of one-half-code-rate LDPC-coded signals designed for iterative-diversity reception by stationary DTV receivers. The FIG. 32 transmitter apparatus differs from the FIG. 2 transmitter apparatus in the following respects. The cascade connection of the bits de-interleaver 12, the CC encoder 13 and the symbols interleaver 14 is replaced by an encoder 201 for first one-half-rate low-density parity-check (LDPC) coding. The cascade connection of the delay memory 16 and the CC encoder 17 are replaced by an encoder 202 for second one-half-rate low-density parity-check (LDPC) coding. The first and second LDPC codes use different H matrices, avoiding the need for a bits de-interleaver and a symbols interleaver. Since the bits de-interleaver 12 and the symbols interleaver 14 are omitted, the delay memory 16 is no longer needed either.

More particularly, the bit-serial, convolutionally byte-interleaved (204, 188) Reed-Solomon codewords of even-numbered time-slices supplied from the output port of the selector 10 are supplied to the input port of the encoder 201 for first LDPC coding. The output port of the encoder 201 is connected for supplying the one-half-rate first LDPC coding to the first input port of the time-division multiplexer 15 for even and odd coded time-slices. The bit-serial, convolutionally byte-interleaved (204, 188) Reed-Solomon codewords of odd-numbered time-slices are supplied from the output port of the selector 11 to the input port of the encoder 202 for second LDPC coding. The output port of the encoder 202 is connected for supplying the one-half-rate second LDPC coding to the second input port of the time-division multiplexer 15 for even and odd coded time-slices.

FIG. 33 combines with FIG. 3 to provide a schematic diagram of a portion of a COFDM transmitter for a DTV system, which transmitter is capable of transmitting pairs of one-half-code-rate LDPC-coded signals designed for iterative-diversity reception by mobile DTV receivers. The FIG. 33 transmitter apparatus differs from the FIG. 4 transmitter apparatus in the following respects. The cascade connection of the bits de-interleaver 44, the CC encoder 45 and the symbols interleaver 46 is replaced by an encoder 203 for third one-half-rate low-density parity-check (LDPC) coding. The cascade connection of delay memory 48 and the CC encoder 49 is replaced by an encoder 204 for fourth one-half-rate low-density parity-check (LDPC) coding. The third and fourth LDPC codes use different H matrices, avoiding the need for the bits de-interleaver 44, the symbols interleaver 46 and the delay memory 49.

More particularly, the bit-serial, convolutionally byte-interleaved (204, 188) Reed-Solomon codewords of even-numbered time-slices supplied from the output port of the selector 42 are supplied to the input port of the encoder 203 for third LDPC coding. The output port of the encoder 203 is connected for supplying the one-half-rate third LDPC coding to the first input port of the time-division multiplexer 47 for even and odd coded-time-slices. The bit-serial, convolutionally byte-interleaved (204, 188) Reed-Solomon codewords of odd-numbered time-slices are supplied from the output port of the selector 43 to the input port of the encoder 204 for fourth LDPC coding. The output port of the encoder 204 is connected for supplying the one-half-rate fourth LDPC coding to the second input port of the time-division multiplexer 47 for even and odd coded-time-slices.

FIGS. 12, 34 and 14 combine to provide a generic schematic diagram of a stationary DTV receiver adapted for iterative-diversity reception of COFDM signals as transmitted by the portions of the DTV transmitter depicted in FIGS. 1 and 32, which DTV receiver is novel and embodies aspects of the invention. The FIG. 34 receiver apparatus differs from the FIG. 13 receiver apparatus in the following respects. A soft-input/soft-output decoder 205 for the first LDPC coding replaces the SISO decoder 78 for CC, and a soft-input/soft-output decoder 206 for the second LDPC coding replaces the SISO decoder 79 for CC. The soft symbols selector 80 of FIG. 13 is replaced in FIG. 34 by a selector 207 connected for supplying soft bits of the first LDPC coding to the SISO decoder 205. The extrinsic data feedback processor 81 of FIG. 13 is replaced in FIG. 34 by an extrinsic data feedback processor 208 interconnecting the SISO decoder 205 with the memory 76 for soft data bits and extrinsic data. The soft symbols selector 82 of FIG. 13 is replaced in FIG. 34 by a selector 209 connected for supplying soft bits of the second LDPC coding to the SISO decoder 206, omitting the soft symbols de-interleaver 83. The extrinsic data feedback processor 81 of FIG. 13 is replaced in FIG. 34 by an extrinsic data feedback processor 210 interconnecting the SISO decoder 206 with the memory 76 for soft data bits and extrinsic data. The soft bits interleaver 84 is omitted in FIG. 34.

The operation of the FIG. 12 portion of the stationary DTV receiver shown in FIGS. 12, 34 and 14 differs somewhat from the FIG. 12 portion of the stationary DTV receiver shown in FIGS. 12, 13 and 14. The de-mapper 66 for 256 QAM symbol constellations supplies LDPC coding to the input port of the selector 67 for reproducing at its output port the second LDPC coding of just those transmissions that are not repeated and the final ones of those transmissions that are repeated for iterative-diversity reception. The de-mapper 66 also supplies LDPC coding to the input port of the selector 68 for reproducing at its output port the first LDPC coding of just the initial ones of those transmissions subsequently repeated for iterative-diversity reception. The delay memory 69 delays the first LDPC coding of the initial transmissions data bits of which are subsequently repeated for iterative-diversity reception, such that the first LDPC coding of the initial transmissions is supplied from the output port of the delay memory 69 concurrently with the corresponding second LDPC coding of final transmissions supplied from the output port of the selector 67.

FIG. 34 shows the selector 70 connected for selectively reproducing at its output port just the soft parity bits from the first LDPC coding supplied to its input port from the output port of the delay memory 69. The output port of the soft-parity-bits selector 70 is connected to supply these selectively reproduced soft parity bits as write input signal to the memory 74 for temporarily storing the soft parity bits of the second LDPC coding for each successive even-numbered time-slice.

FIG. 34 shows the selector 71 connected for selectively reproducing at its output port just the soft data bits from the first LDPC coding supplied to its input port from the output port of the delay memory. FIG. 34 shows the selector 72 connected for selectively reproducing at its output port just the soft data bits 69 from the second LDPC coding supplied to its input port from the output port of the selector 67. The maximal-ratio code combiner 75 is connected for receiving at a first of its two input ports the soft data bits selectively reproduced at the output port of the soft-data-bits selector 71. The second input port of the maximal-ratio code combiner 75 is connected for receiving the soft data bits selectively reproduced at the output port of the soft-data-bits selector 72. The output port of the maximal-ratio code combiner 75 is connected for supplying best soft estimates of the data bits of both the first LDPC coding and the second LDPC coding. These best soft estimates are supplied as write input signal to the memory 76, which temporarily stores those soft data bits.

The memory 76 also temporarily stores soft extrinsic data bits determined during the subsequent iterative LDPC decoding procedure. Soft data bits are read from the memory 76 without being combined with corresponding soft extrinsic data bits during the initial half cycle of an iterative decoding procedure for LDPC coding. Thereafter, when soft data bits are read from the memory 76 during subsequent half cycles of the iterative decoding procedure for LDPC coding, the soft data bits have respectively corresponding soft extrinsic data bits additively combined therewith. The soft extrinsic data bits temporarily stored in the memory 76 are updated responsive to the results of decoding LDPC coding each half cycle of the iterative decoding procedure.

FIG. 34 shows the selector 73 connected for selectively reproducing at its output port just the soft parity bits from the second LDPC coding supplied to its input port from the output port of the selector 67. The output port of the soft-parity-bits selector 73 is connected to supply these selectively reproduced soft parity bits as write input signal to the memory 77 for temporarily storing the soft parity bits of the second LDPC coding for each successive odd-numbered time-slice.

The first LDPC coding and the second LDPC coding are iteratively decoded using soft-input/soft-output decoders 205 and 206, which preferably employ the sliding-window log-MAP algorithm. During the initial half of each cycle of iterative decoding, the SISO decoder 205 decodes second LDPC coding that includes soft parity bits from an odd-numbered time-slice of the service being received. During the final half of each cycle of iterative decoding, the SISO decoder 206 decodes first LDPC coding that includes soft parity bits from an even-numbered time-slice of the service being received. The soft data bits that the SISO decoders 205 and 206 supply from their respective output ports as respective decoding results are compared to combined soft data bits and soft extrinsic data bits read from the memory 76. This is done to generate updated soft extrinsic data bits to be written back to the memory 76. At the conclusion of iterative decoding, combined soft data bits and soft extrinsic data bits are read from the memory 76 to supply an ultimate iterative decoding result to the input port of a quantizer 86 shown in FIG. 14. The read addressing for the memory 76 during reading an ultimate iterative decoding result therefrom is such as to counteract the convolutional byte interleaving introduced at the DTV transmitter by the FIG. 1 convolutional byte interleaver 4.

The selector 207 supplies soft data bits and soft parity bits from first and second output ports thereof, respectively, to first and second input ports of the SISO decoder 205 during the initial half of each cycle of iterative decoding. The selector 207 relays soft data bits additively combined with soft extrinsic data bits, if any, as read to a first input port thereof from the memory 76, thus to generate the soft data bits supplied to the first input port of the SISO decoder 205. The selector 207 reproduces the soft parity bits read to a second input port thereof from the memory 77, thus generating the soft parity bits supplied to the second input port of the SISO decoder 205. In actual practice, the selector 207 will usually be incorporated into the structures of the memories 76 and 77.

The soft data bits supplied from the output port of the SISO decoder 205 as decoding results during the initial half of each cycle of iterative decoding of LDPC coding are supplied to a first of two input ports of the extrinsic-data-feedback processor 208. The processor 208 differentially combines soft data bits read from the memory 76 with corresponding soft data bits of the SISO decoder 205 decoding results to generate extrinsic data feedback written into the memory 76 to update the soft extrinsic data bits temporarily stored therein.

The selector 209 supplies soft data bits and soft parity bits from first and second output ports thereof, respectively, to first and second input ports of the SISO decoder 206 during the final half of each cycle of iterative decoding. The selector 209 relays soft data bits additively combined with soft extrinsic data bits, if any, as read to a first input port thereof from the memory 76, thus to generate the soft data bits supplied to the first input port of the SISO decoder 206. The selector 209 reproduces the soft parity bits read to a second input port thereof from the memory 77, thus to generate the soft parity bits supplied to the second input port of the SISO decoder 206. In actual practice, the selector 209 will usually be incorporated into the structures of the memories 76 and 77.

The soft data bits supplied from the output port of the SISO decoder 206 as decoding results during the final half of each cycle of iterative decoding of LDPC coding are supplied to a first of two input ports of the extrinsic data feedback processor 210. The processor 210 differentially combines soft data bits read from the memory 76 with corresponding soft data bits of the SISO decoder 206 response to generate extrinsic data feedback written into the memory 76 to update the soft extrinsic data bits temporarily stored therein.

After the last half cycle of the iterative decoding procedure for LDPC coding, soft data bits as additively combined with respectively corresponding soft extrinsic data bits are read from the memory 76 to the input port of the quantizer 86 depicted in FIG. 14. Preferably, the read addressing of the memory 76 is such as to counteract the convolutional byte interleaving of time-slices introduced by the convolutional byte interleaver 4 in the portion of the DTV transmitter depicted in FIG. 1. This avoids the need for a separate byte de-interleaver to restore RS codewords to their original byte order.

FIGS. 15, 35, 17 and 18 combine to provide a generic schematic diagram of a mobile DTV receiver adapted for iterative-diversity reception of COFDM signals as transmitted by the portions of the DTV transmitter depicted in FIGS. 3 and 33, which DTV receiver is novel and embodies aspects of the invention. The FIG. 35 receiver apparatus differs from the FIG. 16 receiver apparatus in the following respects. A soft-input/soft-output decoder 211 for the fourth LDPC coding replaces the SISO decoder 78 for CC, and a soft-input/soft-output decoder 212 for the third LDPC coding replaces the SISO decoder 79 for CC. The soft symbols selector 80 of FIG. 16 is replaced in FIG. 35 by a selector 213 connected for supplying soft bits of the fourth LDPC coding to the SISO decoder 205. The extrinsic data feedback processor 81 of FIG. 16 is replaced in FIG. 35 by an extrinsic data feedback processor 214 interconnecting the SISO decoder 211 with the memory 76 for soft data bits and extrinsic data. The soft symbols selector 82 of FIG. 16 is replaced in FIG. 35 by a selector 215 connected for supplying soft bits of the third LDPC coding to the SISO decoder 212, omitting the soft symbols de-interleaver 83. The extrinsic data feedback processor 81 of FIG. 16 is replaced in FIG. 35 by an extrinsic data feedback processor 216 interconnecting the SISO decoder 212 with the memory 76 for soft data bits and extrinsic data. The soft bits interleaver 84 is omitted in FIG. 35.

The operation of the FIG. 15 portion of the mobile DTV receiver shown in FIGS. 15, 35, 17 and 18 differs somewhat from the FIG. 12 portion of the mobile DTV receiver shown in FIGS. 15, 16, 17 and 18. The de-mapper 166 of 64QAM symbol constellations supplies LDPC coding to the input port of the selector 67 for reproducing at its output port the fourth LDPC coding of just those transmissions that are not repeated and the final ones of those transmissions that are repeated for iterative-diversity reception. The de-mapper 166 also supplies LDPC coding to the input port of the selector 68 for reproducing at its output port the third LDPC coding of just the initial ones of those transmissions subsequently repeated for iterative-diversity reception. The delay memory 69 delays the third LDPC coding of the initial transmissions data bits of which are subsequently repeated for iterative-diversity reception, such that the third LDPC coding of the initial transmissions is supplied from the output port of the delay memory 69 concurrently with the corresponding fourth LDPC coding of final transmissions supplied from the output port of the selector 67.

FIG. 35 shows the selector 70 connected for selectively reproducing at its output port just the soft parity bits from the third LDPC coding supplied to its input port from the output port of the delay memory 69. The output port of the soft-parity-bits selector 70 is connected to supply these selectively reproduced soft parity bits as write input signal to the memory 74 for temporarily storing the soft parity bits of the third LDPC coding for each successive even-numbered time-slice.

FIG. 35 shows the selector 71 connected for selectively reproducing at its output port just the soft data bits from the third LDPC coding read to its input port from the delay memory 69. FIG. 35 shows the selector 72 connected for selectively reproducing at its output port just the soft data bits from the fourth LDPC coding supplied to its input port from the output port of the selector 67. The maximal-ratio code combiner 75 is connected for receiving at a first of its two input ports the soft data bits selectively reproduced at the output port of the soft-data-bits selector 71. The second input port of the maximal-ratio code combiner 75 is connected for receiving the soft data bits selectively reproduced at the output port of the soft-data-bits selector 72. The output port of the maximal-ratio code combiner 75 is connected for supplying best soft estimates of the data bits of both the third LDPC coding and the fourth LDPC coding. These best soft estimates are supplied as write input signal to the memory 76, which temporarily stores those soft data bits.

The memory 76 also temporarily stores soft extrinsic data bits determined during the subsequent iterative LDPC decoding procedure. Soft data bits are read from the memory 76 without being combined with corresponding soft extrinsic data bits during the initial half cycle of an iterative decoding procedure for LDPC coding. Thereafter, when soft data bits are read from the memory 76 during subsequent half cycles of the iterative decoding procedure for LDPC coding, the soft data bits have respectively corresponding soft extrinsic data bits additively combined therewith. The soft extrinsic data bits temporarily stored in the memory 76 are updated responsive to the results of decoding LDPC coding each half cycle of the iterative decoding procedure.

FIG. 35 shows the selector 73 connected for selectively reproducing at its output port just the soft parity bits from the fourth LDPC coding selected to its input port by the selector 67. The output port of the soft-parity-bits selector 73 is connected to supply these selectively reproduced soft parity bits as write input signal to the memory 77 for temporarily storing the soft parity bits of the third LDPC coding for each successive odd-numbered time-slice.

The third LDPC coding and the fourth LDPC coding are iteratively decoded using soft-input/soft-output decoders 211 and 212, which preferably employ the sliding-window log-MAP algorithm. During the initial half of each cycle of iterative decoding, the SISO decoder 211 decodes fourth LDPC coding that includes soft parity bits from an odd-numbered time-slice of the service being received. During the final half of each cycle of iterative decoding, the SISO decoder 212 decodes third LDPC coding that includes soft parity bits from a delayed even-numbered time-slice of the service being received. The soft data bits that the SISO decoders 211 and 212 supply from their respective output ports as respective decoding results are compared to combined soft data bits and soft extrinsic data bits read from the memory 76. This is done to generate updated soft extrinsic data bits to be written back to the memory 76. At the conclusion of iterative decoding, combined soft data bits and soft extrinsic data bits are read from the memory 76 to supply an ultimate iterative decoding result to the input port of a quantizer 86 shown in FIG. 17. The read addressing for the memory 76 during reading an ultimate iterative decoding result therefrom is such as to counteract the convolutional byte interleaving introduced at the DTV transmitter by the FIG. 3 convolutional byte interleaver 36.

The selector 213 supplies soft data bits and soft parity bits from first and second output ports thereof, respectively, to first and second input ports of the SISO decoder 211 during the initial half of each cycle of iterative decoding. The selector 213 relays soft data bits additively combined with soft extrinsic data bits, if any, as read to a first input port thereof from the memory 76, thus to generate the soft data bits supplied to the first input port of the SISO decoder 211. The selector 213 reproduces the soft parity bits read to a second input port thereof from the memory 77, thus generating the soft parity bits supplied to the second input port of the SISO decoder 211. In actual practice, the selector 213 will usually be incorporated into the structures of the memories 76 and 77.

The soft data bits supplied from the output port of the SISO decoder 211 as decoding results during the initial half of each cycle of iterative decoding of LDPC coding are supplied to a first of two input ports of the extrinsic-data-feedback processor 214. The processor 214 differentially combines soft data bits read from the memory 76 with corresponding soft data bits of the SISO decoder 211 decoding results to generate extrinsic data feedback written into the memory 76 to update the soft extrinsic data bits temporarily stored therein.

The selector 215 supplies soft data bits and soft parity bits from first and second output ports thereof, respectively, to first and second input ports of the SISO decoder 212 during the final half of each cycle of iterative decoding. The selector 215 relays soft data bits additively combined with soft extrinsic data bits, if any, as read to a first input port thereof from the memory 76, thus to generate the soft data bits supplied to the first input port of the SISO decoder 212. The selector 215 reproduces the soft parity bits read to a second input port thereof from the memory 77, thus to generate the soft parity bits supplied to the second input port of the SISO decoder 212. In actual practice, the selector 215 will usually be incorporated into the structures of the memories 76 and 77.

The soft data bits supplied from the output port of the SISO decoder 212 as decoding results during the final half of each cycle of iterative decoding of LDPC coding are supplied to a first of two input ports of the extrinsic data feedback processor 216. The processor 216 differentially combines soft data bits read from the memory 76 with corresponding soft data bits of the SISO decoder 212 response to generate extrinsic data feedback written into the memory 76 to update the soft extrinsic data bits temporarily stored therein.

After the last half cycle of the iterative decoding procedure for LDPC coding, soft data bits as additively combined with respectively corresponding soft extrinsic data bits are read from the memory 76 to the input port of the quantizer 86 depicted in FIG. 14. Preferably, the read addressing of the memory 76 is such as to counteract the convolutional byte interleaving of time-slices introduced by the convolutional byte interleaver 36 in the portion of the DTV transmitter depicted in FIG. 3. This avoids the need for a separate byte de-interleaver to restore RS codewords to their original byte order.

FIG. 36 shows a modification of the FIG. 2 portion of the COFDM transmitter for a DTV system, which modification employs an encoder 217 for one-half-rate LDPC coding of even time-slices and a similar encoder 218 for one-half-rate LDPC coding of odd time-slices. That is, both the encoders 217 and 218 employ similar H matrices for LDPC coding. However, data bits are supplied in different order to the two encoders 217 and 218, so as to generate respective LDPC coding sequences that differ from each other.

The bit-serial, convolutionally byte-interleaved (204, 188) Reed-Solomon codewords of even-numbered time-slices are supplied from the output port of the selector 10 to the input port of a permuter 219. The permuter 219 changes the order of data bits supplied from its output port to the input port of the encoder 217 from the order of data bits supplied to its input port from the output port of the selector 10. The output port of the encoder 217 is connected for supplying one-half-rate LDPC coding to the input port of a further permuter 220. The permuter 220 changes the order of data bits and parity bits supplied from its output port to the first input port of the time-division multiplexer 15 from the order of data bits and parity bits supplied to its input port from the output port of the encoder 217. The permuter 220 restores in its response the order of data bits supplied from the output port of the selector 10.

The bit-serial, convolutionally byte-interleaved (204, 188) Reed-Solomon codewords of odd-numbered time-slices are supplied from the output port of the selector 11 to the input port of a delay memory 221, the output port of which is connected to the input port of the encoder 218 for one-half-rate LDPC coding. The output port of the encoder 218 is connected for supplying one-half-rate LDPC coding to the second input port of the time-division multiplexer 15. The delay memory 218 provides delay that compensates for the latent delays in the permuters 219 and 220. So, the coded odd-numbered time-slices that the encoder 218 supplies to the second input port of the time-division multiplexer 15 interleave in time with the even coded-time-slices that the permuter 220 supplies to the first input port of the time-division multiplexer 15.

FIG. 37 shows a modification of the FIG. 4 portion of the COFDM transmitter for a DTV system, which modification employs an encoder 222 for one-half-rate LDPC coding of even time-slices and a similar encoder 223 for one-half-rate LDPC coding of odd time-slices. That is, both the encoders 222 and 223 employ similar H matrices for LDPC coding. However, data bits are supplied in different order to the two encoders 222 and 223, so as to generate respective LDPC coding sequences that differ from each other.

The bit-serial, convolutionally byte-interleaved (204, 188) Reed-Solomon codewords of even-numbered time-slices are supplied from the output port of the selector 41 to the input port of a permuter 224. The permuter 224 changes the order of data bits supplied from its output port to the input port of the encoder 222 from the order of data bits supplied to its input port from the output port of the selector 41. The output port of the encoder 222 is connected for supplying one-half-rate LDPC coding to the input port of a further permuter 225. The permuter 225 changes the order of data bits and parity bits supplied from its output port to the first input port of the time-division multiplexer 47 from the order of data bits and parity bits supplied to its input port from the output port of the encoder 222. The permuter 225 restores in its response the order of data bits supplied from the output port of the selector 41.

The bit-serial, convolutionally byte-interleaved (204, 188) Reed-Solomon codewords of odd-numbered time-slices are supplied from the output port of the selector 42 to the input port of a delay memory 226, the output port of which is connected to the input port of the encoder 223 for one-half-rate LDPC coding. The output port of the encoder 223 is connected for supplying one-half-rate LDPC coding to the second input port of the time-division multiplexer 47. The delay memory 226 provides delay that compensates for the latent delays in the permuters 224 and 225. So, the coded odd-numbered time-slices that the encoder 223 supplies to the second input port of the time-division multiplexer 47 interleave in time with the even coded-time-slices that the permuter 225 supplies to the first input port of the time-division multiplexer 47.

FIG. 38 combines with FIGS. 12 and 14 to show a stationary DTV receiver adapted for iterative-diversity reception of COFDM signals as transmitted by the portions of the DTV transmitter as depicted in FIG. 1 and in FIG. 2 with modifications per FIG. 36. The turbo decoder shown in FIG. 38 differs from the turbo decoder shown in FIG. 34 in that a single soft-input/soft-output decoder 227 replaces both the SISO decoder 205 for first LDPC coding and the SISO decoder 206 for second LDPC coding. The selectors 207 and 209 for supplying soft bits of LDPC coding to the SISO decoders 205 and 206 in FIG. 34 are replaced in FIG. 38 by selectors 228 and 229 for supplying the SISO decoder 227 soft bits of LDPC coding for even-numbered time-slices and for odd-numbered time-slices, respectively. The extrinsic data feedback processors 208 and 210 in FIG. 34 are replaced in FIG. 38 by a single extrinsic data feedback processor 230.

FIG. 38 combines with FIGS. 15, 17 and 18 to show a mobile DTV receiver adapted for iterative-diversity reception of COFDM signals as transmitted by the portions of the DTV transmitter as depicted in FIG. 3 and in FIG. 4 with modifications per FIG. 37. This DTV receiver is novel and embodies aspects of the invention. The turbo decoder shown in FIG. 38 differs from the turbo decoder shown in FIG. 35 in that the single soft-input/soft-output decoder 227 replaces both the SISO decoder 211 for third LDPC coding and the SISO decoder 212 for fourth LDPC coding. The selectors 213 and 215 for supplying soft bits of LDPC coding to the SISO decoders 211 and 212 in FIG. 35 are replaced in FIG. 38 by the selectors 228 and 229. The extrinsic data feedback processors 214 and 216 in FIG. 35 are replaced in FIG. 38 by a single extrinsic data feedback processor 230.

In actual practice, the selector 228 will usually be incorporated into the structures and operations of the memories 76 and 77, and the selector 229 will usually be incorporated into the structures and operations of the memories 74 and 76. The operation of the FIG. 38 portion of the mobile DTV receiver shown in FIGS. 15, 38, and 14 is similar to the operation of the FIG. 38 portion of the stationary DTV receiver shown in FIGS. 12, 38 and 14. Such operation is described in some detail, immediately following.

During each even-numbered half cycle of iterative decoding, soft data bits and extrinsic data bits are read to the SISO decoder 227 and the extrinsic data feedback processor 230 from the memory 76, and soft parity bits are read to the SISO decoder 227 from the memory 74. The soft data bits are read from the memory 76 in an order the same as or the reverse of the order as written into the memory 76, and the soft extrinsic data bits are read from and written back to the memory 76 in corresponding order. The soft parity bits are read from the memory 74 in an order the same as or the reverse of the order as written into the memory 74.

During each odd-numbered half cycle of iterative decoding, soft data bits and extrinsic data are read to the SISO decoder 227 and the extrinsic data feedback processor 230 from the memory 76, and soft parity bits are read to the SISO decoder 227 from the memory 74. The soft data bits are read from the memory 76 in their order after being encoded as LDPC coding, but before their subsequent permutation to restore their original order. The soft extrinsic data bits are read from and written to the memory 76 in similar order as the soft data bits. The soft parity bits are read from the memory 74 in their original order after being encoded as LDPC coding. This order of reading from the memories 74 and 76 avoids having to include permuters before and after the SISO decoder 227 during each odd-numbered half cycle of iterative decoding.

At the conclusion of the iterative decoding procedure for a concurrent pair of time-slices soft data bits are read from the memory 76 together with the soft extrinsic data bits read in corresponding order. The soft data bits combined with corresponding soft extrinsic data bits are read in an order that de-interleaves the combined soft bits for application to the input port of the quantizer 86 in FIG. 14 or in FIG. 17.

FIG. 39 shows a modification of the FIG. 2 portion of the COFDM transmitter for a DTV system. This modification facilitates “maximal-ratio QAM combining” in a DTV receiver—that is, the two-dimensional maximal-ratio code combining of the complex coordinates of similar QAM constellation maps. This modification differs from the modification of FIG. 2 shown in FIG. 20 in that the FEC coding is provided by similar encoders 217 and 218 for one-half-rate LDPC coding, rather than by the similar encoders 13 and 17 for one-half-rate convolutional coding. The respective input ports of the selectors 10 and 11 are still connected for receiving the response of the convolutional byte interleaver 9 shown in FIG. 1. In FIG. 39, as in FIG. 36, the output port of the selector 10 of even time-slices connects to the input port of the permuter 219, and the output port of the permuter 219 connects to the input port of the encoder 217 for one-half-rate LDPC coding. However, in FIG. 39 the output port of the selector 11 of odd time-slices connects directly to the input port of the encoder 218 for one-half-rate LDPC coding, rather than connecting via delay memory 221 as shown in FIG. 36.

In FIG. 39 the permuter 220 shown in FIG. 36 is replaced by random-access memories 231 and 232. The RAM 311 has a write-input port connected to be written with the data bits of one-half-rate LDPC coding of initial transmissions that subsequently are repeated for iterative-diversity reception, as supplied from a first output port of the encoder 217. The RAM 231 has a read-output port connected for supplying bytes of data bits to a first input port of a selector 233 of the 8-bit Gray labeling used by the 256QAM symbol constellation mapper 18 during even time-slices. The RAM 232 has a write-input port connected to be written with the parity bits of the one-half-rate LDPC coding of the initial transmissions that subsequently are repeated for iterative-diversity reception, as supplied from a second output port of the encoder 217. The RAM 232 has a read-output port connected for supplying bytes of parity bits to a second input port of the selector 233 of the 8-bit Gray labeling used by the 256QAM symbol constellation mapper 18 during even time-slices. The write addressing and read addressing of the RAMs 231 and 232 are such as to complement the permutation of data bits by the permuter 219, thus to restore the order of the data bits supplied from the output port of the selector 10 in the LDPC-coded data supplied from the output port of the selector 233. The output port of the selector 233 is connected for supplying a first input port of the time-division multiplexer 15 with 8-bit Gray labels for 256QAM constellation maps in even-numbered time-slices of COFDM signals intended for iterative-diversity reception.

In FIG. 39 the delay to compensate for the latencies of the permuter 219 and of the RAMs 231 and 232 is provided for by random-access memories 234 and 235. The RAM 234 has a write-input port connected to be written with the data bits of one-half-rate LDPC coding of those transmissions that are not repeated and of the final ones of those transmissions that are repeated, as supplied from a first output port of the encoder 218. The RAM 234 has a read-output port connected for supplying bytes of data bits to a first input port of a selector 236 of the 8-bit Gray labeling used by the 256QAM symbol constellation mapper 18 during odd time-slices. The RAM 235 has a write-input port connected to be written with the parity bits of the one-half-rate LDPC coding of those transmissions that are not repeated and of the final ones of those transmissions that are repeated for iterative-diversity reception, as supplied from a second output port of the encoder 218. The RAM 235 has a read-output port connected for supplying bytes of parity bits to a second input port of the selector 236 of the 8-bit Gray labeling used by the 256QAM symbol constellation mapper 18 during odd time-slices. FIG. 39 shows the output port of the selector 236 connected to supply a second input port of the time-division multiplexer 15 with 8-bit Gray labels for 256QAM constellation in odd-numbered time-slices of COFDM signals intended for iterative-diversity reception.

The time-division multiplexer 15 and the selectors 233 and 236 are depicted as physically separate elements as an aid to the reader in understanding the desired operation of the FIG. 39 configuration. In actual practice the functions of the time-division multiplexer 15 and of the selectors 233 and 236 can be subsumed into the read-control circuits of the RAMs 231, 232, 234 and 235, as one skilled in digital electronics design will understand.

FIG. 40 combines with FIGS. 22 and 14 to provide a generic schematic diagram of another stationary DTV receiver adapted for iterative-diversity reception of COFDM signals as transmitted by the portions of the DTV transmitter as depicted in FIG. 1 and in FIG. 2 with modifications per FIG. 39. The FIG. 40 receiver apparatus for decoding parallel concatenated LDPC coding extracted from 256QAM symbol constellations is analogous in several respects to the FIG. 23 receiver apparatus for decoding PCCC extracted from 256QAM symbol constellations.

In the FIG. 22 portion of the DTV receiver preceding its FIG. 40 portion, the selectors 67 and 68 selectively respond to the complex coordinates of 256QAM symbol constellations supplied from the frequency-domain channel equalizer 65, rather than to demodulated LDPC coding from the omitted de-mapper 66 of 256QAM symbol constellations. The delay memory 69 delays the complex coordinates of 256QAM symbol constellations from the initial transmissions that subsequently are repeated for iterative-diversity reception, as reproduced at the output port of the selector 68. The complex coordinates of 256QAM symbol constellations from the initial transmissions reproduced after delay at the output port of the delay memory 69 are concurrent with the complex coordinates of corresponding 256QAM symbol constellations from the final transmissions reproduced at the output port of the selector 67. FIG. 22 shows a maximal-ratio QAM combiner 133 for combining the complex coordinates of 256QAM symbol constellations descriptive of data bits, as selected from the initial transmissions for iterative-diversity reception, with the complex coordinates of corresponding 256QAM symbol constellations descriptive of data bits, as selected from the final transmissions for iterative-diversity reception.

FIG. 40 shows a selector 136 that has an input port connected for receiving the response of the delay memory 69. The selector 36 is operable for selectively reproducing the complex coordinates of 256QAM symbol constellations descriptive of parity bits from the LDPC coding of the delayed initial transmissions for iterative-diversity reception. The output port of the selector 136 is connected for supplying these selectively reproduced complex coordinates to the input port of a de-mapper 237 of 256QAM symbol constellations. The de-mapper 237 de-maps the parity bits, supplying them from its output port to the write-input port of the memory 74 for soft LDPC parity bits from an even-numbered time-slice of COFDM signal intended for iterative-diversity reception.

FIG. 40 shows the input port of a de-mapper 238 of 256QAM symbol constellations connected for receiving the response of the QAM combiner 133, which response supplies the complex coordinates of 256QAM symbol constellations descriptive of data bits of the LDPC coding. The de-mapper 238 de-maps these data bits, supplying soft data bits of the LDPC coding from its output port to the random-access port of the memory 76 for soft data bits and extrinsic data. The soft data bits are written into the storage locations for soft data bits within the memory 76.

FIG. 40 shows a selector 139 that has an input port connected for receiving the response of the selector 67 at its input port. The selector 139 is operable for selectively reproducing the complex coordinates of 256QAM symbol constellations descriptive of parity bits from the final transmissions for iterative-diversity reception. The output port of the selector 139 is connected for supplying these selectively reproduced complex coordinates to the input port of a de-mapper 239 of 256QAM symbol constellations. The de-mapper 239 de-maps the parity bits, supplying them from its output port to the write-input port of the memory 77 for soft LDPC parity bits from an even-numbered time-slice of COFDM signal intended for iterative-diversity reception.

Besides showing the memories 74, 76 and 77, FIG. 40 shows the other elements used for iteratively decoding parallel concatenated LDPC coding similarly to the way described supra with reference to FIG. 38 of the drawings. These other elements include the SISO decoder 227 for one-half-rate LDPC coding, the selector 228 of soft bits of LDPC coding from even-numbered time-slices, the selector 229 of soft bits of LDPC coding from odd-numbered time-slices, and the extrinsic data feedback processor 230.

FIG. 41 shows a modification of the FIG. 4 portion of the COFDM transmitter for a DTV system, which modification facilitates “maximal-ratio QAM combining” in a DTV receiver. This modification differs from the modification of FIG. 4 shown in FIG. 21 in that the FEC coding is provided by similar encoders 222 and 223 for one-half-rate LDPC coding, rather than by the similar encoders 44 and 49 for one-half-rate convolutional coding. The respective input ports of the selectors 41 and 42 are still connected for receiving the response of the convolutional byte interleaver 36 shown in FIG. 3. In FIG. 41, as in FIG. 37, the output port of the selector 41 of even time-slices connects to the input port of the permuter 224, and the output port of the permuter 224 connects to the input port of the encoder 222 for one-half-rate LDPC coding. However, in FIG. 41 the output port of the selector 42 of odd time-slices connects directly to the input port of the encoder 226 for one-half-rate LDPC coding, rather than connecting via delay memory 226 as shown in FIG. 37.

In FIG. 41 the permuter 225 shown in FIG. 36 is replaced by random-access memories 241 and 242. The RAM 241 has a write-input port connected to be written with the data bits of one-half-rate LDPC coding of initial transmissions that subsequently are repeated for iterative-diversity reception, as supplied from a first output port of the encoder 222. The RAM 241 has a read-output port connected for supplying bytes of data bits to a first input port of a selector 243 of the 6-bit Gray labeling used by the 64QAM symbol constellation mapper 50 during even time-slices. The RAM 242 has a write-input port connected to be written with the parity bits of the one-half-rate LDPC coding of the initial transmissions that subsequently are repeated for iterative-diversity reception, as supplied from a second output port of the encoder 222. The RAM 242 has a read-output port connected for supplying bytes of parity bits to a second input port of the selector 243 of the 6-bit Gray labeling used by the 64QAM symbol constellation mapper 50 during even time-slices. The write addressing and read addressing of the RAMs 241 and 242 are such as to complement the permutation of data bits by the permuter 224, thus to restore the order of the data bits supplied from the output port of the selector 41 in the LDPC-coded data supplied from the output port of the selector 243. FIG. 41 shows the output port of the selector 243 connected for supplying a first input port of the time-division multiplexer 47 with 6-bit Gray labels for 64QAM constellation maps in even-numbered time-slices of COFDM signals intended for iterative-diversity reception.

In FIG. 41 the delay to compensate for the latencies of the permuter 224 and of the RAMs 241 and 242 is provided for by random-access memories 244 and 245. The RAM 244 has a write-input port connected to be written with the data bits of one-half-rate LDPC coding of those transmissions that are not repeated and of the final ones of those transmissions that are repeated, as supplied from a first output port of the encoder 223. The RAM 244 has a read-output port connected for supplying bytes of data bits to a first input port of a selector 236 of the 6-bit Gray labeling used by the 64QAM symbol constellation mapper 50 during odd time-slices. The RAM 245 has a write-input port connected to be written with the parity bits of the one-half-rate LDPC coding of those transmissions that are not repeated and of the final ones of those transmissions that are repeated for iterative-diversity reception, as supplied from a second output port of the encoder 223. The RAM 245 has a read-output port connected for supplying bytes of parity bits to a second input port of the selector 246 of the 6-bit Gray labeling used by the 64QAM symbol constellation mapper 50 during odd time-slices. FIG. 41 shows the output port of the selector 246 connected to supply a second input port of the time-division multiplexer 47 with 6-bit Gray labels for 64QAM constellation in odd-numbered time-slices of COFDM signals intended for iterative-diversity reception.

The time-division multiplexer 47 and the selectors 243 and 246 are depicted as physically separate elements as an aid to the reader in understanding the desired operation of the FIG. 41 configuration. In actual practice the functions of the time-division multiplexer 47 and of the selectors 243 and 246 can be subsumed into the read-control circuits of the RAMs 241, 242, 244 and 245, as one skilled in digital electronics design will understand.

FIG. 42 combines with FIGS. 24, 17 and 18 to provide a generic schematic diagram of another mobile DTV receiver adapted for iterative-diversity reception of COFDM signals as transmitted by the portions of the DTV transmitter as depicted in FIG. 3 and in FIG. 4 with modifications per FIG. 41. The FIG. 42 receiver apparatus for decoding parallel concatenated LDPC coding extracted from 64QAM symbol constellations is analogous in several respects to the FIG. 25 receiver apparatus for decoding PCCC extracted from 64QAM symbol constellations.

In the FIG. 24 portion of the DTV receiver preceding its FIG. 42 portion, the selectors 67 and 68 selectively respond to the complex coordinates of 64QAM symbol constellations supplied from the frequency-domain channel equalizer 165, rather than to demodulated LDPC coding from the omitted de-mapper 166 of 64QAM symbol constellations. The delay memory 69 delays the complex coordinates of 64QAM symbol constellations from the initial transmissions that subsequently are repeated for iterative-diversity reception, as reproduced at the output port of the selector 68. The complex coordinates of 64QAM symbol constellations from the initial transmissions reproduced after delay at the output port of the delay memory 69 are concurrent with the complex coordinates of corresponding 64QAM symbol constellations from the final transmissions reproduced at the output port of the selector 67. FIG. 24 shows a maximal-ratio QAM combiner 141 for combining the complex coordinates of 64QAM symbol constellations descriptive of data bits, as selected from the initial transmissions for iterative-diversity reception, with the complex coordinates of corresponding 64QAM symbol constellations descriptive of data bits, as selected from the final transmissions for iterative-diversity reception.

FIG. 42 shows a selector 144 connected for receiving the response of the delay memory 69 at its input port and for selectively reproducing the complex coordinates of 64QAM symbol constellations descriptive of parity bits from the LDPC coding delayed initial transmissions for iterative-diversity reception. The output port of the selector 144 is connected for supplying these selectively reproduced complex coordinates to the input port of a de-mapper 247 of 64QAM symbol constellations. The de-mapper 247 de-maps the parity bits, supplying them from its output port to the write-input port of the memory 74 for soft LDPC parity bits from an even-numbered time-slice of COFDM signal intended for iterative-diversity reception.

FIG. 42 shows the input port of a de-mapper 248 of 64QAM symbol constellations connected for receiving the response of the QAM combiner 141, which response supplies the complex coordinates of 64QAM symbol constellations descriptive of data bits of the LDPC coding. The de-mapper 248 de-maps these data bits, supplying soft data bits of the LDPC from its output port to the random-access port of the memory 76 for soft data bits and extrinsic data. The soft data bits are written into the storage locations for soft data bits within the memory 76.

FIG. 42 shows a selector 147 that has an input port connected for receiving the response of the selector 67. The selector 147 is operable for selectively reproducing the complex coordinates of 64QAM symbol constellations descriptive of parity bits from the final transmissions for iterative-diversity reception. The output port of the selector 147 is connected for supplying these selectively reproduced complex coordinates to the input port of a de-mapper 249 of 64QAM symbol constellations. The de-mapper 239 de-maps the parity bits, supplying them from its output port to the write-input port of the memory 77 for soft LDPC parity bits from an odd-numbered time-slice of COFDM signal intended for iterative-diversity reception.

Besides showing the memories 74, 76 and 77, FIG. 42 shows the other elements used for iteratively decoding parallel concatenated LDPC coding similarly to the way described supra with reference to FIG. 38 of the drawings. These other elements include the SISO decoder 227 for one-half-rate LDPC coding, the selector 228 of soft bits of LDPC coding from even-numbered time-slices, the selector 229 of soft bits of LDPC coding from odd-numbered time-slices, and the extrinsic data feedback processor 230.

Additional sorts of DTV receivers embodying the invention are generated by modifying DTV receivers using the turbo decoders shown in FIGS. 34, 35, 38, 40 and 42, respectively. Each turbo decoder is modified to incorporate a respective decoder for (204, 188) Reed-Solomon coding within its structure, connected similarly to the RS decoder 149 shown in FIG. 26,

Less preferred, additional sorts of DTV receivers embodying the invention are generated by modifying DTV receivers that use the turbo decoders shown in FIGS. 38, 40 and 42, respectively. The turbo decoders shown in FIGS. 38, 40 and 42 are replaced by turbo decoders that use a pair of decoders for LDPC coding, rather than a single decoder for LDPC coding. In a stationary DTV receiver the replacement turbo decoder in FIG. 38 or 38 as so modified is configured similarly to the turbo decoder comprising elements 205-210 in FIG. 34. In a mobile DTV receiver the replacement turbo decoder in FIG. 38 or 40 as so modified is configured similarly to the turbo decoder comprising elements 211-216 in FIG. 35.

The selectors 123 and 126 shown in FIG. 20 alternate 256QAM symbol constellations respectively descriptive of data bits and descriptive of parity bits. Other patterns of interleaving the 256QAM symbol constellations could be used instead without departing from the spirit and scope of the invention, but would require modification to suit of the selectors 134, 135, 136 and 139 in the receiver apparatus of FIGS. 22 and 23 to de-interleave the symbol constellations for subsequent processing. Analogously, 256QAM symbol constellations respectively descriptive of data bits and descriptive of parity bits are alternated by the selectors 233 and 236 shown in FIG. 39. Other patterns of interleaving the 256QAM symbol constellations could be used instead without departing from the spirit and scope of the invention, but would require modification to suit of the selectors 134, 135, 136 and 139 in the receiver apparatus of FIGS. 22 and 40 to de-interleave the symbol constellations for subsequent processing.

The selectors 129 and 130 shown in FIG. 21 alternate 64QAM symbol constellations respectively descriptive of data bits and descriptive of parity bits. Other patterns of interleaving the 64QAM symbol constellations could be used instead without departing from the spirit and scope of the invention, but would require modification to suit of the selectors 142, 143, 144 and 147 in the receiver apparatus of FIGS. 24 and 25 to de-interleave the symbol constellations for subsequent processing. Analogously, 64QAM symbol constellations respectively descriptive of data bits and descriptive of parity bits are alternated by the selectors 243 and 246 shown in FIG. 41. Other patterns of interleaving the 64QAM symbol constellations could be used instead without departing from the spirit and scope of the invention, but would require modification to suit of the selectors 142, 143, 144 and 147 in the receiver apparatus of FIGS. 24 and 42 to de-interleave the symbol constellations for subsequent processing.

FIG. 10 shows frequency-domain equalizer 53 connected in cascade after the OFDM demodulator 51. FIGS. 12 and 22 show frequency-domain equalizer 65 connected in cascade after the OFDM demodulator 63. FIGS. 15 and 24 show frequency-domain equalizers 165 connected in cascade after the OFDM demodulators 163. The cascade connections of OFDM demodulator and frequency-domain equalizer illustrate the overall functioning of these elements in the DTV receivers in simple and more readily understood form. In a customary practice, however, the ultimate parallel-to-serial conversion of the frequency-division-multiplexed carriers that is usually considered part of complete OFDM demodulation is deferred until after the carriers are multiplied by frequency-domain equalization coefficients. The frequency-domain equalization coefficients are determined by interpolation based on the measurement of the unmodulated pilot carriers carried out as part of the pilot and TPS carriers processing. U.S. Pat. No. 6,912,258 issued 28 Jun. 2005 to Dagnachew Birru and titled “Frequency-domain equalizer for terrestrial digital TV reception” is instructive concerning frequency-domain equalization for OFDM demodulators.

Frequency-domain equalization is supplemented by adaptive time-domain equalization in some receiver designs. Variants of the specifically described systems that replace the (204, 188) RS coding of MPEG-2 compatible data packets with a slightly different sort of Reed-Solomon coding, such as the (207, 187) RS coding used in 8-VSB DTV broadcasting should be considered as functional equivalents when construing the claims which follow.

Provisional U.S. Pat. App. Ser. No. 61/574,640 filed 6 Aug. 2011, provisional U.S. Pat. App. Ser. No. 61/575,179 filed 16 Aug. 2011, provisional U.S. Pat. App. Ser. No. 61/627,495 filed 13 Oct. 2011 and provisional U.S. Pat. App. Ser. No. 61/628,832 filed 7 Nov. 2011 are incorporated herein by reference, particularly for their showing of means in the transmitter for randomizing respective data for each said service intended for iterative-diversity reception, which means are alternative to preferred means for such randomizing shown in FIGS. 1 and 3 hereof. These alternative means for randomizing respective data for each said service intended for iterative-diversity reception use a respective data randomizer for each of the services that are to be temporarily stored in a respective dual-port RAM and subsequently transmitted for iterative diversity reception. Other alternative means for randomizing respective data for each said service intended for iterative-diversity reception use a respective data randomizer for each of the services the respective data of which have been temporarily stored in respective dual-port RAMs and are twice read from those RAMs to be data-randomized before being subsequently transmitted for iterative diversity reception.

The QAM symbol constellation mappers 18 and 50 may, per a customary practice, include inner interleaving that permutes the temporal order of groups of bits before coding them into successive QAM symbols for constellation mapping. If inner interleaving is used in the DTV transmissions, inner de-interleaving of the results of de-mapping the QAM symbol constellations is required. In receiver apparatus as partially shown in any of FIGS. 13, 16, 23, 25, 29, 34, 35, 38 and 40, suitable write addressing of the memories 74, 76 and 77 can implement this inner de-interleaving.

Various mappings of bit-wise FEC coding at one-half code rate to QAM symbol constellations are specifically described supra. However, bit-wise FEC coding can be performed at other code rates, such as the ⅞, ⅚, ¾ and ⅔ code rates that together with ½ code rate are the valid code rates for DVB DTV broadcasting. Transmissions for iterative-diversity reception will halve the overall code rate for bit-wise FEC coding, of course.

DVB-H DTV broadcasting standards now prescribe “in-depth interleaving” in the formation of OFDM symbol blocks for COFDM transmissions using 2K carriers and for COFDM transmissions using 4K carriers. Receivers for such transmissions include de-interleaving of this in-depth interleaving following their OFDM demodulators. Transmitter apparatuses as described in the foregoing specification that are modified to use in-depth interleaving embody further aspects of the invention and are to be considered within the scope of claims to transmitter apparatus following this specification. Receiver apparatuses as described in the foregoing specification in which in their OFDM demodulators followed by de-interleaving for in-depth interleaving embody further aspects of the invention and are to be considered within the scope of claims to receiver apparatus following this specification.

It will be apparent to persons skilled in the art that various other modifications and variations can be made in the specifically described apparatus without departing from the spirit or scope of the invention. Accordingly, it is intended that these modifications and variations of the specifically described apparatus be considered to result in further embodiments of the invention and to be included within the scope of the appended claims and their equivalents.

In the appended claims, the word “said” rather than the word “the” is used to indicate the existence of an antecedent basis for a term being provided earlier in the claims. The word “the” is used for purposes other than to indicate the existence of an antecedent basis for a term having being provided earlier in the claims, the usage of the word “the” for other purposes being consistent with customary grammar in the American English language.

What is claimed is:

1. Transmitter apparatus for a digital television system, said transmitter apparatus by itself generating coded orthogonal frequency-division multiplex (COFDM) transmissions that comprise a plurality of successive time-slices, a respective pair of time-slices for each of a number of services for iterative-diversity reception being included in each of a succession of super-frames, one of each said pair of time-slices conveying a relatively later part of initial transmissions of one of said services for iterative-diversity reception and the other of that same said pair of time-slices conveying a relatively earlier part of the final transmissions of said same one of said services for iterative-diversity reception, said transmitter apparatus comprising:
an assembler for assembling at least one respective frame within each of said succession of super-frames, said frames being assembled by said first assembler from successive data-randomized transport-stream packets for each of a number of services intended for iterative-diversity reception by stationary receivers, said assembler arranging said data-randomized transport-stream packets for transmission an initial time in a respective prescribed one of said successive time-slices in each super-frame and for transmission a final time in a respective other prescribed one of said successive time-slices in another super-frame later transmitted;
an encoder for generating successive (204, 188) Reed-Solomon codewords responsive to the randomized 188-byte transport-stream packets as arranged by said first assembler in said succession of super-frames;
a convolutional byte interleaver connected for convolutionally interleaving bytes of said successive (204, 188) Reed-Solomon codewords in each time-slice;
an encoder connected for redundantly coding the individual bits of said convolutionally interleaved bytes of said successive (204, 188) Reed-Solomon codewords in said earlier transmissions to generate first further forward-error-correction coding including a first set of parity bits;
an encoder connected for redundantly coding the individual bits of said convolutionally interleaved bytes of said successive (204, 188) Reed-Solomon codewords in said later transmissions to generate second further forward-error-correction coding including a second set of parity bits, said second set of parity bits differing from said first set of parity bits derived from the same individual bits of said convolutionally interleaved bytes of said successive (204, 188) Reed-Solomon codewords;
a constellation mapper, for mapping interleaved time-slices of said first further forward-error-correction coding and said second further forward-error-correction coding to a succession of complex samples descriptive of QAM symbols;
a modulator for orthogonal frequency-division multiplexing (OFDM) complex samples of plural carrier waves in each of successive OFDM windows responsive to respective OFDM symbol blocks;
a parser of said complex samples descriptive of QAM symbols into effective portions of successive ones of said OFDM symbol blocks;
a pilot-carrier-insertion unit for completing said OFDM symbol blocks by inserting complex samples descriptive of unmodulated pilot carrier waves and of carrier waves modulated by Transmission Parameters Signaling (TPS);
a guard interval and cyclic prefix insertion unit for prefacing said complex symbols of said plural carrier waves in each of said successive OFDM windows with complex symbols identical to those in a concluding portion of the same OFDM window, thereby to generate a respective one of a succession of extended OFDM windows; and
a digital-to-analog converter for converting said succession of extended OFDM windows to an analog signal.

2. Transmitter apparatus as set forth in claim 1, further comprising:
means for byte de-interleaving the bytes of the data-randomized transport-stream packets as arranged by said assembler, before their application to said encoder for generating successive (204, 188) Reed-Solomon codewords, said byte de-interleaving complementing subsequent convolutional byte interleaving by said convolutional byte interleaver so said subsequent convolutional byte interleaving is coded or implied in nature.

3. Transmitter apparatus as set forth in claim 1, wherein said encoder to generate first further forward-error-correction coding and said encoder to generate second further forward-error-correction coding are structurally similar, but differ in their connections for receiving the individual bits of said convolutionally interleaved bytes of said successive (204, 188) Reed-Solomon codewords for convolutional interleaving, said transmitter apparatus further comprising:
a bit de-interleaver for de-interleaving the individual bits of said convolutionally interleaved bytes of said successive (204, 188) Reed-Solomon codewords in said earlier transmissions in accordance with a prescribed pattern before being supplied to said encoder to generate first further forward-error-correction coding;
a symbol interleaver for symbol-interleaving symbols of the redundant coding generated by said encoder to generate first further forward-error-correction coding responsive to the de-interleaved individual bits of said convolutionally interleaved bytes of said successive (204, 188) Reed-Solomon codewords in said earlier transmissions supplied to said encoder to generate first further forward-error-correction coding, said symbol-interleaving being coded interleaving that is performed in accordance with said prescribed pattern to restore in its symbol-interleaving results said individual bits of said convolutionally interleaved bytes of said successive (204, 188) Reed-Solomon codewords in said later transmissions to their original order before their de-interleaving by said bit de-interleaver; and
delay memory for delaying the individual bits of said convolutionally interleaved bytes of said successive (204, 188) Reed-Solomon codewords in said later transmissions supplied to said encoder to generate first further forward-error-correction coding so its decoding results interleave in time with said symbol-interleaving results in a time-division multiplex signal supplied to said constellation mapper for mapping to said succession of complex samples descriptive of QAM symbols.

4. Transmitter apparatus as set forth in claim 3, wherein said encoder to generate first further forward-error-correction coding and said encoder to generate second forward-error-correction coding each generate convolutional coding.

5. Transmitter apparatus as set forth in claim 3, wherein said encoder to generate first further forward-error-correction coding and said encoder to generate second forward-error-correction coding each generate low-density parity-check (LDPC) coding.

6. Transmitter apparatus as set forth in claim 1, wherein said assembler comprises:
a respective dual-port random-access memory for each of said number of services intended for iterative-diversity reception by stationary DTV receivers, each said respective random-access memory having a random-access port through which successive transfer-stream packets of that particular service are written to be temporarily stored at storage locations in said memory for a period of more than one super-frame, each said respective random-access memory having a serial output port through which said successive transfer-stream packets of that particular service are read for transmission an initial time in a respective prescribed one of said successive time-slices in each super-frame and are read again for transmission a final time in a respective other prescribed one of said successive time-slices in another super-frame later transmitted;
a time-division multiplexer for assembling ones of said succession of super-frames by time-division multiplexing time-slices from said respective dual-port random-access memory for each of said number of services intended for iterative-diversity reception by stationary DTV receivers; and
means for randomizing respective data for each said service intended for iterative-diversity reception by stationary receivers.

7. Transmitter apparatus as set forth in claim 1, wherein said assembler comprises:
a respective dual-port random-access memory for each of said number of services intended for iterative-diversity reception by mobile receivers, said respective random-access memory having a random-access port through which successive internet-protocol transfer-stream packets of that particular service are written into storage locations within that said random-access memory to be temporarily stored for a period of more than one super-frame, said respective random-access memory having a serial output port through which said successive internet-protocol transfer-stream packets of that particular service are read for transmission an initial time in a respective prescribed one of said successive time-slices in each super-frame and are read again for transmission a final time in a respective other prescribed one of said successive time-slices in another super-frame later transmitted;
a time-division multiplexer for assembling respective frames within said succession of super-frames by time-division multiplexing time-slices from said respective dual-port random-access memory for each of said number of services intended for iterative-diversity reception by mobile receivers;
means for randomizing respective data in each of the internet-protocol transport-stream packets of each said service intended for iterative-diversity reception by mobile receivers;
a TRS encoder for (255, 191) transverse Reed-Solomon coding of each successive time-slice intended for iterative-diversity reception by mobile receivers in said succession of super-frames, said TRS encoder generating therefrom a first response to a first set of alternate ones of said time-slices intended for iterative-diversity reception by mobile receivers, said TRS encoder generating therefrom a second response to a second set of alternate ones of said time-slices intended for iterative-diversity reception by mobile receivers, said first set and said second set of alternate time-slices interleaving with each other in time; and
an internet-protocol encapsulator for encapsulating portions of said first response of said TRS encoder within respective ones of 188-byte internet-protocol-encapsulation packets for application to said encoder for (204, 188) Reed-Solomon coding.

8. Receiver apparatus for a digital television system with coded orthogonal frequency-division multiplex (COFDM) transmissions providing for iterative-diversity reception, which COFDM transmissions comprise a plurality of carrier waves transmitted in successive time-slices that convey components of parallel concatenated redundant coding of convolutionally byte-interleaved (204, 188) Reed-Solomon codewords, some of said components of parallel concatenated redundant coding being transmitted in different ones of said successive time-slices than are others of said components of parallel concatenated redundant coding, a prescribed number of which said successive time-slices are included in each of successive super-frames of prescribed duration, said receiver apparatus comprising:
a front-end tuner for converting a selected radio-frequency analog COFDM signal to a digitized baseband COFDM signal;
a demodulator of said orthogonal frequency-division multiplex (OFDM) signal, for supplying complex samples of a plurality of carrier waves in response to said OFDM signal;
a processor of unmodulated pilot carrier waves and of carrier waves modulated by Transmission Parameters Signaling (TPS) supplied from said demodulator for OFDM signal as a first output signal therefrom, said processor operable for processing said unmodulated pilot carrier waves to generate continuing measurements of their total root-mean-square energy;
a frequency-domain channel equalizer for equalizing in a response thereof said complex samples of those ones of said plurality of carrier waves subject to quadrature amplitude modulation, as supplied from said demodulator for OFDM signal as a second output signal therefrom, said equalizing being performed responsive to said unmodulated pilot carrier waves supplied from said demodulator for OFDM signal as a portion of said first output signal therefrom;
means to regenerate said parallel concatenated redundant coding from components thereof in said response of said frequency-domain channel equalizer, combining said components of said parallel concatenated redundant coding in ratio determined by said continuing measurements of the total root-mean-square energy of said unmodulated pilot carrier waves which accompany said carrier waves subject to quadrature amplitude modulation that convey said components of said parallel concatenated redundant coding;
a turbo decoder to decode said parallel concatenated redundant coding regenerated by said means to regenerate said parallel concatenated redundant coding, thus to reproduce convolutionally bye-interleaved (204, 188) Reed-Solomon codewords from ones of successive time-slices for a selected service; and
means for de-interleaving the bytes of said convolutionally bye-interleaved (204, 188) Reed-Solomon codewords from ones of successive time-slices for said selected service.

9. Receiver apparatus as set forth in claim 8, wherein said means to regenerate said parallel concatenated redundant coding comprises:
a de-mapper connected for responding to equalized complex samples of those ones of said plurality of carrier waves subject to quadrature amplitude modulation, as supplied in said response from said frequency-domain channel equalizer, to reproduce symbols of convolutional coding;
a selector of those said symbols of convolutional coding from transmissions that are not repeated or are the final ones of transmissions that are repeated;
a selector of those of said symbols of convolutional coding from transmissions that are the initial ones of transmissions that are repeated;
first delay memory for delaying said symbols of convolutional coding selected from transmissions that are the initial ones of transmissions that are repeated to generate delayed symbols of convolutional coding the data bits whereof ideally should be concurrent with corresponding data bits of said symbols of convolutional coding from the final ones of transmissions that are repeated;
a selector of said measurements of total root-mean-square energy of those of said unmodulated pilot carrier waves from said transmissions that are not repeated or are the final ones of transmissions that are repeated;
second delay memory for delaying said measurements of total root-mean-square energy of those of said unmodulated pilot carrier waves from said transmissions that are the initial ones of transmissions that are repeated, said second delay memory providing delay similar to that provided by said first delay memory; and
a maximal-ratio code combiner for combining in its response (a) soft data bits from said symbols of redundant coding from transmissions that are said final ones of said transmissions that are repeated with (b) said corresponding soft data bits from said delayed symbols of redundant coding from transmissions that are said initial ones of said transmissions that are repeated, said combining being done in the same ratio as the ratio of said measurements of total root-mean-square energy of those of said unmodulated pilot carrier waves from said final ones of said transmissions that are repeated to said delayed measurements of total root-mean-square energy of those of said unmodulated pilot carrier waves from said initial ones of said transmissions that are repeated, said maximal-ratio code combiner simply reproducing in its response soft data bits from said symbols of redundant coding from said transmissions that are not repeated.

10. Receiver apparatus as set forth in claim 9, wherein said turbo decoder is operable for decoding parallel concatenated convolutional coding (PCCC).

11. Receiver apparatus as set forth in claim 9, wherein said turbo decoder is operable for decoding parallel concatenated low-density parity-check (LDPC) coding.

12. Receiver apparatus as set forth in claim 9, wherein said means for de-interleaving the bytes of said convolutionally bye-interleaved (204, 188) codewords of LRS coding preserves the soft data bits as recovered by said turbo decoder, the hard bit components of which soft data bits define said (204, 188) codewords of LRS coding, said receiver apparatus further comprising:
an LRS decoder for decoding said (204, 188) codewords of LRS coding, thereby recovering a respective 188-byte packet from each said (204, 188) codeword of LRS coding;
a bank of exclusive-OR gates for exclusive-ORing the component hard bit component in each of said soft bits as preserved after byte de-interleaving with its further component bits indicative of the level of confidence in the correctness of its component hard bit, thus to generate bits indicative of the level of lack-of-confidence of the correctness of its said component hard bit;
a selector of the largest of the levels of lack-of-confidence in the component hard bits defining each byte of said (204, 188) Reed-Solomon codewords, which is ascribed to that byte as the level of lack-of-confidence of its being correct; and
a threshold detector for detecting the bytes of each of said (204, 188) Reed-Solomon codewords from ones of said successive time-slices for said selected service with the largest levels of lack-of-confidence of those said bytes being correct, thus locating the bytes of each of said (204, 188) Reed-Solomon codewords most likely to be in error for said LRS decoder, which enables said LRS decoder to use a byte-error-correction algorithm capable of correcting as many as sixteen erroneous bytes in each of said (204, 188) Reed-Solomon codewords.

13. Receiver apparatus as set forth in claim 12, further comprising:
means for re-interleaving bytes of 188-byte packets recovered by said LRS decoder to reproduce randomized transfer-stream data packets concerning said selected service; and
a data de-randomizer for de-randomizing randomized data in said randomized transfer-stream data packets concerning said selected service to reproduce respective transfer-stream data packets concerning said selected service.

14. Receiver apparatus as set forth in claim 12, further comprising:
a data de-randomizer for de-randomizing randomized data concerning said selected service contained in 188-byte packets recovered by said LRS decoder.

15. Receiver apparatus as set forth in claim 9, wherein said means for de-interleaving the bytes of said convolutionally bye-interleaved (204, 188) codewords of LRS coding preserves the soft data bits as recovered by said turbo decoder, the hard bit components of which soft data bits define said (204, 188) codewords of LRS coding, said receiver apparatus further comprising:
a quantizer for extracting the hard bit component in each of said soft bits as preserved after byte de-interleaving, thereby recovering said (204, 188) codewords of LRS coding defined by those said hard bit components;
an 8-bit-byte former for forming 8-bit bytes from the hard bit components in said (204, 188) codewords of LRS coding recovered by said quantizer;
a bank of exclusive-OR gates for exclusive-ORing the hard bit component in each of said soft bits as preserved after byte de-interleaving with its further component bits indicative of the level of confidence in the correctness of its hard bit component, thus to generate bits indicative of the level of lack-of-confidence of the correctness of its said hard bit component;
a selector of the largest of the levels of lack-of-confidence in the hard bit components defining each byte of said (204, 188) codewords of LRS coding, which is ascribed to that byte as the level of lack-of-confidence of its being correct; and
an extended-byte former connected for extending each 8-bit byte of said codewords of LRS coding with respective extension bits indicating the level of lack-of-confidence of that said 8-bit byte being correct, thus to generate (204, 188) codewords of LRS coding that have each of their bytes extended.

16. Receiver apparatus as set forth in claim 15, further comprising:
an LRS decoder for correcting erroneous bytes in said (204, 188) codewords of LRS coding that have each of their bytes extended, said decoder for correcting erroneous bytes in said (204, 188) codewords using said extension bits to locate erroneous bytes for correction, said LRS decoder recovering a respective 188-byte packet from each said (204, 188) codeword and reducing the levels of lack-of-confidence of each extended said 8-bit byte for each said 188-byte packet that said LRS decoder corrects or newly finds correct, successive said 188-byte packets recovered by said LRS decoder being successive reproduced transfer-stream packets of randomized data concerning said selected service;
a TRS decoder for correcting erroneous bytes in (255, 191) codewords of transverse Reed-Solomon (TRS) coding within said successive said reproduced transfer-stream packets of randomized data concerning said selected service;
an extended-byte-organized random-access memory with extended-byte storage locations arranged in rows and columns, with 255 extended-byte storage locations per column, said extended-byte storage locations being written row by row with said extended bytes of said successive reproduced transfer-stream packets of randomized data, said extended-byte storage locations being read column by column to supply (255, 191) codewords of TRS coding to said TRS decoder;
a byte-organized random-access memory with byte storage locations arranged in rows and columns, with 191 byte storage locations per column and with as many byte storage locations per row as there are extended-byte storage locations per row in said extended-byte-organized random-access memory, said byte storage locations being written column by column with bytes of randomized data from 191-byte packets extracted from said (255, 191) codewords of TRS coding by said TRS decoder, said byte storage locations being read row by row to supply corrected reproduced transfer-stream packets of randomized data concerning said selected service; and
a data de-randomizer for de-randomizing said randomized data concerning said selected service.

17. Receiver apparatus as set forth in claim 15, further comprising:
an LRS decoder for correcting erroneous bytes in said (204, 188) codewords of LRS coding that have each of their bytes extended, said decoder for correcting erroneous bytes in said (204, 188) codewords using said extension bits to locate erroneous bytes for correction, said LRS decoder recovering a respective 188-byte packet from each said (204, 188) codeword and reducing the levels of lack-of-confidence of each extended said 8-bit byte for each said 188-byte packet that said LRS decoder corrects or newly finds correct;
means for re-interleaving extended bytes of said 188-byte packets recovered by said LRS decoder to generate extended bytes of reproduced transfer-stream packets of randomized data concerning said selected service;
a TRS decoder for correcting erroneous bytes in (255, 191) codewords of transverse Reed-Solomon (TRS) coding within successive said reproduced transfer-stream packets of randomized data concerning said selected service;
an extended-byte-organized random-access memory with extended-byte storage locations arranged in rows and columns, with 255 extended-byte storage locations per column, said extended-byte storage locations being written row by row with said extended bytes of said successive reproduced transfer-stream packets of randomized data, said extended-byte storage locations being read column by column to supply (255, 191) codewords of TRS coding to said TRS decoder;
a byte-organized random-access memory with byte storage locations arranged in rows and columns, with 191 byte storage locations per column and with as many byte storage locations per row as there are extended-byte storage locations per row in said extended-byte-organized random-access memory, said byte storage locations being written column by column with bytes of randomized data from 191-byte packets extracted from said (255, 191) codewords of TRS coding by said TRS decoder, said byte storage locations being read row by row to supply corrected reproduced transfer-stream packets of randomized data concerning said selected service; and
a data de-randomizer for de-randomizing said randomized data concerning said selected service.

18. Receiver apparatus as set forth in claim 15, further comprising:
an extended-byte-organized random-access memory (RAM) with extended-byte storage locations arranged in rows and columns, with 255 extended-byte storage locations per column, said extended-byte storage locations being written row by row with extended bytes of randomized data from (204, 188) Reed-Solomon codewords having extended bytes that are supplied from said extended-byte former;
an LRS decoder for correcting erroneous bytes in said (204, 188) codewords of LRS coding having extended bytes as read thereto row by row from said extended-byte-organized RAM, said LRS decoder operable for using said extension bits indicating the levels of lack-of-confidence of each extended said 8-bit byte being correct to locate erroneous bytes for correction, said LRS decoder further operable for reducing the levels of lack-of-confidence of each extended said 8-bit byte of each said (204, 188) codeword of LRS coding that said LRS decoder corrects or newly finds correct and updating that said extended said 8-bit byte as temporarily stored in its respective one of said extended-byte storage locations within said extended-byte-organized RAM;
a TRS decoder for correcting erroneous bytes in said (225, 191) codewords of transverse Reed-Solomon (TRS) coding having extended bytes as read thereto column by column from said extended-byte-organized random-access memory, said TRS decoder operable for using said extension bits indicating the levels of lack-of-confidence of each extended said 8-bit byte being correct for locating erroneous bytes for correction, said TRS decoder further operable for reducing the levels of lack-of-confidence of each extended said 8-bit byte for each said (225, 191) codeword of TRS coding that said TRS decoder corrects or newly finds correct and updating that said extended said 8-bit byte as temporarily stored in its respective one of said extended-byte storage locations within said extended-byte-organized RAM; and
a data de-randomizer for de-randomizing randomized data concerning said selected service, said randomized data supplied from byte-storage portions of said extended-byte storage locations in said extended-byte-organized random-access memory as read row by row.

19. Receiver apparatus as set forth in claim 18, wherein 2-dimensional Reed-Solomon decoding is iteratively performed using the following steps:
(a) reading extended-byte-storage locations in said extended-byte-organized random-access memory row by row for supplying (204, 188) Reed-Solomon codewords with extended bytes to said LRS decoder;
(b) writing extended-byte-storage locations in said extended-byte-organized random-access memory row by row with bytes of corrected (204, 188) Reed-Solomon codewords from said LRS decoder, said extension bits of said bytes of said corrected (204, 188) Reed-Solomon codewords being adjusted to indicate reduced levels of lack-of-confidence in those said bytes being correct;
(c) reading extended-byte-storage locations in said extended-byte-organized random-access memory column by column for supplying (255, 191) Reed-Solomon codewords with extended bytes to said TRS decoder;
(d) writing extended-byte-storage locations in said extended-byte-organized random-access memory column by column with bytes of corrected (225, 191) Reed-Solomon codewords from said TRS decoder, said extension bits of said bytes of said corrected (225, 191) Reed-Solomon codewords being adjusted to indicate reduced levels of lack-of-confidence in those said bytes being correct; and
(e) if 2-dimensional Reed-Solomon decoding is completed, reading randomized data from byte-storage portions of said extended-byte storage locations in said extended-byte-organized random-access memory as read row by row; otherwise looping back to step (a).

20. Receiver apparatus as set forth in claim 18, further comprising:
a CRC decoder for cyclic-redundancy-check (CRC) coding in internet-protocol (IP) packets formed by successive 188-byte internet-protocol-encapsulation (IPE) packets having extended bytes as read from said extended-byte-organized random-access memory, said CRC decoder operable for detecting errors in said IP packets, said CRC decoder further operable for reducing the levels of lack-of-confidence of each extended said 8-bit byte for each said IP packet in which said CRC decoder detects no error and updating that said extended said 8-bit byte as temporarily stored in its respective one of said extended-byte storage locations within said extended-byte-organized RAM.

21. Receiver apparatus as set forth in claim 15, further comprising:
an extended-byte-organized random-access memory with extended-byte storage locations arranged in rows and columns, with 255 extended-byte storage locations per column, said extended-byte storage locations being written row by row with convolutional-byte-interleaved extended bytes supplied from said extended-byte former;
an LRS decoder for correcting erroneous bytes in said (204, 188) codewords of LRS coding having extended bytes as read thereto from said extended-byte-organized random-access memory, said LRS decoder operable for using said extension bits indicating the levels of lack-of-confidence of each extended said 8-bit byte being correct to locate erroneous bytes for correction, said LRS decoder further operable for reducing the levels of lack-of-confidence of each extended said 8-bit byte for each said (204, 188) codeword of LRS coding that said LRS decoder corrects or newly finds correct and updating that said extended said 8-bit byte as temporarily stored in its respective one of said extended-byte storage locations within said extended-byte-organized RAM;
a TRS decoder for correcting erroneous bytes in said (225, 191) codewords of transverse Reed-Solomon (TRS) coding having extended bytes as read thereto column by column from said extended-byte-organized random-access memory, said TRS decoder operable for using said extension bits indicating the levels of lack-of-confidence of each extended said 8-bit byte being correct for locating erroneous bytes for correction, said TRS decoder further operable for reducing the levels of lack-of-confidence of each extended said 8-bit byte for each said (225, 191) codeword of TRS coding that said TRS decoder corrects or newly finds correct and updating that said extended said 8-bit byte as temporarily stored in its respective one of said extended-byte storage locations within said extended-byte-organized RAM; and
a data de-randomizer for de-randomizing randomized data concerning said selected service, said randomized data supplied from byte-storage portions of said extended-byte storage locations in said extended-byte-organized random-access memory as read row by row.

22. Receiver apparatus as set forth in claim 21, wherein 2-dimensional Reed-Solomon decoding is iteratively performed using the following steps:
(a) reading extended-byte-storage locations in said extended-byte-organized random-access memory for supplying (204, 188) Reed-Solomon codewords with extended bytes to said LRS decoder;
(b) writing extended-byte-storage locations in said extended-byte-organized random-access memory with bytes of corrected (204, 188) Reed-Solomon codewords from said LRS decoder, said extension bits of said bytes of said corrected (204, 188) Reed-Solomon codewords being adjusted to indicate reduced levels of lack-of-confidence in those said bytes being correct;
(c) reading extended-byte-storage locations in said extended-byte-organized random-access memory column by column for supplying (255, 191) Reed-Solomon codewords with extended bytes to said TRS decoder;
(d) writing extended-byte-storage locations in said extended-byte-organized random-access memory column by column with bytes of corrected (225, 191) Reed-Solomon codewords from said TRS decoder, said extension bits of said bytes of said corrected (225, 191) Reed-Solomon codewords being adjusted to indicate reduced levels of lack-of-confidence in those said bytes being correct; and
(e) if 2-dimensional Reed-Solomon decoding is completed, reading randomized data from byte-storage portions of said extended-byte storage locations in said extended-byte-organized random-access memory as read row by row; otherwise looping back to step (a).

23. Receiver apparatus as set forth in claim 21, further comprising:
a CRC decoder for cyclic-redundancy-check (CRC) coding in internet-protocol (IP) packets formed by successive 188-byte internet-protocol-encapsulation (IPE) packets having extended bytes as read thereto row by row from said extended-byte-organized random-access memory, said CRC decoder operable for detecting errors in said IP packets, said CRC decoder operable further operable for reducing the levels of lack-of-confidence of each extended said 8-bit byte for each said IP packet in which said CRC decoder detects no error and updating that said extended said 8-bit byte as temporarily stored in its respective one of said extended-byte storage locations within said extended-byte-organized RAM.

24. Receiver apparatus as set forth in claim 8, wherein said means to regenerate said parallel concatenated redundant coding comprises:
a selector of said complex samples of those ones of said plurality of carrier waves subject to quadrature amplitude modulation that are from transmissions that are not repeated or are the final ones of transmissions that are repeated;
a selector of said complex samples of those ones of said plurality of carrier waves subject to quadrature amplitude modulation that are from transmissions that are the initial ones of transmissions that are repeated;
first delay memory for delaying said complex samples of those ones of said plurality of carrier waves subject to quadrature amplitude modulation that are selected from said initial ones of transmissions that are repeated to generate delayed complex samples of said plurality of carrier waves subject to quadrature amplitude modulation that are concurrent with said complex samples said plurality of carrier waves subject to quadrature amplitude modulation that are selected from final ones of transmissions that are repeated and that are based on similar data;
a selector of said measurements of total root-mean-square energy of those of said unmodulated pilot carrier waves from said transmissions that are not repeated or are the final ones of transmissions that are repeated;
second delay memory for delaying said measurements of total root-mean-square energy of those of said unmodulated pilot carrier waves from said transmissions that are the initial ones of transmissions that are repeated, said second delay memory providing delay similar to that provided by said first delay memory;
a maximal-ratio QAM combiner for combining in its response selected ones of said complex samples of carrier waves subject to quadrature amplitude modulation from transmissions that are said final ones of said transmissions that are repeated with selected ones of said delayed complex samples of carrier waves subject to quadrature amplitude modulation from transmissions that are said initial ones of said transmissions that are repeated, said selected ones said complex samples of carrier waves subject to quadrature amplitude modulation from transmissions that are said final ones of said transmissions that are repeated describing QAM mapping of data bits rather than parity bits, said selected ones said delayed complex samples of carrier waves subject to quadrature amplitude modulation from transmissions that are said initial ones of said transmissions that are repeated describing QAM mapping data bits rather than parity bits, said combining being done in the same ratio as the ratio of said measurements of total root-mean-square energy of those of said unmodulated pilot carrier waves from said final ones of said transmissions that are repeated to said delayed measurements of total root-mean-square energy of those of said unmodulated pilot carrier waves from said initial ones of said transmissions that are repeated, said maximal-ratio QAM combiner generating as at least part of its response therefrom combined complex samples of carrier waves subject to quadrature amplitude modulation which carrier waves map data bits of parallel concatenated redundant coding, said maximal-ratio QAM combiner simply reproducing in its said response said complex samples of carrier waves subject to quadrature amplitude modulation that map data bits of parallel concatenated redundant coding from any said transmissions that are not repeated;
a first de-mapper connected for reproducing said data bits of parallel concatenated redundant coding by de-mapping carrier waves subject to quadrature amplitude modulation as supplied in said response from said maximal-ratio QAM combiner;
a second de-mapper connected for reproducing a first set of parity bits of said parallel concatenated redundant coding by de-mapping carrier waves subject to quadrature amplitude modulation, as selected from a delayed response of said first delay memory to the initial ones of said transmissions that are repeated; and
a third de-mapper connected for reproducing a second set of parity bits of said parallel concatenated redundant coding by de-mapping carrier waves subject to quadrature amplitude modulation, as selected from the final ones of said transmissions that are repeated.

25. Receiver apparatus as set forth in claim 24, wherein said turbo decoder is operable for decoding parallel concatenated convolutional coding (PCCC).

26. Receiver apparatus as set forth in claim 24, wherein said turbo decoder is operable for decoding parallel concatenated low-density parity-check (LDPC) coding.

27. Receiver apparatus as set forth in claim 24, wherein said means for de-interleaving the bytes of said convolutionally bye-interleaved (204, 188) codewords of LRS coding preserves the soft data bits as recovered by said turbo decoder, the hard bit components of which soft data bits define said (204, 188) codewords of LRS coding, said receiver apparatus further comprising:
an LRS decoder for decoding said (204, 188) codewords of LRS coding, thereby recovering a respective 188-byte packet from each said (204, 188) codeword of LRS coding;
a bank of exclusive-OR gates for exclusive-ORing the component hard bit component in each of said soft bits as preserved after byte de-interleaving with its further component bits indicative of the level of confidence in the correctness of its component hard bit, thus to generate bits indicative of the level of lack-of-confidence of the correctness of its said component hard bit;
a selector of the largest of the levels of lack-of-confidence in the component hard bits defining each byte of said (204, 188) Reed-Solomon codewords, which is ascribed to that byte as the level of lack-of-confidence of its being correct; and
a threshold detector for detecting the bytes of each of said (204, 188) Reed-Solomon codewords from ones of said successive time-slices for said selected service with the largest levels of lack-of-confidence of those said bytes being correct, thus locating the bytes of each of said (204, 188) Reed-Solomon codewords most likely to be in error for said LRS decoder, which enables said LRS decoder to use a byte-error-correction algorithm capable of correcting as many as sixteen erroneous bytes in each of said (204, 188) Reed-Solomon codewords.

28. Receiver apparatus as set forth in claim 27, further comprising:
means for re-interleaving bytes of 188-byte packets recovered by said LRS decoder to reproduce randomized transfer-stream data packets concerning said selected service; and
a data de-randomizer for de-randomizing randomized data in said randomized transfer-stream data packets concerning said selected service to reproduce respective transfer-stream data packets concerning said selected service.

29. Receiver apparatus as set forth in claim 28, further comprising:
a data de-randomizer for de-randomizing randomized data concerning said selected service contained in 188-byte packets recovered by said LRS decoder.

30. Receiver apparatus as set forth in claim 24, wherein said means for de-interleaving the bytes of said convolutionally bye-interleaved (204, 188) codewords of LRS coding preserves the soft data bits as recovered by said turbo decoder, the hard bit components of which soft data bits define said (204, 188) codewords of LRS coding, said receiver apparatus further comprising:
a quantizer for extracting the hard bit component in each of said soft bits as preserved after byte de-interleaving, thereby recovering said (204, 188) codewords of LRS coding defined by those said hard bit components;
an 8-bit-byte former for forming 8-bit bytes from the hard bit components in said (204, 188) codewords of LRS coding recovered by said quantizer;
a bank of exclusive-OR gates for exclusive-ORing the hard bit component in each of said soft bits as preserved after byte de-interleaving with its further component bits indicative of the level of confidence in the correctness of its hard bit component, thus to generate bits indicative of the level of lack-of-confidence of the correctness of its said hard bit component;
a selector of the largest of the levels of lack-of-confidence in the hard bit components defining each byte of said (204, 188) codewords of LRS coding, which is ascribed to that byte as the level of lack-of-confidence of its being correct; and
an extended-byte former connected for extending each 8-bit byte of said codewords of LRS coding with respective extension bits indicating the level of lack-of-confidence of that said 8-bit byte being correct, thus to generate (204, 188) codewords of LRS coding that have each of their bytes extended.

31. Receiver apparatus as set forth in claim 30, further comprising:
an LRS decoder for correcting erroneous bytes in said (204, 188) codewords of LRS coding that have each of their bytes extended, said decoder for correcting erroneous bytes in said (204, 188) codewords using said extension bits to locate erroneous bytes for correction, said LRS decoder recovering a respective 188-byte packet from each said (204, 188) codeword and reducing the levels of lack-of-confidence of each extended said 8-bit byte for each said 188-byte packet that said LRS decoder corrects or newly finds correct, successive said 188-byte packets recovered by said LRS decoder being successive reproduced transfer-stream packets of randomized data concerning said selected service;
a TRS decoder for correcting erroneous bytes in (255, 191) codewords of transverse Reed-Solomon (TRS) coding within said successive said reproduced transfer-stream packets of randomized data concerning said selected service;
an extended-byte-organized random-access memory with extended-byte storage locations arranged in rows and columns, with 255 extended-byte storage locations per column, said extended-byte storage locations being written row by row with said extended bytes of said successive reproduced transfer-stream packets of randomized data, said extended-byte storage locations being read column by column to supply (255, 191) codewords of TRS coding to said TRS decoder;
a byte-organized random-access memory with byte storage locations arranged in rows and columns, with 191 byte storage locations per column and with as many byte storage locations per row as there are extended-byte storage locations per row in said extended-byte-organized random-access memory, said byte storage locations being written column by column with bytes of randomized data from 191-byte packets extracted from said (255, 191) codewords of TRS coding by said TRS decoder, said byte storage locations being read row by row to supply corrected reproduced transfer-stream packets of randomized data concerning said selected service; and
a data de-randomizer for de-randomizing said randomized data concerning said selected service.

32. Receiver apparatus as set forth in claim 30, further comprising:
an LRS decoder for correcting erroneous bytes in said (204, 188) codewords of LRS coding that have each of their bytes extended, said decoder for correcting erroneous bytes in said (204, 188) codewords using said extension bits to locate erroneous bytes for correction, said LRS decoder recovering a respective 188-byte packet from each said (204, 188) codeword and reducing the levels of lack-of-confidence of each extended said 8-bit byte for each said 188-byte packet that said LRS decoder corrects or newly finds correct;
means for re-interleaving extended bytes of said 188-byte packets recovered by said LRS decoder to generate extended bytes of reproduced transfer-stream packets of randomized data concerning said selected service;
a TRS decoder for correcting erroneous bytes in (255, 191) codewords of transverse Reed-Solomon (TRS) coding within successive said reproduced transfer-stream packets of randomized data concerning said selected service;
an extended-byte-organized random-access memory with extended-byte storage locations arranged in rows and columns, with 255 extended-byte storage locations per column, said extended-byte storage locations being written row by row with said extended bytes of said successive reproduced transfer-stream packets of randomized data, said extended-byte storage locations being read column by column to supply (255, 191) codewords of TRS coding to said TRS decoder;
a byte-organized random-access memory with byte storage locations arranged in rows and columns, with 191 byte storage locations per column and with as many byte storage locations per row as there are extended-byte storage locations per row in said extended-byte-organized random-access memory, said byte storage locations being written column by column with bytes of randomized data from 191-byte packets extracted from said (255, 191) codewords of TRS coding by said TRS decoder, said byte storage locations being read row by row to supply corrected reproduced transfer-stream packets of randomized data concerning said selected service; and
a data de-randomizer for de-randomizing said randomized data concerning said selected service.

33. Receiver apparatus as set forth in claim 30, further comprising:
an extended-byte-organized random-access memory (RAM) with extended-byte storage locations arranged in rows and columns, with 255 extended-byte storage locations per column, said extended-byte storage locations being written row by row with extended bytes of randomized data from (204, 188) Reed-Solomon codewords having extended bytes that are supplied from said extended-byte former;
an LRS decoder for correcting erroneous bytes in said (204, 188) codewords of LRS coding having extended bytes as read thereto row by row from said extended-byte-organized RAM, said LRS decoder operable for using said extension bits indicating the levels of lack-of-confidence of each extended said 8-bit byte being correct to locate erroneous bytes for correction, said LRS decoder further operable for reducing the levels of lack-of-confidence of each extended said 8-bit byte of each said (204, 188) codeword of LRS coding that said LRS decoder corrects or newly finds correct and updating that said extended said 8-bit byte as temporarily stored in its respective one of said extended-byte storage locations within said extended-byte-organized RAM;
a TRS decoder for correcting erroneous bytes in said (225, 191) codewords of transverse Reed-Solomon (TRS) coding having extended bytes as read thereto column by column from said extended-byte-organized random-access memory, said TRS decoder operable for using said extension bits indicating the levels of lack-of-confidence of each extended said 8-bit byte being correct for locating erroneous bytes for correction, said TRS decoder further operable for reducing the levels of lack-of-confidence of each extended said 8-bit byte for each said (225, 191) codeword of TRS coding that said TRS decoder corrects or newly finds correct and updating that said extended said 8-bit byte as temporarily stored in its respective one of said extended-byte storage locations within said extended-byte-organized RAM; and
a data de-randomizer for de-randomizing randomized data concerning said selected service, said randomized data supplied from byte-storage portions of said extended-byte storage locations in said extended-byte-organized random-access memory as read row by row.

34. Receiver apparatus as set forth in claim 33, wherein 2-dimensional Reed-Solomon decoding is iteratively performed using the following steps:
(a) reading extended-byte-storage locations in said extended-byte-organized random-access memory row by row for supplying (204, 188) Reed-Solomon codewords with extended bytes to said LRS decoder;
(b) writing extended-byte-storage locations in said extended-byte-organized random-access memory row by row with bytes of corrected (204, 188) Reed-Solomon codewords from said LRS decoder, said extension bits of said bytes of said corrected (204, 188) Reed-Solomon codewords being adjusted to indicate reduced levels of lack-of-confidence in those said bytes being correct;
(c) reading extended-byte-storage locations in said extended-byte-organized random-access memory column by column for supplying (255, 191) Reed-Solomon codewords with extended bytes to said TRS decoder;
(d) writing extended-byte-storage locations in said extended-byte-organized random-access memory column by column with bytes of corrected (225, 191) Reed-Solomon codewords from said TRS decoder, said extension bits of said bytes of said corrected (225, 191) Reed-Solomon codewords being adjusted to indicate reduced levels of lack-of-confidence in those said bytes being correct; and
(e) if 2-dimensional Reed-Solomon decoding is completed, reading randomized data from byte-storage portions of said extended-byte storage locations in said extended-byte-organized random-access memory as read row by row; otherwise looping back to step (a).

35. Receiver apparatus as set forth in claim 33, further comprising:
a CRC decoder for cyclic-redundancy-check (CRC) coding in internet-protocol (IP) packets formed by successive 188-byte internet-protocol-encapsulation (IPE) packets having extended bytes as read from said extended-byte-organized random-access memory, said CRC decoder operable for detecting errors in said IP packets, said CRC decoder further operable for reducing the levels of lack-of-confidence of each extended said 8-bit byte for each said IP packet in which said CRC decoder detects no error and updating that said extended said 8-bit byte as temporarily stored in its respective one of said extended-byte storage locations within said extended-byte-organized RAM.

36. Receiver apparatus as set forth in claim 30, further comprising:
an extended-byte-organized random-access memory with extended-byte storage locations arranged in rows and columns, with 255 extended-byte storage locations per column, said extended-byte storage locations being written row by row with convolutional-byte-interleaved extended bytes supplied from said extended-byte former;
an LRS decoder for correcting erroneous bytes in said (204, 188) codewords of LRS coding having extended bytes as read thereto from said extended-byte-organized random-access memory, said LRS decoder operable for using said extension bits indicating the levels of lack-of-confidence of each extended said 8-bit byte being correct to locate erroneous bytes for correction, said LRS decoder further operable for reducing the levels of lack-of-confidence of each extended said 8-bit byte for each said (204, 188) codeword of LRS coding that said LRS decoder corrects or newly finds correct and updating that said extended said 8-bit byte as temporarily stored in its respective one of said extended-byte storage locations within said extended-byte-organized RAM;
a TRS decoder for correcting erroneous bytes in said (225, 191) codewords of transverse Reed-Solomon (TRS) coding having extended bytes as read thereto column by column from said extended-byte-organized random-access memory, said TRS decoder operable for using said extension bits indicating the levels of lack-of-confidence of each extended said 8-bit byte being correct for locating erroneous bytes for correction, said TRS decoder further operable for reducing the levels of lack-of-confidence of each extended said 8-bit byte for each said (225, 191) codeword of TRS coding that said TRS decoder corrects or newly finds correct and updating that said extended said 8-bit byte as temporarily stored in its respective one of said extended-byte storage locations within said extended-byte-organized RAM; and
a data de-randomizer for de-randomizing randomized data concerning said selected service, said randomized data supplied from byte-storage portions of said extended-byte storage locations in said extended-byte-organized random-access memory as read row by row.

37. Receiver apparatus as set forth in claim 36, wherein 2-dimensional Reed-Solomon decoding is iteratively performed using the following steps:
(a) reading extended-byte-storage locations in said extended-byte-organized random-access memory for supplying (204, 188) Reed-Solomon codewords with extended bytes to said LRS decoder;
(b) writing extended-byte-storage locations in said extended-byte-organized random-access memory with bytes of corrected (204, 188) Reed-Solomon codewords from said LRS decoder, said extension bits of said bytes of said corrected (204, 188) Reed-Solomon codewords being adjusted to indicate reduced levels of lack-of-confidence in those said bytes being correct;
(c) reading extended-byte-storage locations in said extended-byte-organized random-access memory column by column for supplying (255, 191) Reed-Solomon codewords with extended bytes to said TRS decoder;
(d) writing extended-byte-storage locations in said extended-byte-organized random-access memory column by column with bytes of corrected (225, 191) Reed-Solomon codewords from said TRS decoder, said extension bits of said bytes of said corrected (225, 191) Reed-Solomon codewords being adjusted to indicate reduced levels of lack-of-confidence in those said bytes being correct; and
(e) if 2-dimensional Reed-Solomon decoding is completed, reading randomized data from byte-storage portions of said extended-byte storage locations in said extended-byte-organized random-access memory as read row by row; otherwise looping back to step (a).

38. Receiver apparatus as set forth in claim 36, further comprising:
a CRC decoder for cyclic-redundancy-check (CRC) coding in internet-protocol (IP) packets formed by successive 188-byte internet-protocol-encapsulation (IPE) packets having extended bytes as read thereto row by row from said extended-byte-organized random-access memory, said CRC decoder operable for detecting errors in said IP packets, said CRC decoder operable further operable for reducing the levels of lack-of-confidence of each extended said 8-bit byte for each said IP packet in which said CRC decoder detects no error and updating that said extended said 8-bit byte as temporarily stored in its respective one of said extended-byte storage locations within said extended-byte-organized RAM.
